(19) United States
(12) Patent Application Publication
(10) Pub. No.: US 2026/0056891 A1
(43) Pub. Date: Feb. 26, 2026

(54) STACKED APPARATUS USING IN-MEMORY COMPUTE CHIPLET DEVICES FOR INFERENCE-TIME COMPUTE ACCELERATION

(71) Applicant: d-MATRIX CORPORATION, Santa Clara, CA (US)

(72) Inventors: Sudeep BHOJA, Santa Clara, CA (US); Siddharth SHETH, Santa Clara, CA (US)

(21) Appl. No.: 19/374,356

(22) Filed: Oct. 30, 2025

Related U.S. Application Data
(63) Continuation of application No. 19/257,054, filed on Jul. 1, 2025.
Application No. 19/257,054 is a continuation-in-part of application No. 18/917,555, filed on Oct. 16, 2024.
Application No. 18/917,555 is a continuation of application No. 18/422,386, filed on Jan. 25, 2024, now Pat. No. 12,147,359.
Application No. 18/422,386 is a continuation of application No. 18/047,122, filed on Oct. 17, 2022, now Pat. No. 11,886,359.
Application No. 18/047,122 is a continuation of application No. 17/538,923, filed on Nov. 30, 2021, now Pat. No. 11,847,072.
Application No. 19/257,054 is a continuation-in-part of application No. 19/076,153, filed on Mar. 11, 2025.
Application No. 19/076,153 is a continuation-in-part of application No. 18/493,616, filed on Oct. 24, 2023, now Pat. No. 12,271,321.
Application No. 18/493,616 is a continuation of application No. 17/538,923, filed on Nov. 30, 2021, now Pat. No. 11,847,072.

(51) Int. Cl. G06F 13/16; G06F 1/10; G06F 13/42

(52) U.S. Cl. CPC G06F 13/1668; G06F 1/10; G06F 13/4291; G06F 2213/0026

(57) ABSTRACT

A stacked apparatus using in-memory compute (IMC) chiplet devices for inference-time compute acceleration. The apparatus is configured to accelerate the workload computations for neural network models, such as those for Large Language Models (LLMs) and reasoning models. The apparatus achieves high throughput and low latency using a chiplet design, digital IMC (DIMC) based engines, efficient die-to-die (D2D) interconnects, block floating point (BFP) numerics, and large high bandwidth on-chip memories. With modular chiplets in stacked configurations with memory devices and efficient interconnects, the accelerator apparatus can be easily scaled to accelerate workloads for models of different sizes. The DIMC configuration within the chiplet slices also improves computational performance and reduces power consumption by integrating computational functions and memory fabric. And by dynamically switching between precision levels based on real-time analysis of a target workload, computational efficiency can be optimized while maintaining accuracy.

### CROSS-REFERENCES TO RELATED APPLICATIONS

The present application is a continuation-in-part of U.S. Pat. App. Ser. No. 19/257,054, filed Jul. 1, 2025, which is a continuation-in-part of U.S. patent application Ser. No. 18/917,555, filed Oct. 16, 2024; which is a continuation of U.S. patent application Ser. No. 18/422,386, filed Jan. 25, 2024 (now U.S. Pat. No. 12,147,359); which is a continuation of U.S. patent application Ser. No. 18/047,122, filed Oct. 17, 2022 (now U.S. Pat. No. 11,886,359); which is a continuation of U.S. patent application Ser. No. 17/538,923, filed Nov. 30, 2021 (now U.S. Pat. No. 11,847,072). U.S. patent application Ser. No. 19/257,054 is also a continuation-in-part of U.S. patent application Ser. No. 19/076,153, filed Mar. 11, 2025; which is a continuation-in-part of U.S. patent application Ser. No. 18/493,616, filed Oct. 24, 2023 (now U.S. Pat. No. 12,271,321); which is a continuation of U.S. patent application Ser. No. 17/538,923, filed Nov. 30, 2021 (now U.S. Pat. No. 11,847,072). The present application also incorporates by reference, for all purposes, the following patent applications: U.S. patent application Ser. No. 18/058,706, filed Oct. 13, 2023; U.S. patent application Ser. No. 17/696,137, filed Mar. 16, 2022; U.S. patent application Ser. No. 17/837,659, filed Jun. 10, 2022; U.S. patent application Ser. No. 17/896,925, filed Aug. 26, 2022; U.S. patent application Ser. No. 18/048,740, filed Oct. 21, 2023; U.S. patent application Ser. No. 18/477,334, filed Sep. 28, 2023; U.S. patent application Ser. No. 18/486,872, filed Oct. 13, 2023; U.S. patent application Ser. No. 18/882,485, filed Sep. 11, 2024; U.S. patent application Ser. No. 18/913,894, filed Oct. 11, 2024; U.S. patent application Ser. No. 18/957,098, filed Nov. 22, 2024; and U.S. patent application Ser. No. 19/037,947, filed Jan. 27, 2025.

### BACKGROUND OF THE INVENTION

Advances in generative artificial intelligence (GenAI) have reinvigorated research into novel computing architectures. GenAI workloads. such as Large Language Models (LLMs) and Reasoning, are unique due to the auto-regressive nature that results in low arithmetic intensity during a significant fraction of the inference execution. Few designs have been build to address the intense memory bandwidth needs of such workloads.

More particularly, the capabilities of LLMs have reached remarkably close to that of humans in various domains such as coding, science, and mathematics. These models have traditionally charted the path indicated by the LLM scaling laws and the state-of-the-art models sport hundreds of billions or even a trillion parameters. However, after reaching the trillion parameter scale, the scaling laws of LLM pre-training seem to have plateaued due to (1) the computational needs of training ever large models proving to be impractical, and (2) the available data to train the models is finite. Currently, models achieve higher accuracy by allowing for iteration and reasoning during inference (i.e., inference-time compute). Such techniques applied to even small models can achieve results that match or outperform larger models.

Although conventional processing units and accelerators have catalyzed the exponential progress in AI thus far, such conventional systems fall short on one or more of the following factors: compute throughput, memory capacity, memory bandwidth, low precision numeric support, and scalability with low-latency, high-bandwidth interconnects. Such mismatches with an LLM inference workload can lead to stark under-utilization or very high system footprint. The resulting high costs directly (and negatively) impact the economic viability of such architectures for broad deployment. Therefore, there is a need for alternative architectures that optimize for latency-bounded throughput as a key metric capturing both user interactivity (low latency) and economic value (high throughput).

### BRIEF SUMMARY OF THE INVENTION

The present invention relates generally to integrated circuit (IC) devices and artificial intelligence (AI) systems. More particularly, the present invention relates to methods and device structures for accelerating computing workloads of neural network models (e.g., transformer models, convolution neural network models, etc.). These methods and structures can be used in applications such as natural language processing (NLP), computer vision (CV), generative AI, agentic AI, autonomous reasoning/decision-making, and the like. Merely by way of example, the invention has been applied to AI accelerator apparatuses and chiplet devices configured in a PCIe card.

According to an example, the present invention provides for an AI accelerator apparatus configured accelerating the workload computations for neural network models, such as inference-time computations for Large Language Models (LLMs) and reasoning models. The apparatus achieves high throughput and low latency using a chiplet design, digital in-memory computing (DIMC) based engines, efficient die-to-die (D2D) interconnects, block floating point (BFP) numerics, and large high bandwidth on-chip memories. The on-chip memories can include output buffer (OB) devices, stash memory devices, global memory (GM) devices, and the like. These chiplets can be arranged in stacked configurations with memory devices (e.g., dynamic random access memory [DRAM]) with either the chiplet overlying or underlying one or more memory devices. Multiple such stacked configurations can be coupled together using interconnections (e.g., D2D interconnects) through an interposer substrate.

In an example, the DIMC architecture and high memory bandwidth can significantly speed up the processing of target computational workloads of a particular application, such as those mentioned previously. The DIMC accelerator system can perform precise and efficient computations of data in a block floating point (BFP) format and can also switch to a lower precision floating point (FP) during runtime. By dynamically switching between precision levels based on real-time analysis of the target workload, the DIMC system can optimize computational efficiency while maintaining the necessary level of accuracy for each step of the workload computation. And with a high memory bandwidth, the DIMC architecture enables a high throughput of workload computations.

The accelerator and chiplet architecture and its related methods can provide many benefits. With modular chiplets, the accelerator apparatus can be easily scaled to accelerate the workloads for neural network models of different sizes. The DIMC configuration within the chiplet slices also improves computational performance and reduces power consumption by integrating computational functions and memory fabric. Further, embodiments of the accelerator apparatus can allow for quick and efficient mapping from computational workload data to enable effective implementation of AI applications, and the like.

A further understanding of the nature and advantages of the invention may be realized by reference to the latter portions of the specification and attached drawings.

### BRIEF DESCRIPTION OF THE DRAWINGS

In order to more fully understand the present invention, reference is made to the accompanying drawings. Understanding that these drawings are not to be considered limitations in the scope of the invention, the presently described embodiments and the presently understood best mode of the invention are described with additional detail through use of the accompanying drawings in which:

FIG. 1A-1C are simplified block diagrams illustrating AI accelerator apparatuses according to examples of the present invention.

FIGS. 2A-2D are simplified block diagrams illustrating 16-slice chiplet devices according to examples of the present invention.

FIGS. 3A-3D are simplified block diagrams illustrating slice devices according to examples of the present invention.

FIG. 4A is a simplified block diagram illustrating an in-memory-compute (IMC) module according to an example of the present invention.

FIG. 4B is a simplified block diagram illustrating a method of processing a computational workload using a digital IMC (DIMC) array according to an example of the present invention.

FIG. 5A is a simplified block flow diagram illustrating numerical formats of the data being processed in a slice device according to an example of the present invention.

FIG. 5B is a simplified diagram illustrating example numerical formats.

FIG. 6 is a simplified block diagram of a transformer architecture.

FIG. 7 is a simplified diagram illustrating a self-attention layer process for an example NLP model.

FIG. 8 is a simplified block diagram illustrating an example transformer.

FIG. 9 is a simplified block diagram illustrating an attention head layer of an example transformer.

FIG. 10 is a simplified table representing an example mapping process between a 24-layer transformer and an example eight-chiplet AI accelerator apparatus according to an example of the present invention.

FIG. 11 is a simplified block flow diagram illustrating a mapping process between a transformer and an AI accelerator apparatus according to an example of the present invention.

FIG. 12 is a simplified table representing a tiling attention process of a transformer to an AI accelerator apparatus according to an example of the present invention.

FIGS. 13A-13C are simplified tables illustrating data flow through the IMC and single input multiple data (SIMD) modules according to an example of the present invention.

FIG. 14 is a simplified block diagram illustrating a digital in-memory compute (DIMC) accelerator system configured for a variety of AI applications according to an example of the present invention.

FIG. 15 is a simplified block diagram illustrating a DIMC accelerator system according to an example of the present invention.

FIG. 16A is a flow diagram illustrating a conventional reasoning model architecture.

FIGS. 16B and 16C are simplified graphs showing accuracy scores and associated inference latency, respectively, measured for an example reasoning model.

FIG. 16D is a simplified graph showing the impact of increasing batch sizes on arithmetic intensity for a variety of Large Language Models (LLMs).

FIG. 17A is a simplified block diagram illustrating a chiplet NoC configuration according to an example of the present invention.

FIG. 17B is a simplified block diagram illustrating an example slice device in the NoC configuration for the chiplet shown in FIG. 17A.

FIG. 18 is a graph illustrating different operation modes for an AI accelerator apparatus according to an example of the present invention.

FIG. 19 is a simplified flow diagram illustrating a method for processing a sub-graph according to an example of the present invention.

FIG. 20 is a simplified block diagram illustrating a switch configuration with AI accelerator apparatuses in a mesh configuration according to an example of the present invention.

FIG. 21 is a simplified block diagram illustrating a server system using transparent bridging with synthetic fabric switch connectivity according to an example of the present invention.

FIG. 22 is a die micrograph showing a die-to-die (D2D) physical layer (PHY) of a chiplet device according to an example of the present invention.

FIG. 23 is a simplified flow diagram representing a method of an autonomous data transfer protocol implemented in an accelerator system according to an example of the present invention.

FIG. 24 is a simplified flow diagram illustrating a method of processing a neural network workload using an AI accelerator system according to an example of the present invention.

FIG. 25 is graph of performance differences between different configurations of a chiplet device according to an example of the present invention.

FIG. 26 is a graph of measured power efficiency for a DIMC device according to an example of the present invention.

FIG. 27 is a simplified diagram illustrating a method of spatio-temporal mapping for an LLM decoder onto a chiplet device according to an example of the present invention.

FIGS. 28A and 28B are simplified graphs measuring latency and throughput, respectively, for an AI accelerator apparatus according to an example of the present invention.

FIG. 29A is a simplified graph measuring power versus frequency for an AI accelerator apparatus and a digital in-memory compute (DIMC) device of the AI accelerator according to an example of the present invention.

FIG. 29B is a simplified graph measuring efficiency versus frequency in a DIMC device of an AI accelerator apparatus according to an example of the present invention.

FIG. 30 is a simplified block diagram illustrating a multi-rack server system with multi-node server systems using transparent bridging for scaling up and out according to an example of the present invention.

FIG. 31A is a simplified block diagram illustrating an input/output (IO) streaming device according to an example of the present invention.

FIG. 31B is a simplified block diagram illustrating an IO streaming device scale-out configuration according to an example of the present invention.

FIG. 32 is a simplified block diagram of an AI accelerator software stack according to an example of the present invention.

FIG. 33A is a simplified diagram illustrating a top view of a 3D stacked AI engine system according to an example of the present invention.

FIG. 33B is a simplified diagram illustrating an exploded view of a 3D stacked AI engine system and its interconnections according to an example of the present invention.

FIG. 33C is a simplified diagram illustrating an exploded view of a 3D stacked AI engine system and its peripheral regions according to an example of the present invention.

FIGS. 34A-34F are simplified diagrams illustrating cross-sectional views of 3D stacked chiplet devices according to various examples of the present invention.

### DETAILED DESCRIPTION OF THE INVENTION

The present invention relates generally to integrated circuit (IC) devices and artificial intelligence (AI) systems. More particularly, the present invention relates to methods and device structures for accelerating computing workloads of neural network models (e.g., transformer models, convolution neural network models, etc.). These methods and structures can be used in applications such as natural language processing (NLP), computer vision (CV), and the like. Merely by way of example, the invention has been applied to AI accelerator apparatuses and chiplet devices configured in a PCIe card.

Large Language Models (LLMs) have become the cornerstone of modern AI. The capabilities of these models have reached remarkably close to that of humans in various domains such as coding, science, and mathematics. These models have traditionally charted the path indicated by the LLM scaling laws and the state-of-the-art models sport hundreds of billions or even a trillion parameters. However, after reaching the trillion parameter scale, the scaling laws of LLM pre-training seem to have plateaued due to (1) the computational needs of training ever large models proving to be impractical, and (2) the available data to train the models is finite. Currently, models achieve higher accuracy by allowing for iteration and reasoning during inference (i.e., inference-time compute). Such techniques applied to even small models can achieve results that match or outperform larger models.

While reasoning models achieve superior results on various measures of model quality, they come with significant performance overheads. For example, a one billion (1B) parameter reasoning LLM that uses up to 128 generations, achieves a math500 score that is similar to an 8 billion parameter model under zero-shot inference. However, the increased math500 score of the 1B reasoning LLM comes at a huge performance cost compared to the one billion parameter-model under zero-shot inference. This means that a reasoning-based inference could take minutes or even hours of execution to service one user's request. This kind of performance profile will be a significant limiter in the way of realizing the full potential of these reasoning models. It is crucial to reduce the latency of execution (e.g., from minutes to seconds) in order to improve the user experience of using these models. Furthermore, it is important to achieve the improved user experience while minimizing the cost of deployment (e.g., by increasing system throughput).

While the reasoning models follow multiple logical phases; including generation, verification, and feedback; the performance of these models is dominated by the performance of the generation and verification phases, both of which are bound by LLM inference execution. In an example, LLM inference performance is governed by a number of high-level key factors. First, the prefill stage is largely compute-throughput bound due to the model parameters fetched from memory being reused by a factor proportional to the sequence length of the prefill text (typically in the 100s or 1000s of tokens). This places a high compute throughput demand on the underlying system architecture. Second, along with the model parameters, LLMs store and reference intermediate activations within their “KV cache” every token generation. The KV cache is also unique to a sequence and thus grows in size with the number of requests in a batch. This makes the generation phase bound by the need for a high capacity and high bandwidth memory. Third, due to the previous factors, it is highly desirable to support low precision numerics which help increase the compute throughput roofline while also increasing effective memory capacity and bandwidth. Furthermore, as LLMs get larger, typical execution of these models involve executing a single layer of the model on multiple devices and scaling out different layers over larger number of devices, too. Thus, the underlying system needs the capability to scale out a cluster of devices using low-latency, high-bandwidth interconnects.

Although conventional processing units and accelerators have catalyzed the exponential progress in AI thus far, such conventional systems fall short on one or more of the factors described above. Such mismatches with the LLM inference workload can lead to stark under-utilization or very high system footprint. The resulting high CAPEX/OPEX costs directly (and negatively) impact the economic viability of such architectures for broad deployment. Therefore, there is a need for alternative architectures that optimize for latency-bounded throughput as a key metric capturing both user interactivity (low latency) and economic value (high throughput).

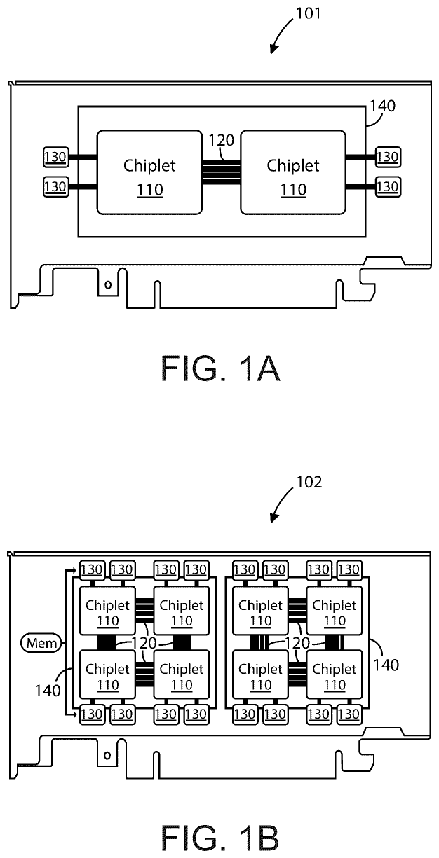

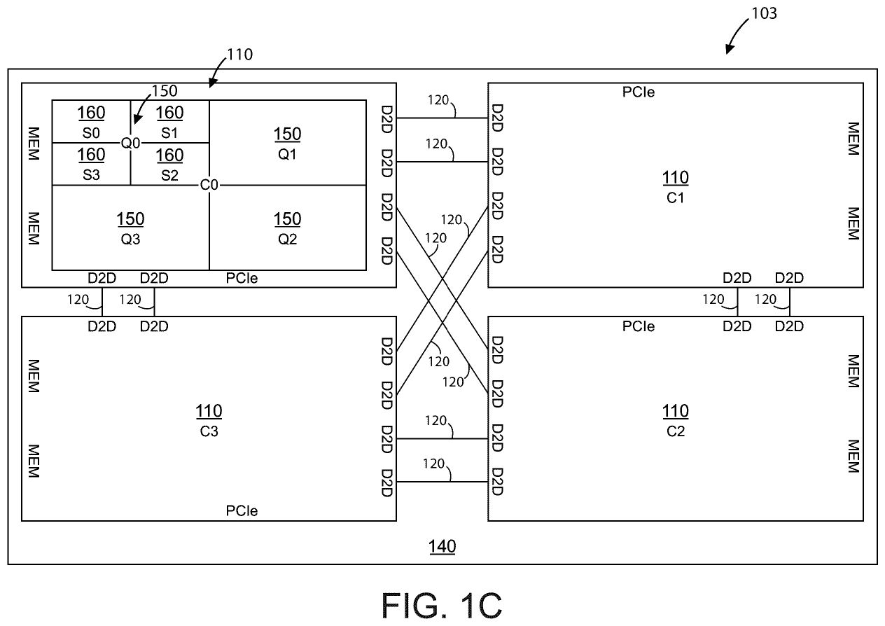

According to an example, the present invention provides for an apparatus using chiplet devices that are configured to accelerate neural network model workload computations for AI applications. In an aspect, the chiplet devices include efficient digital in-memory compute (DIMC) devices to enable high compute throughput. In another aspect, the chiplet devices implement block-floating point numerics to provide sufficient numerical accuracy at low precisions with the efficient DIMC based compute process. In another aspect, the chiplet devices include large high-bandwidth on-chip memories to address the memory needs of workload computations. And, in another aspect, the AI accelerator implements a multi-chiplet configuration with efficient interconnects, such as die-to-die (D2D) on-package interconnects, peripheral component interconnect express (PCIe) interconnects beyond a package, and the like. Examples of the AI accelerator apparatus are shown in FIGS. 1A to 1C.

FIG. 1A illustrates a simplified AI accelerator apparatus 101 with two chiplet devices 110. As shown, the chiplet devices 110 are coupled to each other by one or more die-to-die (D2D) interconnects 120. Also, each chiplet device 110 is coupled to a memory interface 130 (e.g., static random access memory (SRAM), dynamic random access memory (DRAM), synchronous dynamic RAM (SDRAM), or the like). The apparatus 101 also includes a substrate member 140 that provides mechanical support to the chiplet devices 110 that are configured upon a surface region of the substrate member 140. The substrate can include interposers, such as a silicon interposer, glass interposer, organic interposer, or the like. The chiplets can be coupled to one or more interposers, which can be configured to enable communication between the chiplets and other components (e.g., serving as a bridge or conduit that allows electrical signals to pass between internal and external elements).

FIG. 1B illustrates a simplified AI accelerator apparatus 102 with eight chiplet devices 110 configured in two groups of four chiplets on the substrate member 140. In an example, each of these chiplet groups is configured as a multi-chip module (MCM). Here, each chiplet device 110 within a group is coupled to other chiplet devices by one or more D2D interconnects 120. Apparatus 102 also shows a DRAM memory interface 130 coupled to each of the chiplet devices 110. The DRAM memory interface 130 can be coupled to one or more memory modules, represented by the “Mem” block.

As shown, the AI accelerator apparatuses 101 and 102 are embodied in peripheral component interconnect express (PCIe) card form factors, but the AI accelerator apparatus can be configured in other form factors as well. These PCIe card form factors can be configured in a variety of dimensions (e.g., full height, full length (FHFL); half height, half length (HHHL), etc.) and mechanical sizes (e.g., 1×, 2×, 4×, 16×, etc.). In an example, one or more substrate members 140, each having one or more chiplets, are coupled to a PCIe card.

In such PCIe form factors (or similar form factors), these apparatuses can implement secure boot to ensure that the firmware loaded by the card during a boot process is digitally signed and trustworthy. The apparatuses can also implement management interfaces, such as Redfish, Platform Level Data Model (PLDM), Security Protocol and Data Model (SPDM), and the like. In an example, the Thermal Design Power (TDP) of apparatus 102 is 600 W, but can be configured at other wattages depending on the application. Also, these apparatuses can implement dual slot air cooling, similar to conventional graphics processing units (GPUs). Those of ordinary skill in the art will recognize other variations, modifications, and alternatives to these elements and configurations of the AI accelerator apparatus.

FIG. 1C illustrates a simplified AI accelerator apparatus 103 with four chiplets 110 in an inter-connected configuration according to an example of the present invention. As shown, each chiplet 110 is coupled to each other chiplet 110 via D2D interconnects 120. Each chiplet 110 also includes a plurality slice devices (or slices) 160 configured in tile groups 150 (or gangs) on a substrate 140, such as an organic substrate, a ceramic substrate, a glass substrate, and the like. In this case, the tiles 150 are configured as quad groups with each such group including four clustered slices. Each chiplet 110 also includes PCIe and memory interfaces (denoted as “PCIe” and “MEM”, respectively), such as those for dual data rate (DDR) memory, low-power DDR (LPDDR) memory, high-bandwidth memory (HBM), and the like. In an example, this AI accelerator apparatus 103 is configured as an MCM, which can be integrated with other MCMs (see accelerator apparatus 102 of FIG. 1B).

Embodiments of the AI accelerator apparatus can implement several techniques to improve performance (e.g., computational efficiency) in various AI applications. The AI accelerator apparatus can include digital in-memory-compute (DIMC) to integrate computational functions and memory fabric. Algorithms for the mapper, numerics, and sparsity can be optimized within the compute fabric. And, use of chiplets and interconnects configured on organic interposers can provide modularity and scalability.

According to an example, the present invention implements chiplets with in-memory-compute (IMC) functionality, which can be used to accelerate the computations required by the workloads of transformers. The computations for training these models can include performing a scaled dot-product attention function to determine a probability distribution associated with a desired result in a particular AI application. In the case of training NLP models, the desired result can include predicting subsequent words, determining contextual word meaning, translating to another language, etc.

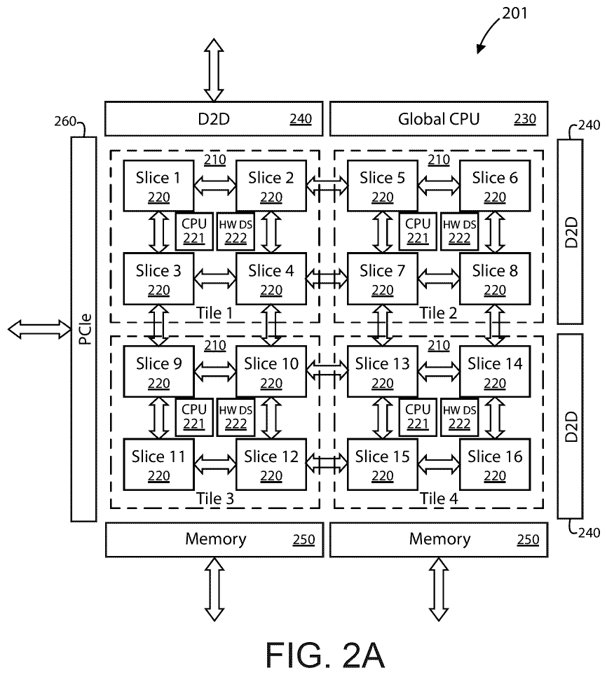

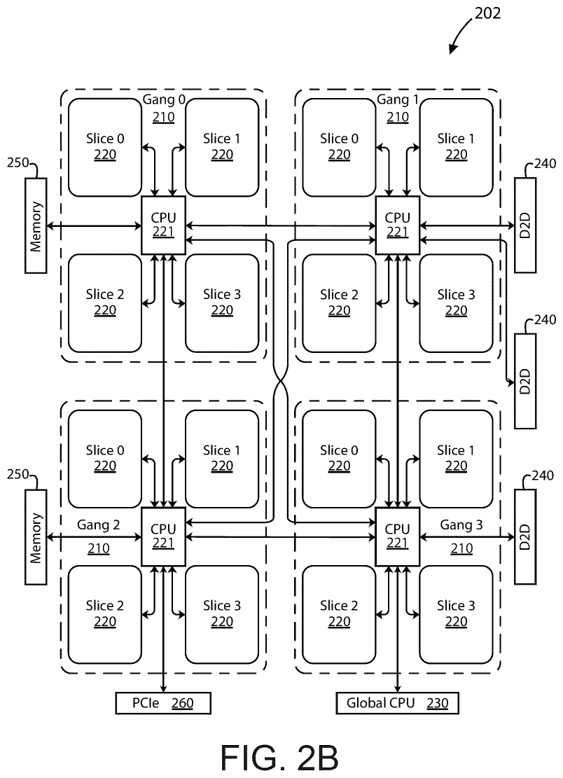

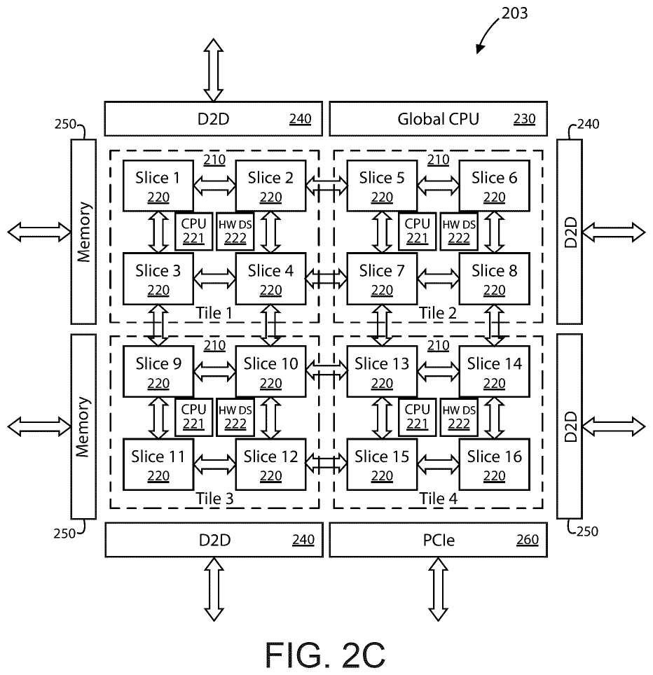

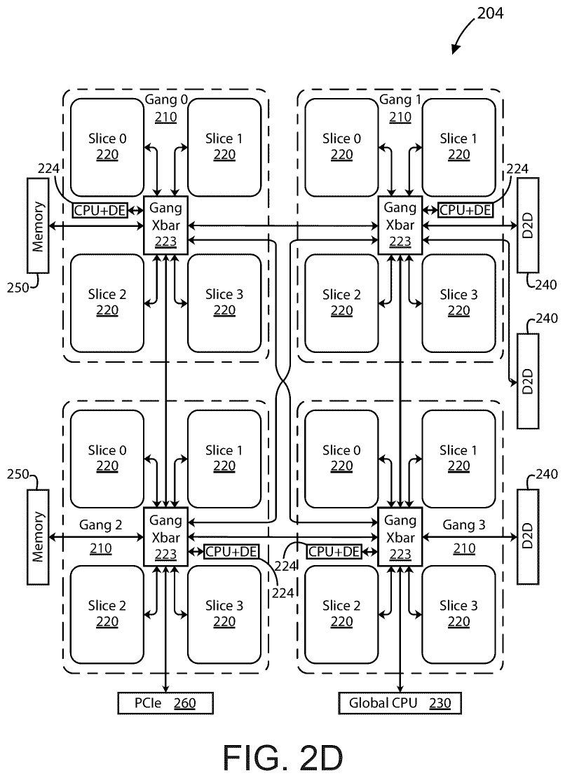

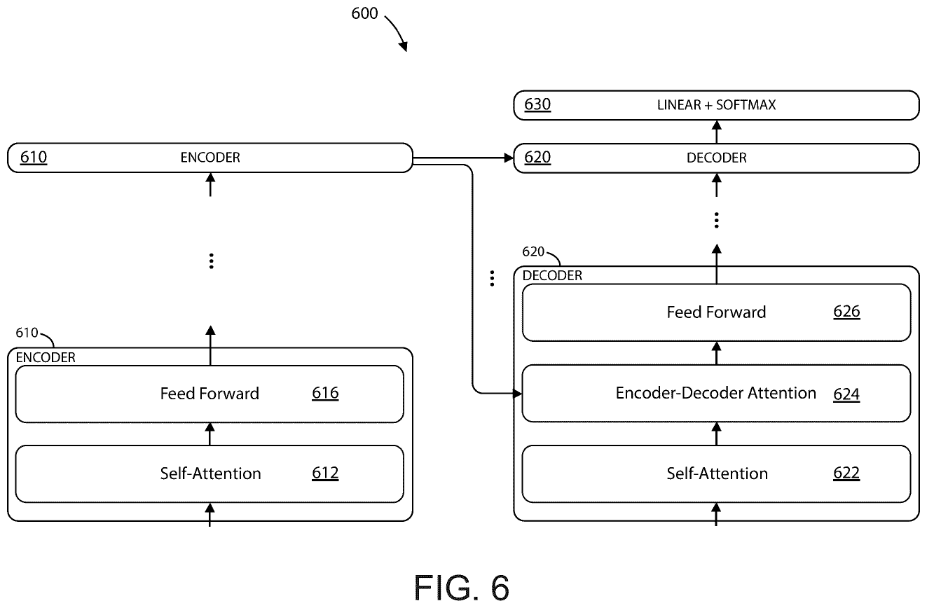

The chiplet architecture can include a plurality of slice devices (or slices) controlled by a central processing unit (CPU) to perform the transformer computations in parallel. Each slice is a modular IC device that can process a portion of these computations. The plurality of slices can be divided into tiles/gangs (i.e., subsets) of one or more slices with a CPU coupled to each of the slices within the tile. This tile CPU can be configured to perform transformer computations in parallel via each of the slices within the tile. A global CPU can be coupled to each of these tile CPUs and be configured to perform transformer computations in parallel via all of the slices in one or more chiplets using the tile CPUs. Further details of the chiplets are discussed in reference to FIGS. 2A-5B, while transformers are discussed in reference to FIGS. 6-9.

FIG. 2A is a simplified block diagram illustrating an example configuration of a 16-slice chiplet device 201. In this case, the chiplet 201 includes four tile devices 210, each of which includes four slice devices 220, a CPU 221, and a hardware dispatch (HW DS) device 222. In a specific example, these tiles 210 are arranged in a symmetrical manner. As discussed previously, the CPU 221 of a tile 210 can coordinate the operations performed by all slices within the tile. The HW DS 222 is coupled to the CPU 221 and can be configured to coordinate control of the slices 220 in the tile 210 (e.g., to determine which slice in the tile processes a target portion of transformer computations). In a specific example, the CPU 221 can be a reduced instruction set computer (RISC) CPU, or the like. Further, the CPU 221 can be coupled to a dispatch engine, which is configured to coordinate control of the CPU 221 (e.g., to determine which portions of transformer computations are processed by the particular CPU).

The CPUs 221 of each tile 210 can be coupled to a global CPU via a global CPU interface 230 (e.g., buses, connectors, sockets, etc.). This global CPU can be configured to coordinate the processing of all chiplet devices in an AI accelerator apparatus, such as apparatuses 101 and 102 of FIGS. 1A and 1B, respectively. In an example, a global CPU can use the HW DS 222 of each tile to direct each associated CPU 221 to perform various portions of the transformer computations across the slices in the tile. Also, the global CPU can be a RISC processor, or the like.

The chiplet 201 also includes D2D interconnects 240 and a memory interface 250, both of which are coupled to each of the CPUs 221 in each of the tiles. These D2D interconnects 240 can provide low-latency, energy-efficient on-package interconnect interfaces to connect multiple chiplets or other system-on-chip (SoC) devices. In an example, the D2D interconnects 240 can be configured with single-ended signaling. The memory interface 250 can include one or more memory buses coupled to one or more memory devices (e.g., DRAM, SRAM, SDRAM, or the like).

Further, the chiplet 201 includes a PCIe interface/bus 260 coupled to each of the CPUs 221 in each of the tiles. The PCIe interface 260 can be configured to communicate with a server or other communication system and can be used for host connectivity, inter-accelerator connectivity, inter-chiplet connectivity, and the like. In a specific example, the PCIe interface 260 includes a PCIe Gen5×16 interface with a 128 GB/s bidirectional bandwidth.

In the case of a plurality of chiplet devices, a main bus device is coupled to the PCIe bus 260 of each chiplet device using a master chiplet device (e.g., main bus device also coupled to the master chiplet device). This master chiplet device is coupled to each other chiplet device using at least the D2D interconnects 240. The master chiplet device and the main bus device can be configured overlying a substrate member (e.g., same substrate as chiplets or separate substrate). An apparatus integrating one or more chiplets can also be coupled to a power source (e.g., configured on-chip, configured in a system, or coupled externally) and can be configured and operable to a server, network switch, or host system using the main bus device. The server apparatus can also be one of a plurality of server apparatuses configured for a server farm within a data center, or other similar configuration.

In a specific example, an AI accelerator apparatus configured for GPT-3 can incorporate eight chiplets (similar to apparatus 102 of FIG. 1B). The chiplets can be configured with D2D 16×16 Gb/s interconnects, 32-bit LPDDR5 6.4 Gb/s memory modules, and 16 lane PCIe Gen 5 PHY NRZ 32 Gb/s/lane interface. LPDDR5 (16×16 GB) can provide the necessary capacity, bandwidth and low power for large scale NLP models, such as quantized GPT-3. In such a configuration, the apparatus can achieve high throughput computations (e.g., 2400 TFLOPS for 8-bit dense, 9600 TFLOPS for 4-bit dense, etc.)

In an example, the chiplets can also include a dual LPDDR interface that supports the main memory. More specifically, each chiplet can be connected to up to 32 GB of LPDDR5 memory providing about 50 GB/s bandwidth, as well as prefill-decode disaggregation, prefix caching, dormant KV cache, and other functions. At a card level, this configuration provides up to 256 GB of memory capacity and 400 GB/s bandwidth. The main memory can provide the main interface for host-device communication, support a variety of workload usage scenarios (e.g., rapid model swapping; prompt KV caching; inference on small device footprint; offline execution of large models, contexts, and batches; etc.). Of course, there can be other variations, modifications, and alternatives.

FIG. 2B is a simplified block diagram illustrating an example configuration of a 16-slice chiplet device 202. Similar to chiplet 201, chiplet 202 includes four gangs 210 (or tiles), each of which includes four slice devices 220 and a CPU 221. As shown, the CPU 221 of each gang/tile 210 is coupled to each of the slices 220 and to each other CPU 221 of the other gangs/tiles 210. In an example, the tiles/gangs serve as neural cores, and the slices serve as compute cores. With this multi-core configuration, the chiplet device can be configured to take and run several computations in parallel. The CPUs 221 are also coupled to a global CPU interface 230, D2D interconnects 240, a memory interface 250, and a PCIe interface 260. As described for FIG. 2A, the global CPU interface 230 connects to a global CPU that controls all of the CPUs 221 of each gang 210.

FIG. 2C is a simplified block diagram illustrating an example configuration of a 16-slice chiplet device 203. Chiplet 203 is similar to chiplet 201, except that the positions of the D2D interconnects 240, the memory interface 250, and the PCIe interface 260 are in a different configuration. Here, a first input/output (I/O) region includes (shown at the top) includes one or more D2D interconnects 240 and the global CPU interface 230, and a second I/O region (shown to the right) includes one or more D2D interconnects 240 as well. In chiplet 203, a third I/O region (shown at the bottom) includes one or more D2D interconnects 240 and a PCIe interface 260, whereas chiplet 201 had one or more memory interface connections 250 in this region. And, a fourth I/O region (shown to the left) includes one or more memory interface connections 250, whereas chiplet 201 had the PCIe interface 260 in this region.

In an example, these I/O regions are placed in a symmetrical configuration. The I/O placement of chiplet 203 can be used in a single die configuration for various chiplet configurations (e.g., 1×2, 2×2, 2×4, etc.). Further, the I/O placement is optimized for various array configurations due to die rotations not affecting the package I/O routing (i.e., enables scalable chiplet array configurations in any die orientation).

FIG. 2D is a simplified block diagram illustrating an example configuration of a 16-slice chiplet device 204. Similar to chiplet 202, chiplet 204 includes four gangs 210 (or tiles), each of which includes four slice devices 220. However, in this case, each of the slice devices 220 within each gang are coupled to a gang crossbar device 223, which is coupled to a gang CPU and dispatch engine (DE) device 224. The gang crossbar device 223 can be coupled to the crossbar devices within each slice device and to other gang crossbar devices in other chiplets via the D2D interconnects 240.

In an example, the DE device 224 (or HW DS discussed previously) is configured with the CPU to run the chip firmware, which includes managing the processing of neural network model workloads represented as ISA graphs, which includes a plurality of sub-graphs. The DE device 224 can be configured to assign the sub-graphs to be executed by the tiles (or gangs) of the chiplets. In this manner, the tiles are treated as basic units of graph execution and can perform the workload computations in parallel. Those of ordinary skill in the art will recognize other variations, modifications, and alternatives to the configurations shown in FIGS. 2A-2D.

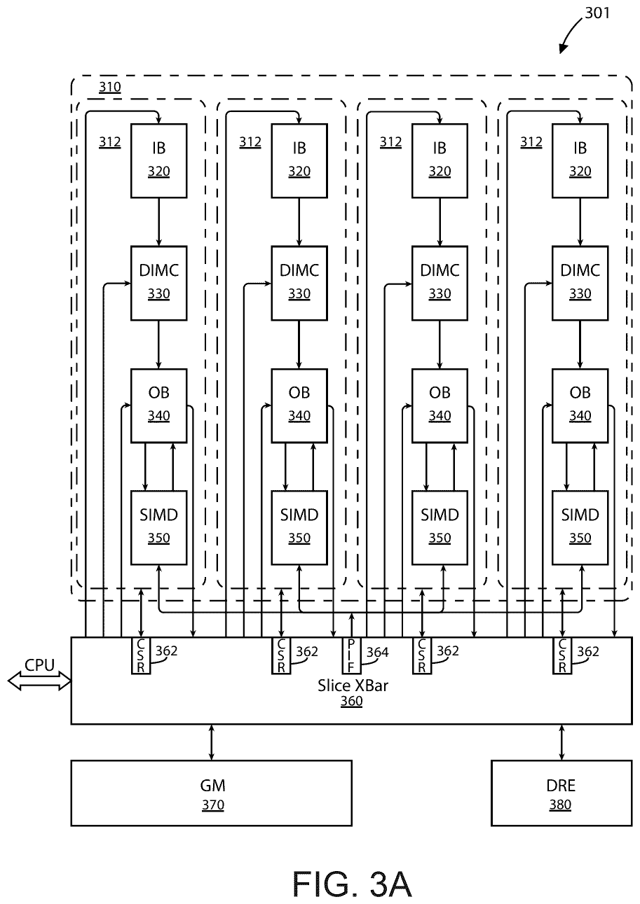

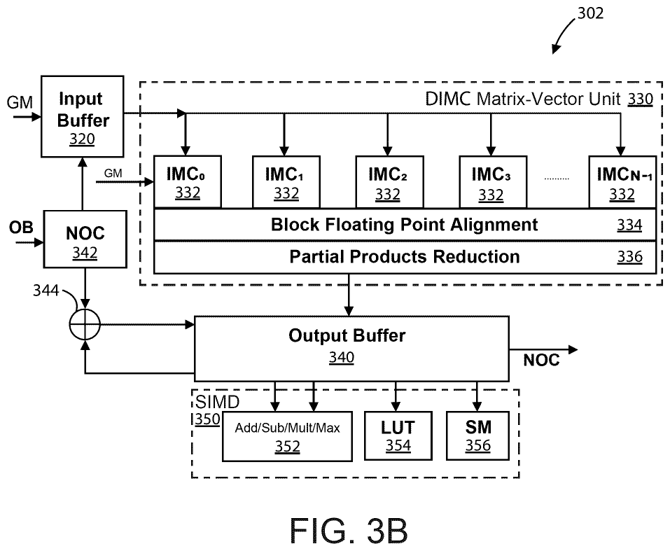

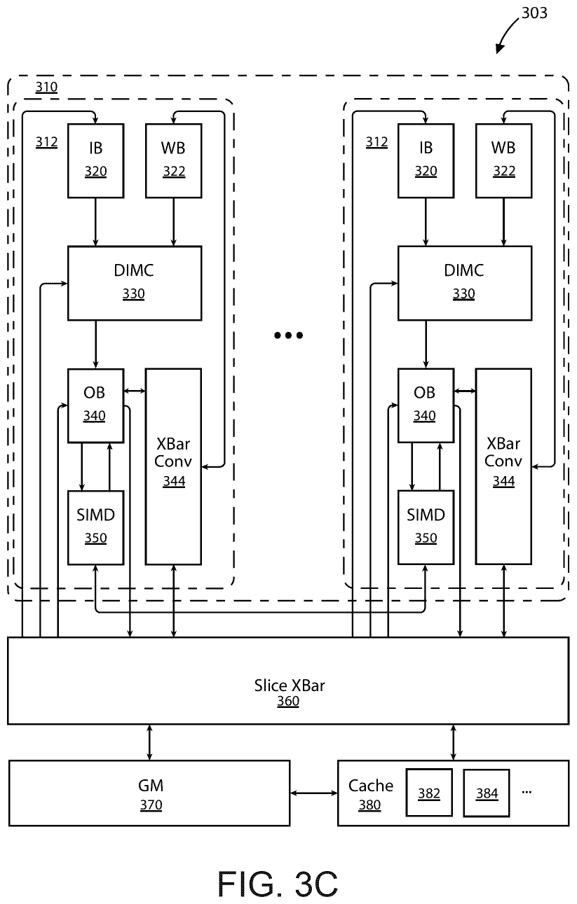

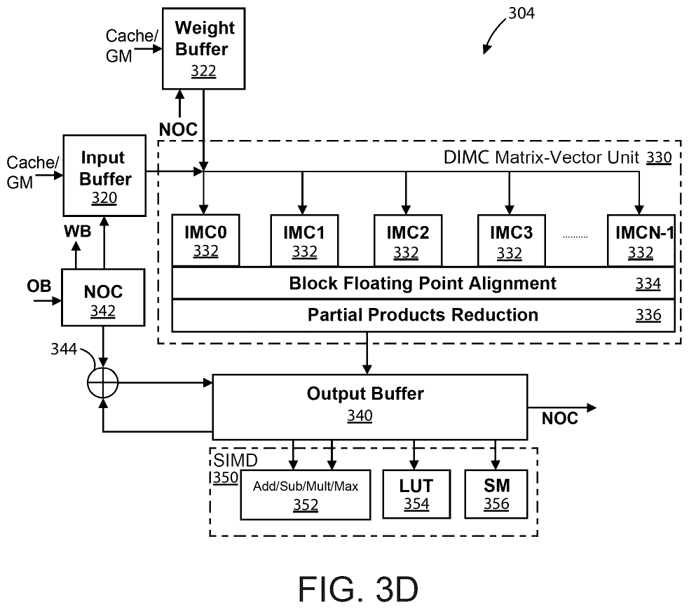

FIG. 3A is a simplified block diagram illustrating an example slice device 301 of a chiplet. For the 16-slice chiplet example, slice device 301 includes a compute core 310 having four compute paths 312, each of which includes an input buffer (IB) device 320, a digital in-memory-compute (DIMC) device 330, an output buffer (OB) device 340, and a Single Instruction, Multiple Data (SIMD) device 350 coupled together. Each of these paths 312 is coupled to a slice cross-bar/controller 360, which is controlled by the tile CPU to coordinate the computations performed by each path 312.

In an example, the DIMC device 330 is coupled to a clock and is configured within one or more portions of each of the plurality of slices of the chiplet to allow for high throughput of one or more matrix computations provided in the DIMC device 330 such that the high throughput is characterized by 512 multiply accumulates per a clock cycle. In a specific example, the clock coupled to the DIMC device 330 is a second clock derived from a first clock (e.g., chiplet clock generator, AI accelerator apparatus clock generator, etc.) configured to output a clock signal of about 0.5 GHz to 4 GHz; the second clock can be configured at an output rate of about one half of the rate of the first clock. When configured as a tensor compute engine, the DIMC device 330 can achieve up to 47 TOPS/W and provides 2400-9600 TOPS (eff 8-bit/40 bit precision) per card. The DIMC device 330 can also be configured to support a block structured sparsity (e.g., imposing structural constraints on weight patterns of a neural networks like a transformer).

In an example, the SIMD device 350 is a SIMD processor coupled to an output of the DIMC. The SIMD 350 can be configured to process one or more non-linear operations and one or more linear operations on a vector process. The SIMD 350 can be a programmable vector unit or the like. The SIMD 350 can also include one or more random-access memory (RAM) modules, such as a data RAM module, an instruction RAM module, and the like.

In an example, the slice controller 360 is coupled to all blocks of each compute path 312 and also includes a control/status register (CSR) 362 coupled to each compute path. The slice controller 360 is also coupled to a memory bank 370 and a data reshape engine (DRE) 380. The slice controller 360 can be configured to feed data from the memory bank 370 to the blocks in each of the compute paths 312 and to coordinate these compute paths 312 by a processor interface (PIF) 364. In a specific example, the PIF 364 is coupled to the SIMD 350 of each compute path 312. The DRE 380 can be configured to provide acceleration for common reshape operations in neural network model workloads, such as transpose, tensor insertion, tensor extraction, and the like.

In an example, the memory bank 370 is configured as a global memory (GM) device of the slice device 301 that can be used as a staging area for input activations, output/intermediate activation collection, collective operations, and the like. In a specific example, the GM can include a shared static RAM (SRAM) device, or similar memory device, within each slice device of a chiplet. The GM can also include a multi-banked configuration that is used for parallel operations of the compute paths and support compute-data transfer overlap. In a specific example, a PCIe card level configuration such as shown in FIG. 1B can include 2 GB of on-chip SRAM (i.e., performance memory) that provides a net bandwidth of 150 TB/s.

Further details for the compute core 310 are shown in FIG. 3B. The simplified block diagram of slice device 302 includes an input buffer 320, a DIMC matrix vector unit 330, an output buffer 340, a network on chip (NoC) device 342, and a SIMD vector unit 350. The DIMC unit 330 includes a plurality of in-memory-compute (IMC) modules 332 configured to perform matrix computations for a workload, such as computing a Scaled Dot-Product Attention function on input data to determine a probability distribution, which requires high-throughput matrix multiply-accumulate operations.

The IMC modules 332 can be configured in an array to perform matrix-matrix multiply and accumulate operations in a highly energy-efficient manner. The in-memory nature of the computation allows for input data reuse, such as reusing weight tensors for multiplications weight multiple rows of an activation tensor used in deep learning models. Further, the DIMC unit 330 performs matrix operations accurately and precisely without the challenges associated with analog and resistive in-memory compute technologies.

These IMC modules 332 can also be coupled to a block floating point alignment module 334 and a partial products reduction module 336 for further processing (e.g., inline partial products reduction) before outputting the DIMC results to the output buffer 340. In an example, the input buffer 320 receives input data (e.g., data vectors) from the memory bank 370 (shown in FIG. 3A) and sends the data to the IMC modules 332. The IMC modules 332 can also receive instructions from the memory bank 370 as well.

In addition to the details discussed previously, the SIMD 350 can be configured as an element-wise vector processing unit (VPU) or vector SIMD (vSIMD) unit. The SIMD 350 can include a computation unit 352 (e.g., add, subtract, multiply, max, etc.), a look-up table (LUT) 354, and a state machine (SM) module 356 configured to receive one or more outputs from the output buffer 340. The SIMD 350 can be configured with the NoC configuration of the chiplet to enable scalability and to adaptability to increasing model dimensions and context lengths.

In an example, the SIMD 350 includes a plurality of vSIMD can be configured for accelerating linear and non-linear activation functions. Linear activation functions are characterized by massively parallel element-wise operations and are memory intensive in nature. Non-linear activation functions, on the other hand, are compute intensive that involve trigonometric, transcendental computation, and reduction operations. Activation functions, such as those in LLMs also require flexibility in terms of tensor dimensions and parameters that govern function behavior. In an example, the VPU is coupled to a scalar core that enables programmability to exploit the data-level parallelism of the activation functions.

In a specific example, the core of the vSIMD unit includes a 4-wide Very Long Instruction Word (VLIW) machine with fully pipelined functional units that support integer and floating-point compute. The activation functions are captured as vSIMD kernels that reside in a 32 KB private instruction scratchpad, which is primarily used for register spills or lookup tables for the vSIMD kernels. The primary data buffer for streaming tensors in and out of vSIMD cores is the OB device 340 configured as a multi-banked scratchpad memory shared between the vSIMD core and a DIMC array.

In an example, the OB device 340 is configured as a shared scratchpad SRAM that forms the primary data buffer between the DIMC device 330 (e.g., a DIMC array) and the SIMD device 350 (e.g., vSIMD unit). And the OB device 340, the DIMC device 330, the OB device 340, and the SIMD device 350 can form a compute core device. In a specific example, a slice device can include two or more such compute core devices that share the GM device 370 as a larger data buffer, a data reshape engine 380 (see FIG. 3A), and utilizes low-latency interconnects to efficiently process workloads (e.g., higher dimension tensor operations, and the like).

In a specific example, the OB device 340 is organized as 16 banks of 8 KB each and supports simultaneous accesses by multiple streams, which can include 8 DIMC streams (one per core), 3 vSIMD streams and 2 NoC streams. The OB device 340 can also be configured to provide low latency and high bandwidth memory accesses that can sustain up to two vector loads and one vector store or one vector load and two vector stores (three memory operations) every cycle. During data transfers across OB devices 340, an in-place reduction primitive can be exercised to accelerate accumulating partial sums across compute cores 310.

The instruction slot mapping (e.g., determined by the compiler) is dynamic and can handle both compute-intensive and memory-intensive functions, such as the activations functions. In this manner, a given VLIW slot of the vSIMD core is time shared across multiple operations. While some VLIW packets can be more memory dominant, issuing up to three memory operations, a VLIW packet can also issue four compute operations per cycle. Those of ordinary skill in the art will recognize other variations, modifications, and alternatives to this SIMD implementation.

The NoC device 342 is coupled to the output buffer 340 configured in a feedforward loop via shortcut connection 344. Also, the NoC device 342 is coupled to each of the slices and is configured for multicast and unicast processes. Computation and communication processes can be pipelined and overlapped (e.g., ping-pong buffering), and instructions can be merged to exploit symmetric patterns (e.g., command multi-cast). More particularly, the NoC device 342 can be configured to connect all of the slices and all of the tiles, multi-cast input activations to all of the slices/tiles (i.e., data multi-cast loading), and collect the partial computations to be unicast for a specially distributed accumulation. Alternatively, the NoC device 342 can also be configured for fused, strided loading to minimize the data path overhead in certain scenarios.

Considering the previous eight-chiplet AI accelerator apparatus example, the input buffer can have a capacity of 64 KB with 16 banks and the output buffer can have a capacity of 128 KB with 16 banks. The DIMC can be an 8-bit block have dimensions 64×64 (eight 64×64 IMC modules) and the NoC can have a size of 512 bits. The computation block in the SIMD can be configured for 8-bit and 32-bit integer (int) and unsigned integer (uint) computations. These slice components can vary depending on which transformer the AI accelerator apparatus will serve.

According to an example, the present invention relates to processing neural network model workloads in a matrix compute apparatus. In certain applications, it is desirable to improve the handling of large data sizes. For example, transformer-based modeling networks typically involve an enormous number of elements (e.g., weights, activations, etc.) that cannot all be stored in on-chip memory. Thus, accessing these elements requires frequent transfers from a memory storage device (e.g., DDR), which can cause the processing of these elements to become memory bound due to the large latency of such memory operations. Additionally, quantizing the data into certain formats can pose challenges in cases in which the target matrix data is characterized by a changing contraction dimension due to redundant quantizations, potential accuracy reduction, and inefficient memory/cache transfers.

FIG. 3C is a simplified diagram illustrating a matrix compute apparatus 303 according to an example of the present invention. As shown, this apparatus can be configured similarly to the example slice device 301 of FIG. 3A. Any shared reference numerals between these figures refer to the same elements as described previously. In contrast, apparatus 303 includes a cache memory device 380 coupled to the crossbar 360 and the memory device 370. The cache memory device 380 can include at least a first cache device 382 and a second cache device 384. The cache memory device 380 can include additional cache devices as well. In an example, the memory device 370 and the cache memory device 380 can be configured for direct memory access (DMA), including the transfer of contiguous and/or strided data with looping (e.g., 4D nested loops, and the like).

In an example, the cache memory device 380 is configured as a stash memory (Stash) device. This Stash device can be configured as a high-bandwidth SRAM used to store workload inputs, such as model weights and KV cache tensors. The Stash can then feed the tensors to the DIMC device 330 to perform the matrix multiplication operations. In an example, each compute path 312 is coupled to a Stash device, which can be configured as a weight buffer. In workload cases primarily involving vector-matrix multiplications or skinny multiplicand matrix-matrix multiplications, the bandwidth to the DIMC device 330 (which hold the multiplier matrices) governs the performance of the workload. Thus, the Stash can be configured as a highly banked (e.g., 1× bank per DIMC device) high-density SRAM memory that feeds each DIMC device 330 through a 64B/clock interface. For very large weight and KV cache tensors, multiple stash banks can be triggered by software to load their shard of weight tile concurrently, which effectively scales the weight loading bandwidth nearly linearly with the number of banks. Those of ordinary skill in the art will recognize other variations, modifications, and alternatives to this Stash configuration.

The apparatus 303 also includes a crossbar converter device 344 coupled to the crossbar 360, the input buffer (IB) device 320, and a weight buffer (WB) device 322, which is coupled to the compute device 330. The converter device 344 can receive data directly from the output buffer (OB) device 340 or from the memory device 370 or the cache memory device 380 via the crossbar device 360. And, the converter device 344 can convert the data from a first format to a second format by determining mantissa values and shared exponent values from the data in the first format. Then, these mantissas and shared exponents are stored in a blocking configuration in a designated memory location (e.g., memory device 370, cache memory device 380, etc.). In a specific example, the first format can be a floating point (FP) format, while the second format can be a block floating point (BFP) format. Further, the crossbar device 360 can send the converted data to the IB device 320 and/or the WB device 322 in preparation for processing by the compute device 330.

In an example, the WB device 322 can be configured together with the IB device 320 as one buffer device. Or the WB device 322 can be include a stash memory device, which can also be coupled to a decompressor device to unpack data from the Stash before sending the data to the DIMC 330. Also, the crossbar converter device 344 can be configured together or separately within each compute path 312. Alternatively, the crossbar converter device 344 can also be configured within the crossbar device 360 and be coupled to each compute path 312.

FIG. 3D is a simplified diagram illustrating a matrix compute apparatus 304 according to an example of the present invention. As shown, this apparatus 304 can be configured similarly to the example slice device 302 of FIG. 3B. In contrast, apparatus 304 includes the WB device 322 coupled to the in-memory-compute (IMC) modules 332. Similar to the IB device 320, the WB device 322 is also coupled to the network-on-chip (NOC) device 342 and to a memory device (denoted by input from “GM”). As discussed previously, the WB device 322 can be configured together with the IB device 320.

This apparatus includes at least a data path having an IB device, a compute device coupled to the IB device, an OB device coupled to the compute device, and a SIMD device coupled to the OB device. One or more of these data paths, and each of the components therein, are coupled to a crossbar device, which is also coupled at least to a memory device. Further, a crossbar converter device can be configured within the crossbar device, or within each data path coupled the crossbar device and the OB device. In a specific example, the matrix compute apparatus can be configured in a low precision, high accuracy system for generative LLMs with support for BFP numerics and storage, including on-the-fly quantization and format conversions. This apparatus can also be configured within a chiplet device and/or an AI accelerator device. Depending on the embodiment, this apparatus can include any of the elements and configurations discussed herein.

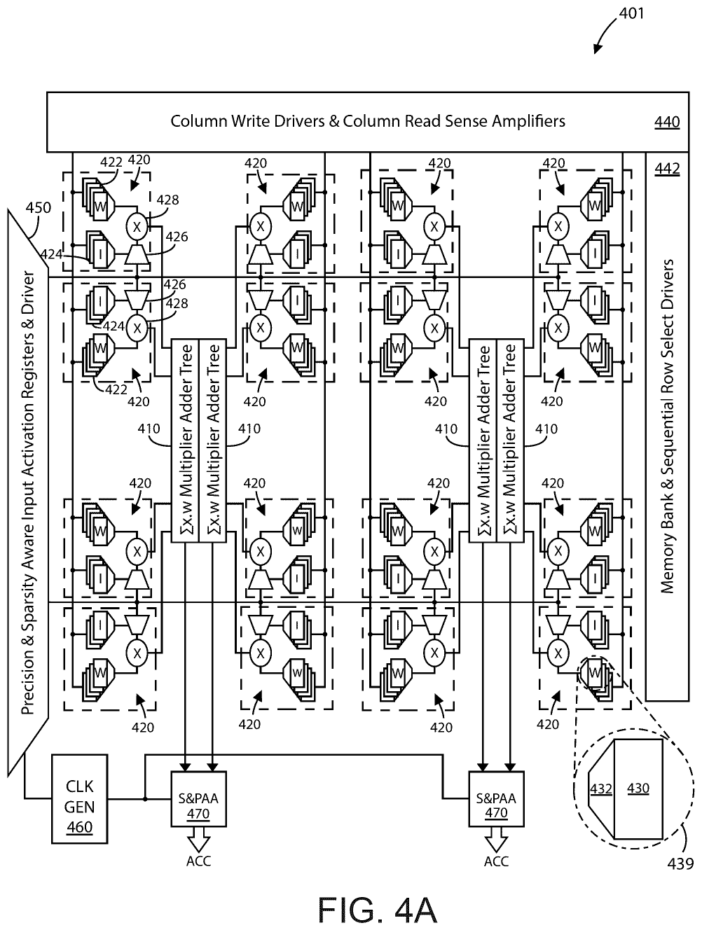

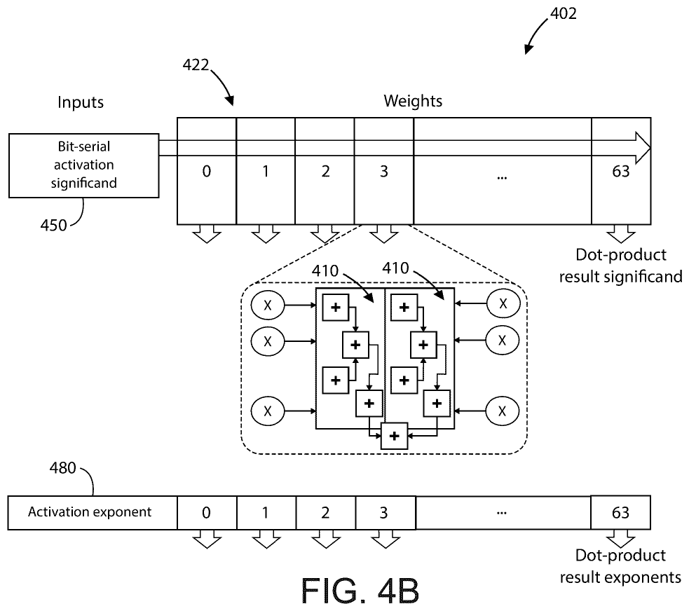

FIG. 4A is a simplified block diagram illustrating an example IMC module 401. As shown, module 401 includes one or more computation tree blocks 410 that are configured to perform desired computations on input data from one or more read-write blocks 420. Each of these read-write blocks 420 includes one or more first memory-select units 422 (also denoted as “W”), one or more second memory-select units 424 (also denoted as “I”), an activation multiplexer 426, and an operator unit 428. The first memory-select unit 422 provides an input to the operator unit 428, while the second memory-select unit 424 controls the activation multiplexer 426 that is also coupled to the operator unit 428. In the case of multiply-accumulate (MAC) operations, the operator unit 428 is a multiplier unit and the computation tree blocks 410 are multiplier adder tree blocks (i.e., Σx.w). In a specific example, these computation tree blocks 410 and these read-write blocks (or computation blocks) 420 are implemented as a dual bit-serial, 4-bit parallel MAC array.

As shown in close-up 439, each of the memory-select units 422, 424 includes a memory cell 430 (e.g., SRAM cell, or the like) and a select multiplexer 432. Each of the memory-select units 422, 424 is coupled to a read-write controller 440, which is also coupled to a memory bank/driver block 442. In an example, the read-write controller 440 can be configured with column write drivers and column read sense amplifiers, while the memory bank/driver block 432 can configured with sequential row select drivers. In an example, the “I” memory cells 430 represent memory units (e.g., in a column configuration) of an input buffer (IB) device while the “W” memory cells 430 represent memory units (e.g., in a column configuration) of a weight buffer (WB) device (see FIGS. 3C and 3D). In a specific example, these memory units can be configured in logic-rule arrays (e.g., 6 nm logic-rule SRAM array)

An input activation controller 450 can be coupled to the activation multiplexer 426 each of the read-write blocks 420. The input activation controller 450 can include precision and sparsity aware input activation register and drivers. The operator unit 428 receives the output of the first memory-select unit 422 and receives the output of this block 450 through the activation multiplexer 426, which is controlled by the output of the second memory-select unit 424. The output of the operator unit 428 is then fed into the computation tree block 410. In a specific example, the module 401 supports a variety of matrix operations, such as 64×64 matrix operations in MXINT8, 64×128 matrix operations in MXINT4, and the like. Further, the module 401 is implemented as a fully digital design for accuracy and precision.

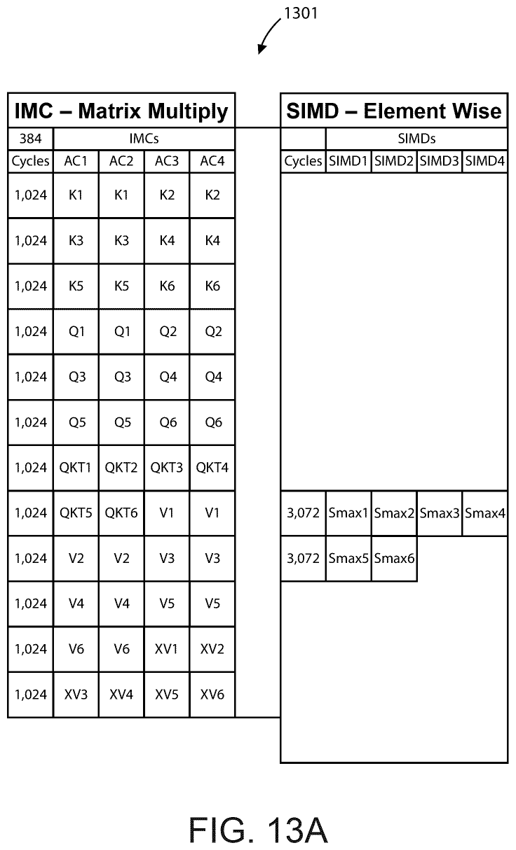

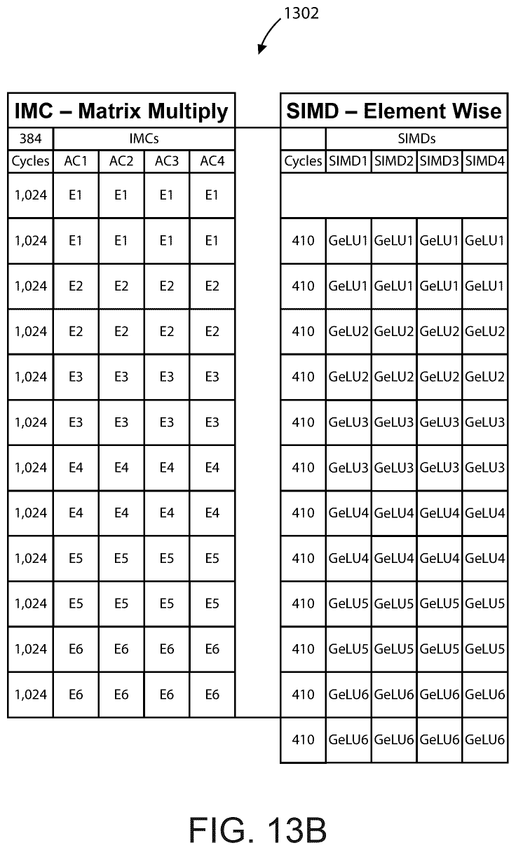

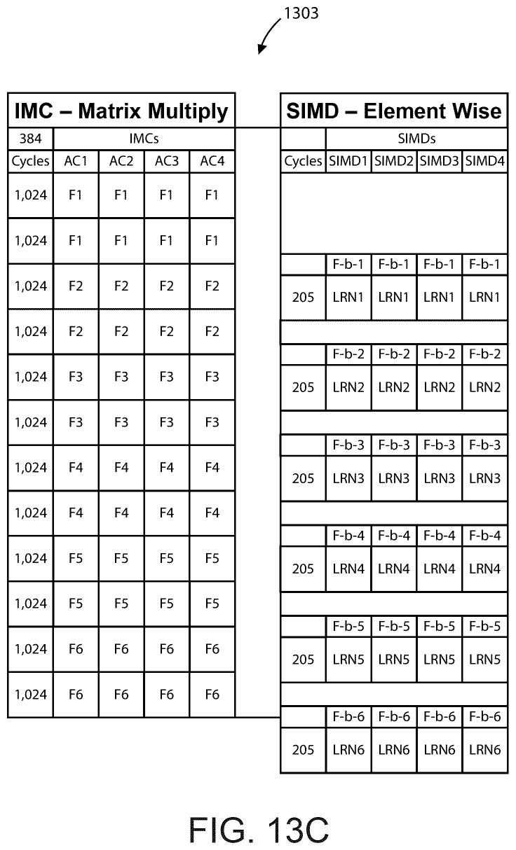

The input activation block 450 is also coupled to a clock source/generator 460. As discussed previously, the clock generator 460 can produce a second clock derived from a first clock configured to output a clock signal of about 0.5 GHz to 4 GHz; the second clock can be configured at an output rate of about one half of the rate of the first clock. The clock generator 460 is coupled to one or more sign and precision aware accumulators 470, which are configured to receive the output of the computation tree blocks 410. In an example, an accumulator 470 is configured to receive the outputs of two computation tree blocks 410. Example output readings of the IMC are shown in FIGS. 13A-13C.

Referring back to the eight-chiplet AI accelerator apparatus example, the memory cell can be a dual bank 2×6T SRAM cell, and the select multiplexer can be an 8T bank select multiplexer. In this case, the memory bank/driver block 442 includes a dual-bank SRAM bank. Also, the read/write controller can include 64 bytes of write drivers and 64 bytes of read sense amplifiers. Those of ordinary skill in the art will recognize other variations, modifications, and alternatives to these IMC module components and their configurations.

FIG. 4B is a simplified block diagram illustrating a method of processing a computational workload using a DIMC array according to an example of the present invention. This diagram includes a simplified version of an IMC module similar to module 401 shown in FIG. 4A; elements marked by the same numbers refer to the same elements and can configured similarly. Here, each DIMC array includes a plurality of bit-serial input registers 450 (see configuration of the input activation registers 450 coupled to memory-select units 424 of FIG. 4A configured with memory cells 430 denoted by “I”), a data type-aware multiply-accumulate (MAC) engine including multiplier and adder trees 410, and a plurality of weight buffers accessed by memory selectors 422 (see memory-select units 422 of FIG. 4A configured with memory cells 430 denoted by “W”).

Here, the activations from the bit-serial input registers 490 are streaming in a dual-bit serial manner to each of the columns of the weight buffer. In this case, each of the weight buffers includes a plurality of columns (e.g., 32 columns, 64 columns, 128 columns, etc.), but row configurations may be used depending on the system configuration. Each column is coupled to a pair of multipliers and adder trees 410 that allow the unit to process all combinations of desired operands (e.g., 4-bit, 8-bit, 16-bit, etc.). In addition, the DIMC cores are paired with a flexible partial product reduction (PPR) engine (see FIG. 3B) that allows for PPR to be performed at a various granularity levels (e.g., 1× DIMC, 2× DIMCs, 4×, 8×, etc.).

Through bit-serial activation and precision-aware adder logic, DIMC arrays perform energy-efficient integer dot product operations. Furthermore, dedicated shift/align logic 480 handles shared exponents which forms the basis of accurate and efficient block floating point (BFP) tensor operations. Referring back to apparatus 102 shown in FIG. 1B, such DIMC arrays can be configured such that the DIMC arrays include a total of 2048 DIMC cores in the PCIe card configuration. Depending on the application, the total number of DIMC cores in the AI accelerator apparatus and the number of DIMC cores per chiplet or slice can vary. Those of ordinary skill in the art will recognize variations, modifications, and alternatives to this workload processing method can the configuration of the DIMC array.

Large neural networks have fairly high tolerances for low precision quantization. However, naive integer arithmetic degrades the inference results considerably. According to an example, the present invention provides a method of implementing block floating point (BFP) formats which combine wide dynamic range, numerical accuracy, and efficient hardware implementation of inner products using simple integer arithmetic. BFP formats are represented by an array of integer elements sharing one exponential scaling factor. The simplest implementation has the scale factor as a power of two. In this case, the inner product between two blocks involves multiplying the integer mantissas and adding the two block exponents.

In a specific example, the DIMC can be configured to support block sizes ranging from 64 to 128 elements, which is optimal for 8 and 4 bit precisions. Depending on the application, the DIMC can be configured to support other block sizes based on the precision level or other related factors. As discussed previously, numerous hardware converters (see FIG. 3C) can be used to allow seamless conversion between formats, such as from floating point (FP) to BFP and vice versa. Also, advanced storage-only formats, such as Scaled-BFP (SBFP) and the like, can also be supported. In a specific example, the SBFP format with 4-bit integer elements and block size of 16 shows negligible degradation in accuracy compared to 8-bit BFP while offering almost 2× storage reduction. Further, tensors in the SBFP format can be decompressed natively in hardware. Further examples regarding numerical formats are described below.

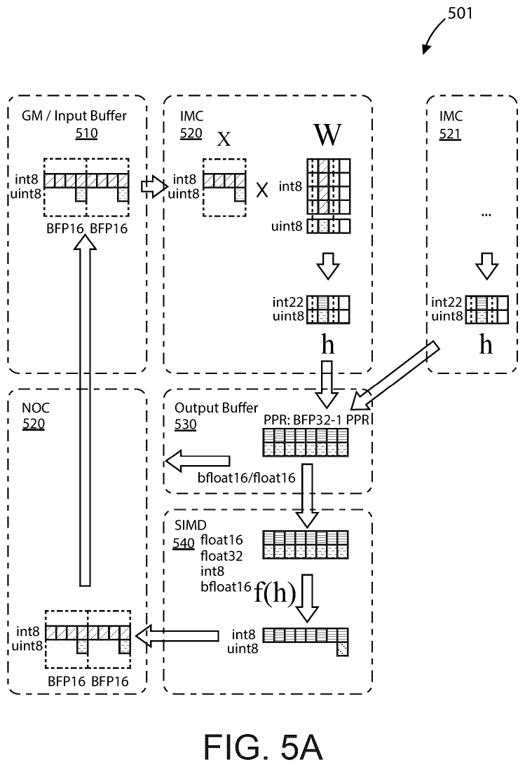

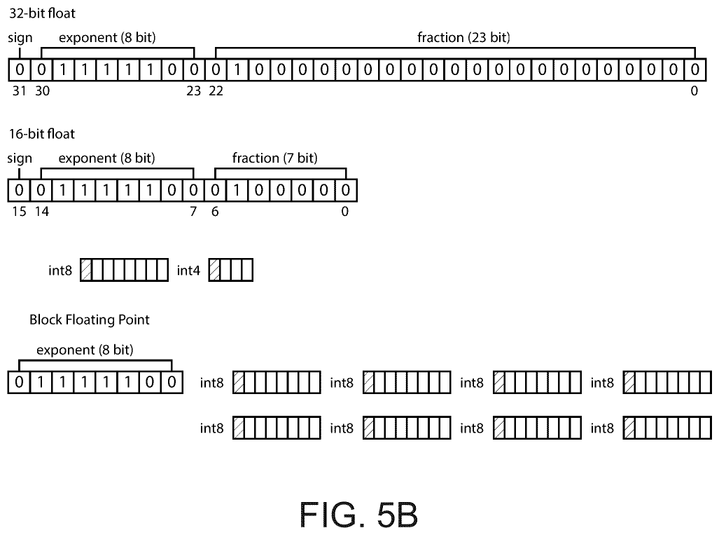

FIG. 5A is a simplified block flow diagram illustrating example numerical formats of the data being processed in a slice. Diagram 501 shows a loop of a computational workload operation with the data formats used within the global memory (GM)/input buffer (IB) 510, the digital in-memory compute (DIMC) array (including IMC 520 and 521), the output buffer (OB) 530, the SIMD 540, and the network-on-chip (NoC) 550, which feeds back to the GM/IB 510. In a specific example, this flow diagram 501 represents processing a workload involving tensor operations using certain hardware-native formats.

Inputs for workload operations can include activations and weights that received by the IB 510 from GM or via the NoC 550. As discussed previously, a DIMC device can include an array of IMC units configured to perform portions of the workload that require matrix computations, such as multiply-accumulate operations. The IMC operations 520 and 521 (performed in parallel) show the multiply-accumulate operations (Σx.w) between the activations (denoted by “x”) and the weights (denoted by “W”), each of which are stored as blocks of integer (int) mantissas with a shared int exponent.

In the output buffer 530, the matrix multiplication output and a partial products reduction (PPR) operation output are stored in full 32-bit block floating point precision (BFP32-1). These values are then inline converted to half precision floating point (float16) for operations by the SIMD 540, if applicable. The results of the DIMC operation (including IMC 520 and IMC 521) or the SIMD operation 540 are inline converted again to BFP format and sent to the IB 510 via the NoC 550 before the next matrix multiplication. Further examples are discussed with reference to FIG. 5B.

FIG. 5B is a simplified diagram illustrating certain numerical formats, including certain formats shown in FIG. 5A. BFP numerics can be used to address certain barriers to performance. Training of transformers is generally done in floating point, i.e., 32-bit float or 16-bit float, and inference is generally done in 8-bit integer (“int8”). With BFP, an exponent is shared across a set of mantissa significant values (see diagonally line filled blocks of the int8 vectors at the bottom of FIG. 5B), as opposed to floating point where each mantissa has a separate exponent (see 32-bit float and 16-bit float formats at the top of FIG. 5A). The method of using BFP numerical formats for training can exhibit the efficiency of fixed point without the problems of integer arithmetic, and can also allow for use of a smaller mantissa, e.g., 4-bit integer (“int4”) while retaining accuracy. Further, by using the block floating point format (e.g., for activation, weights, etc.) and sparsity, the inference of the training models can be accelerated for better performance.

In an example, the present invention can implement support for microscaling (MX) numerics (e.g., MXINT4, MXINT8, MXINT16, etc.) along with BFP numerics (e.g., BFP12, BFP16, BFP 24, etc.). Certain data formats can be designated as compute formats (e.g., MXINT8-64, MXINT4-128, etc.), while others can be designated as storage formats (e.g., SBFP12-16, sparse SBFP12-16 [16:8, 16:4, 16:2], etc.). Using these data formats, the present accelerator apparatuses can support various levels of weight compression (e.g., compression ratio [CR] of 1 for MXINT8-64, CR of 1.8 for SFBP12-16, CR of 2.3 for SBFP12-16:8, CR of 3.3 for SBFP12-16:4, CR of 5.4 for SBFP12-16:2, etc.). Depending on the application, other numerical formats may be used as well. Those of ordinary skill in the art will recognize other variations, modifications, and alternatives to these numerical formats used to process computational workloads.

Currently, the vast majority of NLP models are based on the transformer model, such as the bidirectional encoder representations from transformers (BERT) model, BERT Large model, and generative pre-trained transformer (GPT) models such as GPT-2 and GPT-3, etc. However, as discussed previously, these transformers have very high compute and memory requirements. In an example, the present AI accelerator apparatus can be configured to accelerator transformer workloads. The following figures further describe the transformer workload and how the workload can be mapped to the AI accelerator apparatus to execute its computations.

FIG. 6 illustrates a simplified transformer architecture 600. The typical transformer can be described as having an encoder stack configured with a decoder stack, and each such stack can have one or more layers. Within the encoder layers 610, a self-attention layer 612 determines contextual information while encoding input data and feeds the encoded data to a feed-forward neural network 616. The encoder layers 610 process an input sequence from bottom to top, transforming the output into a set of attention vectors K and V. The decoder layers 620 also include a corresponding self-attention layer 622 and feed-forward neural network 626, and can further include an encoder-decoder attention layer 624 uses the attention vectors from the encoder stack that aid the decoder in further contextual processing. The decoder stack outputs a vector of floating points (as discussed for FIG. 5B), which is fed to linear and softmax layers 630 to project the output into a final desired result (e.g., desired word prediction, interpretation, or translation). The linear layer is a fully-connected neural network that projects the decoder output vector into a larger vector (i.e., logits vector) that contains scores associated with all potential results (e.g., all potential words), and the softmax layer turns these scores into probabilities. Based on this probability output, the projected word meaning may be chosen based on the highest probability or by other derived criteria depending on the application.

Transformer model variations include those based on just the decoder stack (e.g., transformer language models such as GPT-2, GPT-3, etc.) and those based on just the encoder stack (e.g., masked language models such as BERT, BERT Large, etc.). Transformers are based on four parameters: sequence length(S) (i.e., number of tokens), number of attention heads (A), number of layers (L), and embedding length (H). Variations of these parameters are used to build practically all transformer-based models today. Embodiments of the present invention can be configured for any similar model types.

A transformer starts as untrained and is pre-trained by exposure to a desired data set for a desired learning application. Transformer-based language models are exposed to large volumes of text (e.g., Wikipedia) to train language processing functions such as predicting the next word in a text sequence, translating the text to another language, etc. This training process involves converting the text (e.g., words or parts of words) into token IDs, evaluating the context of the tokens by a self-attention layer, and predicting the result by a feed forward neural network.

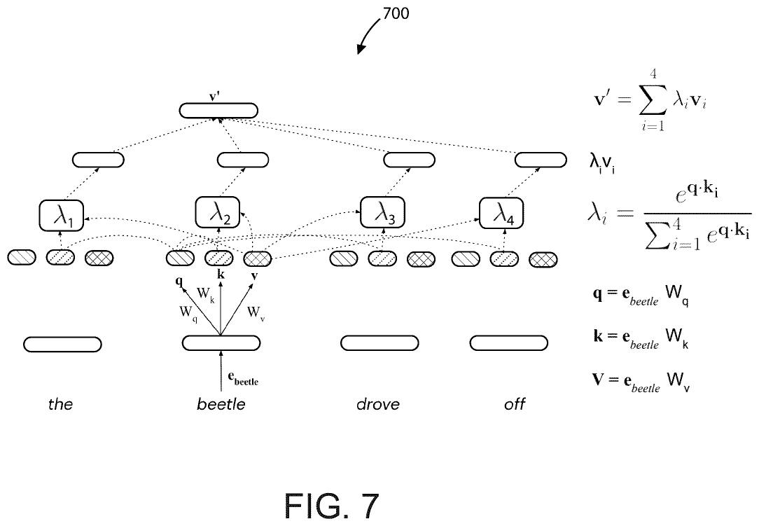

The self-attention process includes (1) determining query (Q), key (K), and value (V) vectors for the embedding of each word in an input sentence, (2) calculating a score for from the dot product of Q and K for each word of the input sentence against a target word, (3) dividing the scores by the square root of the dimension of K, (4) passing the result through a softmax operation to normalize the scores, (5) multiplying each V by the softmax score, and (6) summing up the weighted V vectors to produce the output. An example self-attention process 700 is shown in FIG. 7.

As shown, process 700 shows the evaluation of the sentence “the beetle drove off” at the bottom to determine the meaning of the word “beetle” (e.g., insect or automobile). The first step is to determine the q_{beetle}, k_{beetle}, and v_{beetle} vectors for the embedding vector e_{beetle}. This is done by multiplying e_{beetle} by three different pre-trained weight matrices W_{q}, Wₖ, and Wᵥ. The second step is to calculate the dot products of q_{beetle} with the K vector of each word in the sentence (i.e., kₜₕₑ, k_{beetle}, k_{drove}, and k_{off}), shown by the arrows between q_{beetle} and each K vector. The third step is to divide the scores by the square root of the dimension dₖ, and the fourth step is to normalize the scores using a softmax function, resulting in λᵢ. The fifth step is to multiply the V vectors by the softmax score (λᵢvᵢ) in preparation for the final step of summing up all the weight value vectors, shown by v′ at the top.

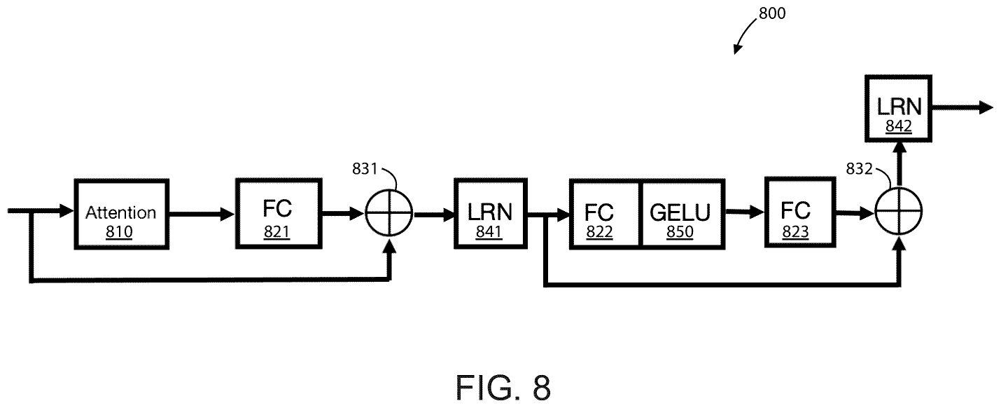

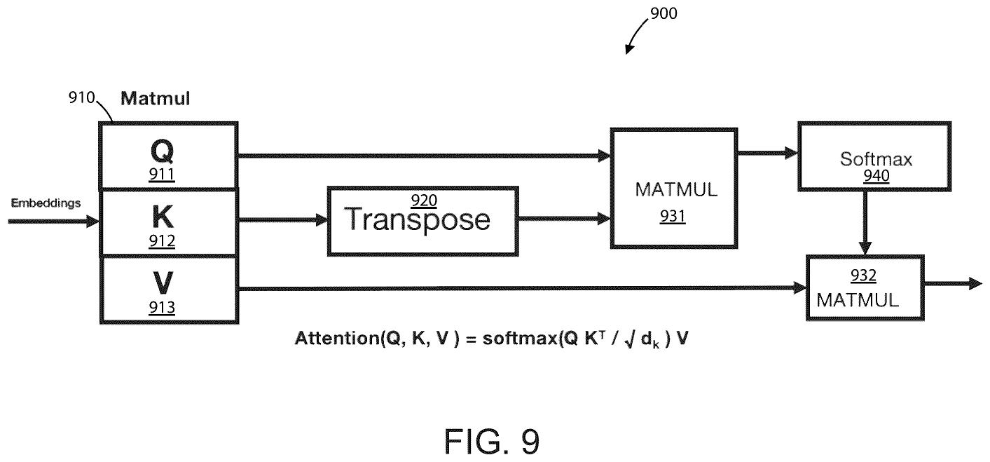

Process 700 only shows the self-attention process for the word “beetle”, but the self-attention process can be performed for each word in the sentence in parallel. The same steps apply for word prediction, interpretation, translation, and other inference tasks. Further details of the self-attention process in the BERT Large model are shown in FIGS. 8 and 9.

A simplified block diagram of the BERT Large model (S=384, A=16, L=34, and H=1024) is shown in FIG. 8. This figure illustrates a single layer 800 of a BERT Large transformer, which includes an attention head device 810 configured with three different fully-connected (FC) matrices 821-823. As discussed previously, the attention head 810 receives embedding inputs (384×1024 for BERT Large) and measures the probability distribution to come up with a numerical value based on the context of the surrounding words. This is done by computing different combination of softmax around a particular input value and producing a value matrix output having the attention scores.

Further details of the attention head 810 are provided in FIG. 9. As shown, the attention head 900 computes a score according to an attention head function: Attention (Q, K, V)=softmax (QK^{T}/√dₖ) V. This function takes queries (Q), keys (K) of dimension dₖ, and values (V) of dimension dₖ and computes the dot products of the query with all of the keys, divides the result by a scaling factor √dₖ and applies a softmax function to obtain the weights (i.e., probability distribution) on the values, as shown previously in FIG. 7.

The function is implemented by several matrix multipliers and function blocks. An input matrix multiplier 910 obtains the Q, K, and V vectors from the embeddings. The transpose function block 920 computes K^{T}, and a first matrix multiplier 931 computes the scaled dot product QK^{T}/√dₖ. The softmax block 940 performs the softmax function on the output from the first matrix multiplier 931, and a second matrix multiplier 932 computes the dot product of the softmax result and V.

For BERT Large, 16 such independent attention heads run in parallel on 16 AI slices. These independent results are concatenated and projected once again to determine the final values. The multi-head attention approach can be used by transformers for (1) “encoder-decoder attention” layers that allow every position in the decoder to attend over all positions of the input sequence, (2) self-attention layers that allows each position in the encoder to attend to all positions in the previous encoder layer, and (3) self-attention layers that allow each position in the decoder to attend to all positions in the decoder up to and including that position. Of course, there can be variations, modifications, and alternatives in other transformers.

Returning to FIG. 8, the attention score output then goes to a first FC matrix layer 821, which is configured to process the outputs of all of the attention heads. The first FC matrix output goes to a first local response normalization (LRN) block 841 through a short-cut connection 830 that also receives the embedding inputs. The first LRN block output goes to a second FC matrix 822 and a third FC matrix 823 with a Gaussian Error Linear Unit (GELU) activation block 850 configured in between. The third FC matrix output goes to a second LRN block 842 through a second short-cut connection 832, which also receives the output of the first LRN block 841.

Using a transformer like BERT Large, NLP requires very high compute (e.g., five orders of magnitude higher than CV). For example, BERT Large requires 5.6 giga-multiply-accumulate operations per second (“GMACs”) per transformer layer. Thus, the NLP inference challenge is to deliver this performance at the lowest energy consumption.

Although the present invention is discussed in the context of a BERT Large transformer for NLP applications, those of ordinary skill in the art will recognize variations, modifications, and alternatives. The particular embodiments shown can also be adapted to other transformer-based models and other AI/machine learning applications.

Many things impact the performance of such transformer architectures. The softmax function tends to be the critical path of the transformer layers (and has been difficult to accelerate in hardware). Requirements for overlapping the compute, SIMD operations and NoC transfers also impacts performance. Further, efficiency of NoC, SIMD, and memory bandwidth utilization is important as well.

Different techniques can be applied in conjunction with the AI accelerator apparatus and chiplet device examples to improve performance, such as quantization, sparsity, knowledge distillation, efficient tokenization, and software optimizations. Supporting variable sequence length (i.e., not requiring padding to the highest sequence lengths) can also reduce memory requirements. Other techniques can include optimizations of how to split self-attention among slices and chips, moving layers and tensors between the slices and chips, and data movement between layers and FC matrices.

According to an example, the present invention provides for an AI accelerator apparatus (such as shown in FIGS. 1A and 1B) coupled to an aggregate of transformer devices (e.g., BERT, BERT Large, GPT-2, GPT-3, or the like). In a specific example, this aggregate of transformer devices can include a plurality of transformers configured in a stack ranging from three to N layers, where N is an integer up to 128.

In an example, each of the transformers is configured within one or more DIMCs such that each of the transformers comprises a plurality of matrix multipliers including QKV matrices configured for an attention layer of a transformer followed by three fully-connected matrices (FC). In this configuration, the DIMC is configured to accelerate the transformer and further comprises a dot product of Q K^{T} followed by a softmax (Q K^{T}/square root (dₖ)) V. In an example, the AI accelerator apparatus also includes a SIMD device (as shown in FIGS. 3A and 3B) configured to accelerate a computing process of the softmax function.

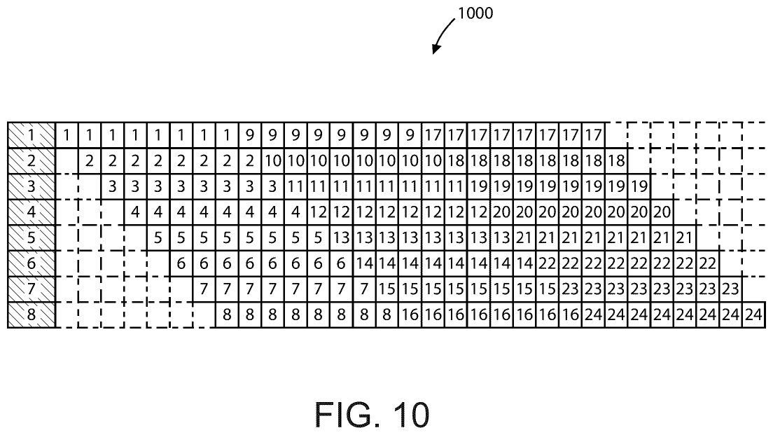

According to an example, the present invention provides for methods of compiling the data representations related to transformer-based models mapping them to an AI accelerator apparatus in a spatial array. These methods can use the previously discussed numerical formats as well as sparsity patterns. Using a compile algorithm, the data can be configured to a dependency graph, which the global CPU can use to map the data to the tiles and slices of the chiplets. Example mapping methods are shown in FIGS. 10-13B.

FIG. 10 is a simplified table representing an example mapping process between a 24-layer transformer and an example eight-chiplet AI accelerator apparatus. As shown, the chiplets are denoted by the row numbers on the left end and the model layers mapped over time are denoted by the table entry numbers. In this case, the 24 layers of the transformer (e.g., BERT Large) are mapped to the chiplets sequentially in a staggered manner (i.e., first layer mapped onto the first chiplet, the second layer mapped onto the second chiplet one cycle after the first, the third layer mapped onto the third chiplet two cycles after the first, etc.) After eight cycles, the mapping process loops back to the first chiplet to start mapping the next eight model layers.

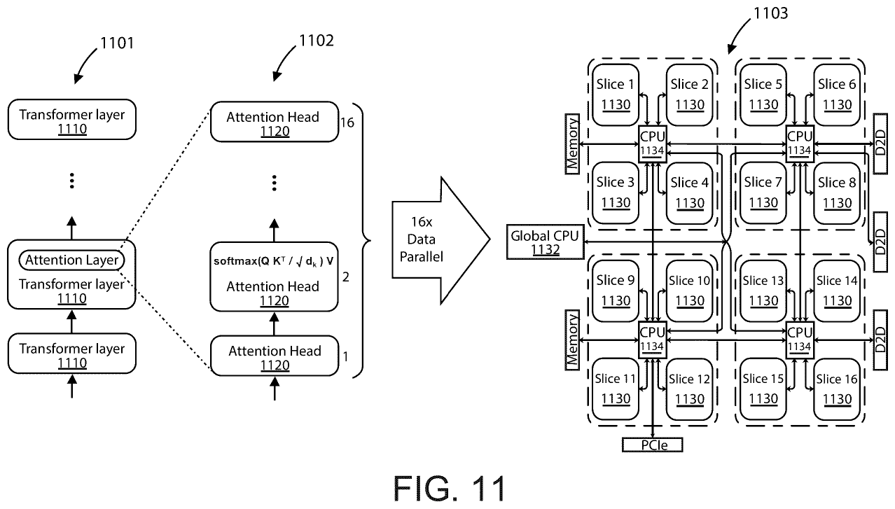

FIG. 11 is a simplified block flow diagram illustrating a mapping process between a transformer and an example AI accelerator apparatus. As shown, a transformer 1101 includes a plurality of transformer layers 1110, each having an attention layer 1102. In this case, there are 16 attention heads 1110 (e.g., BERT Large) computing the attention function as discussed previously. These 16 attention heads are mapped to 16 slices 1130 of an AI accelerator apparatus 1103 (similar to apparatuses 201 and 202) via global CPU 1132 communicating to the slice CPUs 1134.

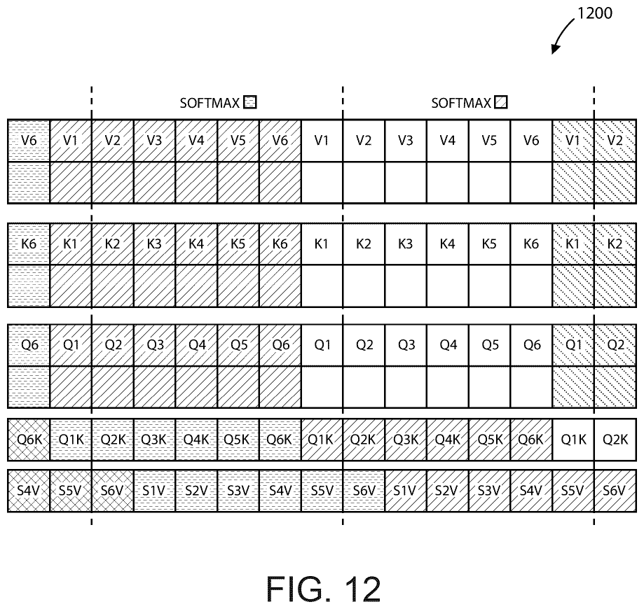

FIG. 12 is a simplified table representing an example tiling attention process between a transformer and an example AI accelerator apparatus. Table 1200 shows positions of Q, K, and V vectors and the timing of the softmax performed on these vectors. The different instances of the softmax are distinguished by fill pattern (e.g., diagonal line filled blocks representing Q, K, V vectors and diagonal line filled blocks representing Q-K and Softmax-V dot products).

In an example, the embedding E is a [64L, 1024] matrix (L=6 for sentence length of 384), and Eᵢ is a [64, 1024] submatrix of E, which is determined as Eᵢ=E_{(64i-63):(64i). 1:1024}, where i=1 . . . . L. Each of the K and Q matrices can be allocated to two slices (e.g., @ [SL1: AC3,4]: Kᵢ←Eᵢ×K_{1 . . . 1024. 1 . . . 64}; and @ [SL1: AC1,2]: Qᵢ←Eᵢ×Q_{1 . . . 1024.1 . . . 64}). An example data flows through IMC and SIMD modules are shown in the simplified tables of FIGS. 13A-13C.

FIG. 13A shows table 1301 representing mapping self-attention to an AI slice according to an example of the present invention. The left side shows the IMC cycles for matrix multiplications performed by IMC modules AC1-AC4, while the right side shows SIMD cycles for element-wise computations performed by SIMD modules SIMD1-SIMD4. In this example, the IMC modules determine the key vectors K1-K6 (a[64×512]; w[512×64]; o[64×64]), and query vectors Q1-Q6 (a[64×512]; w[512×64]; o[64×64]), followed by the transpose QKT1-QKT6 (a[64×64]; w[64×384]; o[64×384]). Then, the SIMD modules compute the softmax Smax1-Smax6 (a[64×384]). Meanwhile, the IMC modules determine the value vectors V1-V6 (a[64×512]; w[512×64]; o[64×64]), followed by the multiplication of the value vectors and the softmax results.

FIG. 13B shows table 1302 representing mapping dense embedding vectors and the second FC matrix to an AI slice (left: IMCs; right: SIMDs) according to an example of the present invention. In this example, the IMCs process the embedding vectors E1-E6 (a[64×512]; w[512×64]; o[64×64]), which corresponds to the path from the attention head 810 to the second FC matrix 822 in FIG. 8. Following the processing of each embedding vector E, the SIMDs process the GELU (a[64×64]), which corresponds to the path through the first LRN block 841 and the GELU block 850 in FIG. 8.

FIG. 13C shows table 1303 representing mapping the third FC matrix to an AI slice (left: IMCs; right: SIMDs) according to an example of the present invention. In this example, the IMCs process the results through the second FC matrix, which corresponds to the path through the third FC matrix 823 and the second LRN block 842 in FIG. 8. Those of ordinary skill in the art will recognize other variations, modifications, and alternatives to the mappings shown in FIGS. 10-13C.

According to an example, the advancement of artificial intelligence (AI) and large language models (LLMs) facilitated by high-speed inference engines can be improved or even optimized with the present chiplet-based processor and memory hardware. The use of advanced hardware accelerators configured with the chiplets and high-bandwidth memory, for example, enhances computational efficiency, reducing latency and power consumption while increasing throughput. The advancements enable real-time decision-making and automation across a wide range of industries. This disclosure describes applications of high-speed inference engines in domains such as natural language processing (NLP), reasoning, video and image processing, cybersecurity, manufacturing, drug discovery, and autonomous AI agents. By integrating AI-driven capabilities into these sectors, we can achieve improvements in efficiency, automation, and decision-making. This disclosure provides an example of these engines across multiple applications.

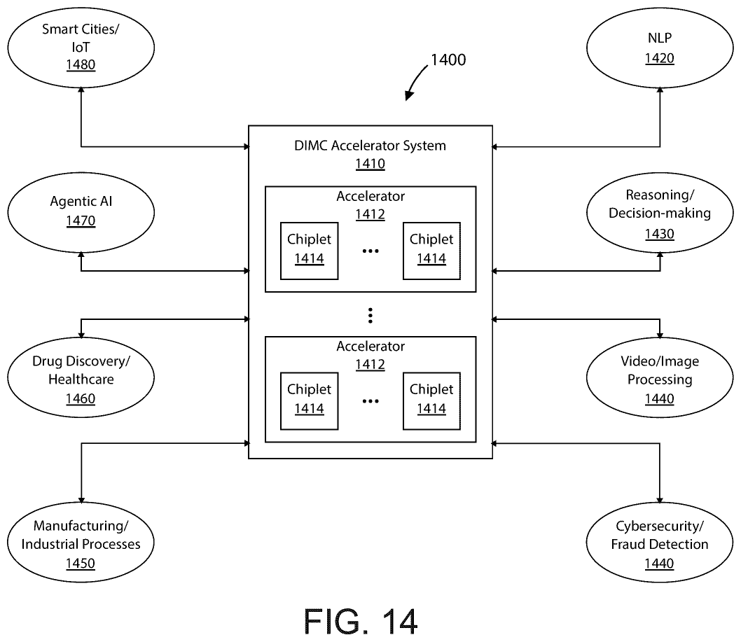

FIG. 14 is a simplified block diagram 1400 illustrating a digital in-memory compute (DIMC) accelerator system configured for a variety of AI applications according to an example of the present invention. The block diagram 1400 includes a DIMC accelerator system 1410 includes a plurality of accelerator apparatuses 1412, each of which includes a plurality of chiplets 1414. These accelerator apparatuses 1412 and chiplets 1414 can be configured similarly to the examples discussed previously. As shown, the DIMC accelerator system 1410 can be used for a variety of applications, including, but not limited to, Natural Language Processing (NLP) 1420, autonomous reasoning/decision-making 1430, video/image processing 1440, cybersecurity/fraud detection 1450, manufacturing/industrial processes 1460, agentic AI 1470, and smart cities/Internet of Things (IOT) 1480. AI agents can use multiple small models (e.g., small language models [SLMs]) for these applications to ensure task specialization.

In a specific example, the present accelerator apparatuses can use the DIMC architecture and high memory bandwidth to significantly speed up the processing of target computational workloads of a particular application, such as those mentioned previously. The DIMC accelerator system can perform precise and efficient computations of data in a block floating point (BFP) format and can also switch to a lower precision floating point (FP) during runtime. By dynamically switching between precision levels based on real-time analysis of the target workload, the DIMC system can optimize computational efficiency while maintaining the necessary level of accuracy for each step of the workload computation. And with a high memory bandwidth, the DIMC architecture enables a high throughput of workload computations. Specific applications are discussed in further detail below.

As discussed previously, the present techniques can be configured for NLP, such as shown in FIG. 7. In an example, NLP applications configured by high-speed inference engines are provided in communication, information retrieval, content generation, and other applications. AI-powered chatbots and virtual assistants provide human-like interactions for customer service and enterprise automation. Real-time translation and transcription services bridge language barriers, while AI-driven search engines deliver contextualized responses to complex queries. In journalism and legal analysis, for example, the present AI assists in summarizing large volumes of text and identifying key insights. In a preferred example, chiplet-based AI accelerators are configured with NLP workloads by distributing tasks across multiple processing units, improving efficiency in model execution.

In an example, the present techniques are configured for reasoning and decision-making. That is, high-speed inference engines enhance AI-driven decision-making, enabling autonomous reasoning in applications such as financial analysis, legal research, scientific hypothesis generation, and others. Financial markets benefit from AI-based trading systems capable of making real-time risk assessments, while the legal industry leverages AI for contract analysis and regulatory compliance. Scientific research is further accelerated by AI's ability to analyze datasets and simulate experiments, driving innovation in fields like genomics and materials science. The integration of the present chiplet-based architectures within AI hardware allows for distributed processing, increasing computational efficiency and supporting more various models.

In an example, the present techniques are configured for video and image processing, such as for computer vision (CV) applications. In an example, AI-powered video and image processing applications include surveillance, healthcare, and entertainment. In an example, the present high-speed inference engines facilitate real-time video analytics (e.g., facial), enabling security systems to detect anomalies and track individuals. In healthcare, AI-driven medical imaging provides diagnostic accuracy in radiology and pathology. Additionally, generative AI is content creation by automating video editing and generating realistic visual media for entertainment and advertising. The incorporation of high-bandwidth memory in AI accelerators according to the present technique provides data access, reducing bottlenecks in processing large-scale image, video datasets, and others.

In an example, the present techniques are configured for cybersecurity and fraud detection. In an example, cybersecurity using chiplet-based AI-powered inference engines contribute to real-time threat detection and risk mitigation. In example, the present AI systems analyze network traffic patterns to identify cyber threats, while fraud detection models in banking and e-commerce prevent financial crimes. Automated penetration testing further enhances security by identifying system vulnerabilities before exploitation occurs. In an example, the utilization of AI hardware with chiplets enables rapid (e.g., nearly real-time) anomaly detection and real-time response, ensuring cybersecurity defenses.

In an example, the present techniques are configured for manufacturing and advanced Industry 4.0 (a.k.a. the Fourth Industrial Revolution or 4IR). Industry 4.0 can be defined as the integration of intelligent digital technologies into manufacturing and industrial processes and includes a set of technologies that include industrial IoT (Internet of Things) networks, AI (Artificial Intelligence), Big Data (e.g., large datacenters), robotics, automation, among other technologies based upon compute. In an example, AI-driven manufacturing is provided with industrial processes through predictive maintenance, robotic automation, and supply chain optimization. In an example, the present chiplet-based high-speed inference engines power intelligent robotics for assembly and quality control, and reducing or event minimizing human intervention. In an example, predictive maintenance systems analyze sensor data to prevent equipment failures, reducing downtime and operational costs. AI-powered logistics and inventory management enhance supply chain efficiency by dynamically adjusting production schedules. The present chiplet-based accelerators in industrial AI systems provide execution of complex manufacturing workflows by efficiently managing parallel computations in an example.

In an example, the present techniques are configured for drug discovery and healthcare. In an example, the present techniques can be applied to AI-driven drug discovery, where high-speed chiplet-based inference engines facilitate molecular simulations and compound screening. In an example, AI algorithms predict drug efficacy and improve and/or optimize clinical trial processes, accelerating the development of new treatments and discoveries. In an example, personalized medicine, enabled by AI's analysis of patient genomics, allows for tailored therapies with improved outcomes. In healthcare, for example, AI-powered diagnostic tools assist medical professionals by analyzing patient data and identifying potential health risks. In an example, the present AI accelerators provide for bioinformatics processing, enabling faster analysis of large-scale genomic datasets.

In an example, the present techniques are configured for agentic AI applications. In an example, the present agentic AI systems provide for AI-driven automation, characterized by autonomous decision-making and task execution with no or minimal human oversight. The intelligent agents autonomously conduct research, manage business operations, and optimize supply chains, etc. In an example, AI-powered legal agents provide in contract negotiation and compliance monitoring, while autonomous AI-driven customer service agents handle inquiries and support requests without human intervention. In an example, an emergence of AI-powered CEOs and business decision-makers are enabled with agentic AI in strategic planning, enterprise management, and other applications. In an example, the present hardware accelerators including chiplets and high-bandwidth memory further enhance these applications by enabling real-time learning and adaptation.

In an example, the present techniques are configured for smart cities and IoT. In an example, smart cities are configured using the present AI-powered inference engines to optimize urban infrastructure, traffic management, energy distribution, among other applications. In an example, AI-driven traffic control systems reduce congestion by analyzing real-time data, while smart grid solutions enhance energy efficiency through predictive analytics. In an example, environmental monitoring applications utilize AI to track pollution levels and model climate change impacts, enabling data-driven policy decisions. In an example, the present AI hardware accelerators provide for low-latency processing, making real-time optimizations feasible for large-scale IoT deployments.

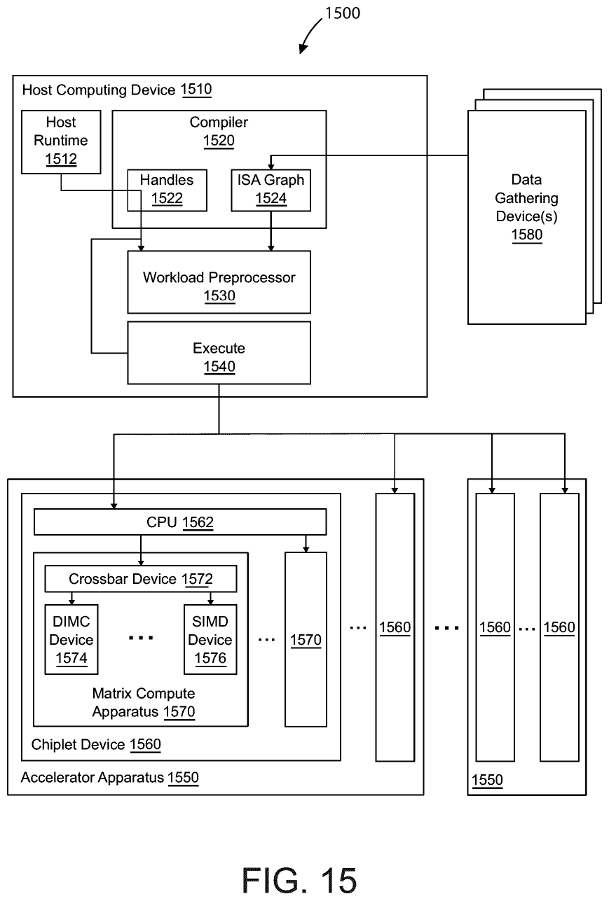

FIG. 15 is a simplified block diagram illustrating a digital in-memory compute (DIMC) accelerator system according to an example of the present invention. As shown, the system 1500 includes a host computing device 1510 with a host runtime 1512 that operates at least a compiler stack 1520, a workload preprocessor 1530, and an execute stack 1540. The host device 1510 is configured to manage and coordinate the plurality of accelerator apparatuses 1512 to perform computational workloads for target applications, such as those discussed previously. Embodiments of this configurable system 1500 allow for the selection of computing throughput, latency, energy consumption, and functional accuracy.

The compiler stack 1520 includes at least a handles layer 1522 and an instruction set architecture (ISA) graph layer 1524. The host runtime 1512 can use the handles layer 1522 to determine references to resources for program, workload, or model; and the host runtime 1512 can use the ISA graph layer 1524 to translate the program, workload, or model into an ISA graph. For example, the ISA graph layer 1524 can translate a computation graph representing a target neural network model workload in machine code.

The workload preprocessor 1530 can be configured to determine a plurality of workload parameters using the translated computation graph from the ISA graph layer 1524. Afterwards, the host runtime 1512 can use the compiler stack 1520 to issue commands for the workload parameters and instructions to the execute stack 1540, which sends these commands to a target hardware. Those of ordinary skill in the art will recognize other variations, modifications, and alternatives to configuration of the host computing device 1510 and the associated software system.

The host computing device 1510 is also coupled to one or more data gathering devices 1580. Each such data gathering device 1580 can be configured to obtain data for one or more target applications (e.g., for a program, workload, or model) and to send the data to the host computing device 1510 to be translated as an ISA graph to be processed via the plurality of accelerator apparatuses 1512. Depending on the application, these data gathering devices 1520 can take many forms and implement different methods. To gather text data for NLP or image/video data for CV, the data gathering device 1520 can include a web-scraping device, a dataset reader device, a crowdsourcing device, and the like. Similar methods can be used to gather data for financial analysis, legal research, scientific research, and other fields as well.

For gathering real-time data, the data gathering device 1520 can include a variety of sensor devices, such as medical imaging devices used to capture patient data, equipment monitoring devices used to determine manufacturing data, network scanning devices used to detect abnormal transactions, and others. The data gathering device 1520 can also accumulate data from a network of devices, vehicles, appliances or other physical objects embedded with sensors, software and network connectivity (i.e., IoT). Further, the scale of such a network of devices can be expanded to smart city networks that manage traffic flow, energy systems, waste collection, and the like.

In addition, the data gathering device 1520 can be configured to analyze collected data to determine fraudulent activity or run simulations using collected data to drive autonomous reasoning and decision-making. For example, traffic data can be analyzed and simulated to assist in autonomous vehicle pathing, supply chain data can be analyzed and simulated to assist in delivery routes and manage inventory, medical data can be analyzed and simulated to assist in personalized treatment schedules or even assist in new discoveries, etc., Of course, there can be other variations, modifications, and alternatives the devices and methods used to gather data for the present DIMC accelerator system.

In an example, the target hardware includes a plurality of accelerator apparatus 1550 with a plurality of chiplet devices 1560 coupled to a CPU 1562, which can include a global CPU and a plurality of local CPUs. The chiplet CPU 1562 is coupled to a plurality of matrix compute apparatuses 1570 via their crossbar devices 1572, each of which is coupled to at least a compute device 1574 (e.g., DIMC device) and a Single Input, Multiple Data (SIMD) device 1576. In an example, the compiler commands are sent to accelerator apparatuses 1550, which can be used to program the CPU 1532 (or CPUs) and connected elements of matrix compute apparatus 1570 via the crossbar device 1572. The AI accelerator apparatus 1550, the chiplet devices 1560, and the matrix compute apparatus 1570 can be configured similarly to any of the previously discussed examples.

In a specific example, the host device 1510 and the plurality of accelerator apparatuses 1512 can be configured within a server device or within multiple connected server devices of a server system. In such cases, the host device 1510 can be configured to coordinate the operations of the accelerator apparatuses 1512 in the server device or a host server can be configured to coordinate the operations of the server devices in the server system.

In an example, the accelerator apparatus 1550 can be configured with on-device support for autoregressive graph execution. The compute apparatuses 1570 of the chiplet devices 1560 can enable this functionality via an autoregression engine that is coupled to the compute apparatus 1570, an inference engine, and the compiler 1520. The autoregression engine is configured to process autoregressive model workloads (e.g., base compiled model from the compiler 1520) to automatically expand spatial and temporal spans with growing context, and can do so without additional host-device interaction. The autoregression engine provides the autoregression outputs (e.g., iteration specific binary data) to the compute apparatus 1570, which determines results from the autoregression outputs used by the inference engine to generate new parameters. Then these parameters are used autoregression engine to further predict future values.

In an example, the inference engine can be configured to large language model (LLM) serving (i.e., process of making trained language models available for inference), such as for an LLM client operating from a user facing application programming interface (API) server. The inference engine acts as the brain of the serving processes and can include a resource manager, an LLM state machine, and a batcher/dispatcher. The serving processes can include managing tensor and pipeline parallelism, model-aware algorithms, dynamic caches, and other features (e.g., paged attention, continuous batching, speculative decoding, etc.). These inference engine components are coupled to a plurality of tensor processing units (TPUs) (e.g., compute apparatus, chiplet device, AI accelerator, etc.) to perform tensor computations involved in the LLM serving processes.

In an example, these TPUs include a plurality of worker units (e.g., slices, in-memory compute units, etc.) configured to operate in parallel (e.g., in parallel processing stages), and can perform the tensor operations asynchronously. Each TPU can be configured in a thin card form factor, which can enable easier stacking in server and server rack systems. Using the chiplet architecture, these TPUs can exhibit minimal worker interprocess communication (IPC) (e.g., none on critical paths) and also minimum host-to-device (H2D) and device-to-hose (D2H) interactions as well. The resulting system includes a distributed, high-performance, multi-modal capable inference serving stack. Of course, there can be other variations, modifications, and alternatives.

Although the matrix compute apparatus 1570 is configured within a chiplet device 1560 in an AI accelerator apparatus 1550 in this example, the host computing device 1510 can also be configured send the compiler commands to an independent chiplet device with matrix compute apparatuses or a server system having a plurality of AI accelerator apparatuses. For example, the server system can include a plurality of AI accelerator PCIe card devices coupled to a plurality of switches, each of with is coupled to one or more server CPUs. Those of ordinary skill in the art will recognize other variations, modifications, and alternatives to this workload transfer configuration.

The integration of high-speed inference engines into AI applications is driving advancements across various industries. The adoption of advanced hardware accelerators including the present chiplets and, e.g., high-bandwidth memory, enhances computational efficiency, supporting larger models and reducing inference latency. In an example, by enhancing decision-making, automation, and predictive analytics, these systems enable organizations to operate more efficiently and intelligently. Those of ordinary skill in the art will recognize other variations, modifications, and alternatives to these applications.

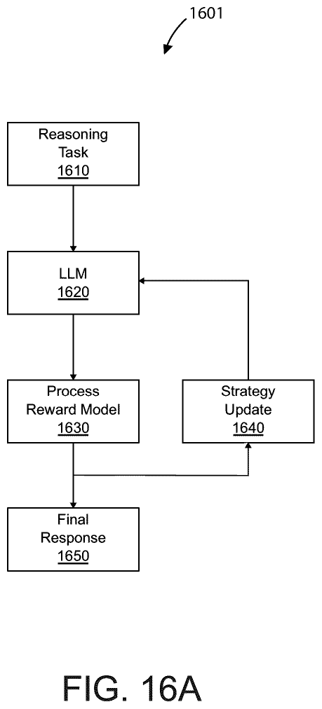

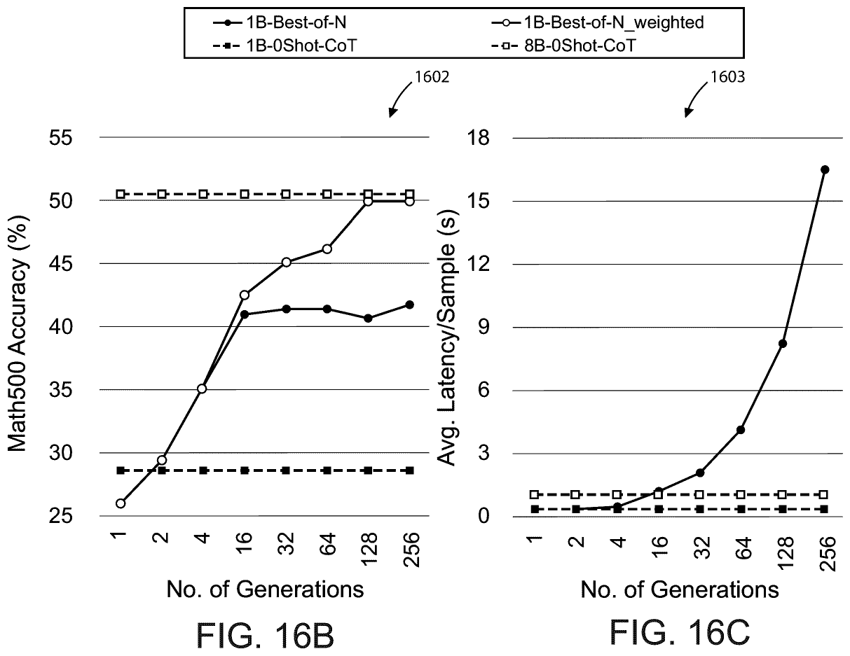

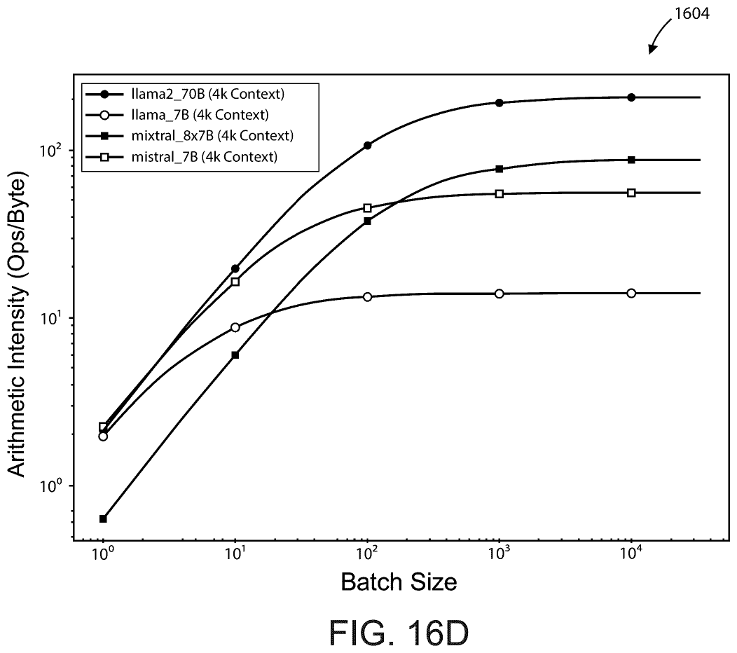

According to an example, the present invention includes a method of adaptively scaling the amount of compute used during an inference process to improve the output quality of neural network models on various workload tasks, such as for the outputs of large language models (LLMs) on reasoning tasks. FIG. 16A is a flow diagram illustrating a conventional reasoning model architecture. In such models, inference execution for reasoning tasks 1610 through such models typically undergoes multiple step-by-step generations through an underlying LLM 1620. Each step generates multiple intermediate responses, and a process reward model (PRM) 1630 scores each intermediate response. Next, based on the score, the strategy for the subsequent step is updated, shown by the loop through the strategy update block 1640 back to the LLM 1620. After a desired number of steps, the final response 1650 is presented.

FIGS. 16B and 16C are simplified graphs showing accuracy scores and associated inference latency, respectively, measured for an example reasoning model. As shown, graph 1602 shows the percentage accuracy over number of generations achieved in a MATH-500 benchmark by a LLaMA-1B based reasoning model, and graph 1603 shows the associated average latency per sample (i.e., latency cost) per number of generations. More specifically, these graphs compare the performance of two reasoning techniques-Best-of-N and Best-of-N weighted on an Nvidia A100 system, as well as the performance obtained by single or 0-Shot Chain of Thought (CoT) run with two models (LLaMA-1B and 8B). Note that such CoT runs can involve 10 to 100 times more tokens than classic LLMs.

The results show that the response quality using a smaller LLM (e.g., LLaMA1B) can be improved significantly by increasing the number of steps the model uses. In fact, the improvement almost matches the same accuracy as a significantly large LLM (e.g., LLaMA 8B) with about 128 steps, but at a cost. As shown in graph 1603, the latency/sample of using the Best-of-N technique with 128 generations is approximately 9× higher than the 8B-OShot-CoT time. Thus, training time cost was traded off for inference time cost using a 1B parameter model instead of an 8B one. In certain cases, small reasoning models can outperform larger LLMs (e.g., 20 times larger). In fact, small language models (SLMs) can solve speech and reasoning prompts and provide tool calling and code generation (e.g., OpenAI gpt-oss-20B, DeepSeek-R1-Distill, Qwen3 “thinking mode” 4B, Google Gemma3, Huggingface SmolLM3, Whisper, etc.).

Deployment of such models at scale face a variety of issues, including latency and throughput. The user experience of using these models can be quite undesirable when inference tasks take a long time to complete (e.g., 9s/sample on math500). And the latency issue is further exacerbated with low system throughput in requests per second leading to prohibitive inference costs. In certain cases, keeping user latency constant can require 10 to 100 times the memory bandwidth. Referring back to FIG. 16C, the latency measurements shown in graph 1603 were achieved with a batch size of one, which means that increasing the batch size to increase throughput is highly undesirable as it will further deteriorate the user experience. In these cases, it is observed that almost all of the time is spent in LLM generations or in LLM based scoring. Therefore, in order to improve the latency and throughput of such reasoning models, the latency and throughput of LLM inference must be improved.

LLMs are auto-regressive generative models based on a decoder only transformer architecture, and they primarily consist of two distinct phases—a prompt (or prefill) processing phase followed by a token generation (or decode) phase. In order to improve the inference throughput of total tokens per second, the system utilization needs to be improved during both prompt processing and token generation phases. Additionally, to provide a desirable and interactive user experience, latency of operations need to be lowered, which includes the Time to First Token (TTFT) and the Time Per Output Token (TPOT).

During the prefill phase, the model is “understanding” the given context. The parameters of the model are read from memory and can be reused by a large number of operations that is proportional to the prompt length of the user request (e.g., 100s or 1000s of tokens long). For most scenarios, the prefill phase is compute-bound and may achieve high system utilization. As a consequence of compute-boundedness, the observed TTFT is limited by the architecture's available compute throughput.

During token generation, the model generates one token at a time auto-regressively-using the entire token history of execution. To avoid redundant computation, the keys (K) and values (V) of all previously processed tokens are commonly cached in a data structure called the KV cache. For each generated token, the entire model parameters and KV cache are read from memory. The KV cache scales linearly with context size, model size, number of attention heads for which K and V are cached, and number of concurrent requests or batch size. In certain cases, service level objectives (SLOs) require small batch sizes (e.g., 16-64). The autoregressive nature of execution combined with the presence of the KV cache makes token generation a memory-bound workload.

FIG. 16D is a simplified graph showing the impact of increasing batch sizes on arithmetic intensity for a variety of LLMs. As shown in graph 1604, while the arithmetic intensity increases initially with batch size during LLM inference execution, it quickly saturates. To achieve high system utilization during the token generation phase, the system's “native arithmetic intensity” or the ratio of compute TOPS to available memory bandwidth needs to match the arithmetic intensity of the workload. In graph 1604, the arithmetic intensity saturates between 10 and 200 Ops/Byte. Consider also the processing of models for voice applications (e.g., Whisper medium, and the like), such as for automatic speech recognition (ASR) and speech translation, which are latency-critical and even more memory bound. Thus, in order to improve both the systems Token per Sec and user experience TPOT, the underlying system requires much greater memory bandwidth than conventionally available.

As discussed previously, the KV cache size grows with context length of the requests. While state-of-the-art LLMs support a rather large context length (e.g., 128K or higher), the user prompt might be smaller in reality. Even so, the inference-time compute requires generating additional reasoning tokens to think step-by-step. The generated reasoning tokens could be 10× larger than the user prompt, which increases the total KV cache needs. Therefore, the underlying system also requires high memory capacity with high memory bandwidth.

Furthermore, at-scale serving of LLMs goes beyond just using a single device. Typical data-center scale system configurations aggregate the compute, memory (capacity and bandwidth), and interconnect properties across multiple devices. In such cases, these configurations are tied to the primary use case-training clusters focus on delivering high throughput, whereas interactive inference clusters target a low-latency response.

According to an example, the present invention includes implementing a method of distributed inference for neural network models, such as LLMs and the like. This method can be implemented by an AI accelerator apparatus and its components, such as those described herein, and can be scaled up to server systems, data center configurations, and the like. The distributed inference method includes implementing memory solutions such that the memory capacity and bandwidth gains outweigh the footprint of execution and enable aggregate compute gain to outweigh the overheads from collective data movement (e.g., in large layers of a neural network model).

Such scaling can also be performed jointly by careful partitioning of a neural network model using tensor parallelism (where individual layers are sharded between multiple devices) and pipeline parallelism (where discrete layers of a model are assigned to different devices). While all communications benefit from high bandwidth and low latency, tensor parallel collective communication is also impacted by the richness of connectivity between devices. For example, processing large tensors (e.g., prompt processing) tends to require high bandwidth, while processing small tensors (e.g., token generation) tends to require low latency. Tensor parallel matrix multiplications often include “AllReduce” operations, which can be implemented as a Ring AllReduce operation, a One-Hop Tree AllReduce operation, and the like.

For Ring All-Reduce, the end-to-end latency is found via communication cost modeling to grow linearly with link latency and the bandwidth component is nearly independent of the number of devices. On the other hand, the cost modeling for One-Hop Tree AllReduce shows that latency remains constant with respect to the number of devices while the bandwidth component linearly reduces with the number of devices. Thus, the optimal algorithm can vary depending on the application.

The physical topology or connectivity between devices strongly affects the efficacy of the collective algorithm. For instance, effective implementation of a One-Hop Tree algorithm requires a fully-connected physical topology, while a ring algorithm can be implemented on a range of physical topologies. According to an example, the present invention provides an AI accelerator architecture that is configured to support various parallelism types with specific features to address link latency and effective bandwidth.

Although the previous examples discuss LLMs, the present AI accelerator apparatus and chiplet devices can be configured for processing the workloads of other neural network models as well. Further, the techniques applied to address specific cases, such as the performance factors related to AllReduce operations, can be adapted depending on needs of the application (e.g., throughput, memory bandwidth and capacity, interconnectivity, etc.). Those of ordinary skill in the art will recognize variations modifications, and alternatives.

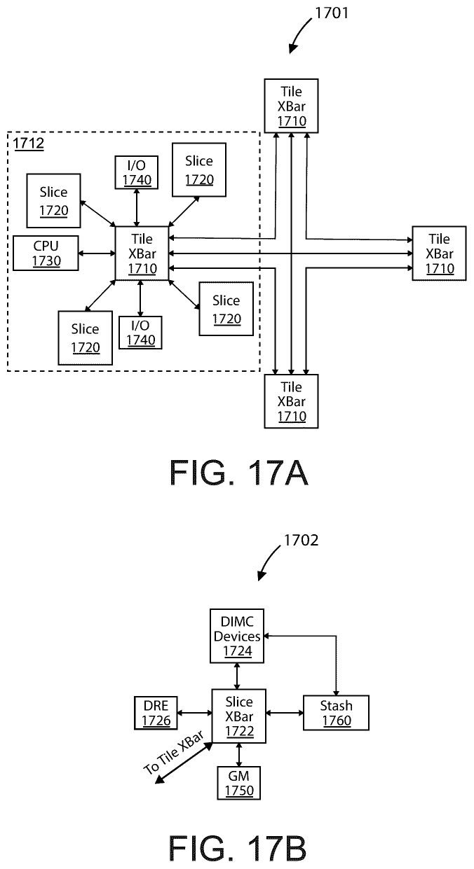

According to an example, the present invention provides a hierarchical chiplet network-on-chip (NoC) configuration to enable low-latency processing of neural network model workloads. This NoC configuration provides low-hop connectivity to frequently accessed end points. FIG. 17A is a simplified block diagram illustrating a chiplet NoC configuration according to an example of the present invention. As shown, the chiplet 1701 includes a plurality of tile crossbar devices 1710, each of which is coupled to a tile 1712 (only one tile shown) and to each other tile crossbar device 1710. Within each tile 1712, the tile crossbar device 1710 is coupled to at least a plurality of slices 1720, a tile CPU 1730, and a plurality of I/O ports 1740. Depending on the tile identity, the I/O ports are used to connect one or more of the I/O interfaces (e.g., PCIe, D2D, LPDDR, etc.). These tiles can also be configured similarly and include similar elements to the other tile configurations discussed previously, such as in FIGS. 2A to 2D.

In this case, each tile 1712 is configured as a “quad” with four slices 1720 and there are four tile crossbar devices 1710 configured as “quad” crossbar devices. These crossbar devices 1710 are interconnected by a physical all-to-all topology and each crossbar device 1710 is coupled to all of the slices 1720 within its associated “quad”. Depending on the application, the NoC configuration can be configured a different tile group size and a different number of slices within each tile.

FIG. 17B is a simplified block diagram illustrating an example slice device in the NoC configuration for the chiplet 1701 shown in FIG. 17A. As shown, slice 1702 includes a slice crossbar device 1722 coupled to at least a plurality of digital in-memory compute (DIMC) devices 1724, a data reshape engine (DRE) device 1726, a global memory (GM) device 1750, and a stash memory device 1760. The slice crossbar device 1722 provides connectivity to the tile crossbar (shown by bi-directional arrow). Similarly, these tiles can also be configured similarly and include similar elements to the other slice configurations discussed previously, such as in FIGS. 3A to 3D. Those of ordinary skill in the art will recognize variations, modifications, and alternatives to this NoC configuration.

According to an example, the present AI accelerator apparatus can implement a data flow architecture based on a spatial array of processing units. In this case, every workload is expressed as an instruction set architecture (ISA) graph, including a plurality of subgraphs, and is spatio-temporally mapped. From these ISA graphs, the compute nodes naturally map to various compute units, such as the DIMC and SIMD, while data dependency edges translate to direct memory access (DMA) operations. Once mapped, the AI accelerator apparatus can unroll the ISA graph temporally in hardware. This approach works well with neural network models characterized by a streaming nature, such as LLMs and the like.

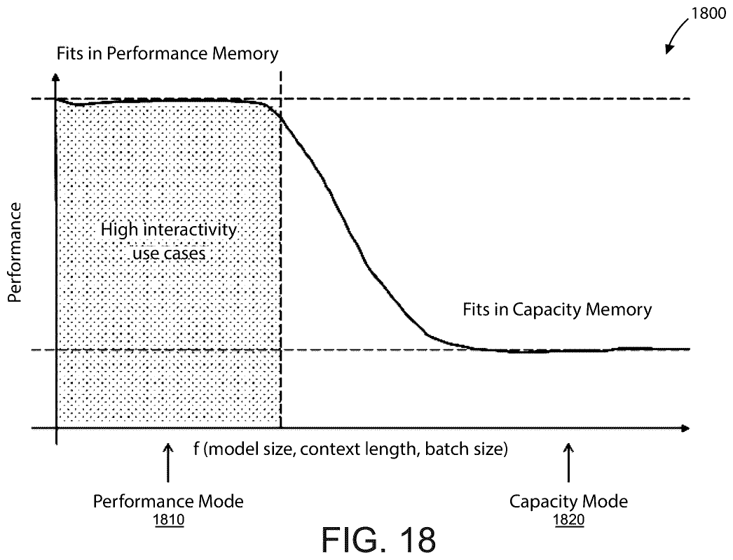

Also, all data buffers and residency lifetimes can be explicitly managed by software, which enable the use of different operating modes. FIG. 18 is a graph illustrating different operation modes for an AI accelerator apparatus according to an example of the present invention. As shown, graph 1800 shows the performance levels for a “performance mode” 1810 and a “capacity mode” 1820. In performance mode, input data, such as tensors and model parameters, resides in the on-chiplet memory (e.g., global memory [GM] or stash memory [Stash]) of the slices, which is beneficial for high interactivity use cases that fits in the performance mode memory capacity. In capacity mode, the input data is fetched from off-chiplet memory (e.g., DRAM) as needed, which can be appropriate for lower interactivity use cases that fit in the capacity mode memory capacity.

Additionally, each of the tiles can be configured to execute subgraphs of the ISA graph without requiring lock-step synchronization with other tiles. With no timing assumption during execution, every causal relationship is explicitly expressed in the ISA graph. In an example, the model parameters (and the execution graph) are delivered into the off-chiplet memory by the host. Subsequently, input activations can be streamed in and results can be streamed out via the PCIe interface (using GM or off-chiplet memory). As part of model initialization, static parameters can be read into the on-chiplet memory (GM and/or Stash) where they ideally remain resident until the end of the workload processing session (e.g., inference session, and the like).

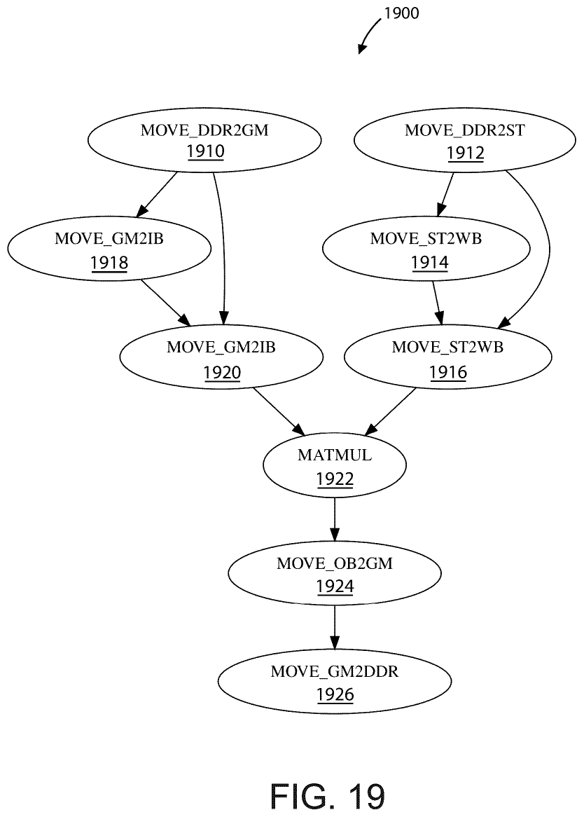

FIG. 19 is a simplified flow diagram illustrating a method for processing a sub-graph according to an example of the present invention. In this case, the subgraph represents a single iteration of a dataflow graph including a matrix multiplication operation and associated DMA operations. As shown, the method 1900 starts with loading input data to the input buffer (IB) and the weight buffer (WB) in parallel. For example, activation data can be transferred from off—the chiplet memory (e.g., DDR memory) to the GM of the slice, step 1910, and weight data can be transferred from off-chiplet memory to the Stash, step 1912. Then, these activations and weights can be transferred from the GM to the IB and WB, respectively (steps 1916 and 1920). The method 1900 can also include additional transfers from the GM to the IB and WB (steps 1914 and 1918), such as for loading additional model parameters or implementing a double buffering configuration.

As discussed previously, the tiles of the chiplets can exploit parallelism across iterations for efficient pipelines. In an example, the data buffers (GMs, Stash, OBs) are highly banked and implement double buffering that allows multiple agents accessing the buffers at the same time. This, in turn, allows the next iteration to begin while the results of the previous iteration are being read.

After the activations and weights are loaded, the DIMC performs the matrix multiplication operation with these inputs, step 1922, and the output data is stored in the OB, which is then transferred from the OB to the GM, step 1924. Depending on the subgraph, the output data can be transferred from the GM to the off-chiplet memory, step 1926, or the output data may be loaded back into the IB or WB for a subsequent iteration. Those of ordinary skill in the art will recognize variations, modifications, and alternatives to this subgraph operation.

According to an example, present invention provides an AI accelerator apparatus configured in a hierarchically fully-connected logical mesh configuration of chiplets. AI accelerators and chiplets that are configured for processing workload computations involving token generation using tensor and pipeline parallelism require low latency, high bandwidth communication. In a specific example, the computations include one-hop tree and ring algorithms, which render unique characteristics to the collective operation. During token generation, the collective communication involves tiny tensors and is thus, heavily latency bound. By using a combination of latency-optimal one-hop tree algorithms and a fully-connected tensor parallel unit, the accelerators and chiplets achieve ultra-low latency collective operation. Using a hierarchically fully-connected logical mesh configuration, the AI accelerator can function as a natural tensor parallel (TP) unit.

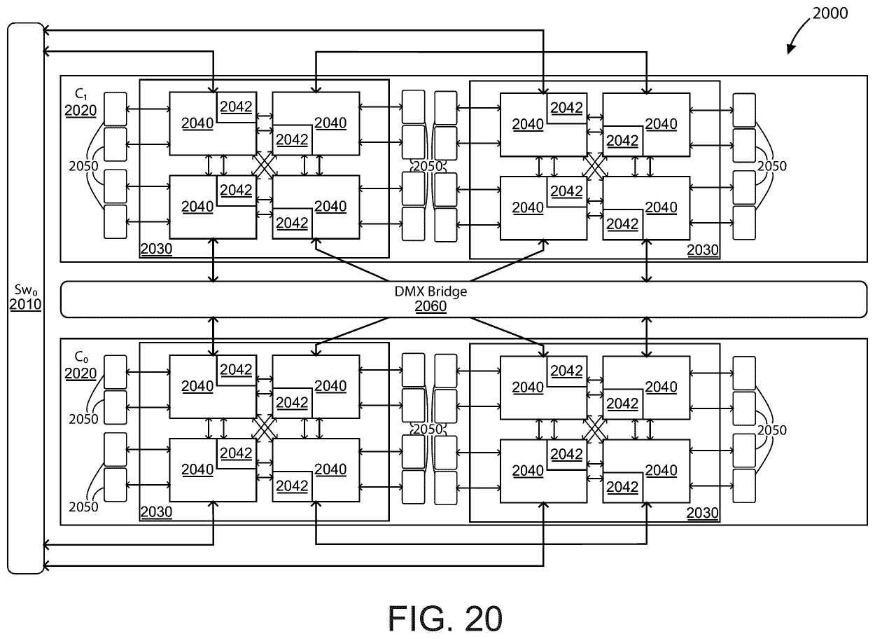

FIG. 20 is a simplified block diagram illustrating a switch configuration with AI accelerator apparatuses in a mesh configuration according to an example of the present invention. As shown, the switch configuration 2000 includes a switch device 2010 coupled to a plurality of PU card devices 2020. Here, this configuration 2000 includes two PU devices 2020 (denoted as C₀-C₁) in a card form factor (e.g., PCIe card, or the like), and these PU devices 2020 are configured similarly to the AI accelerator apparatus 102 of FIG. 1B with eight chiplet devices 2040 formed overlying an interposer 2030 in two groups of four chiplets 2040 coupled together by their D2D interfaces (see previous accelerator configurations). Each of these chiplet devices 2040 also includes a switch connection interface 2042, such as a PCIe interface, or the like. Further, each group of chiplets 2040 is coupled to eight memory devices 2050 (e.g., DRAM, or the like) with each chiplet 2040 being coupled to two of the memory device 2050. However, the specific number and configuration of these chiplet devices in the AI accelerator apparatus can vary and can include any of the configurations discussed previously.

As discussed previously, each group of chiplets can be configured as multi-chip module (MCM) with a plurality of chiplets in an all-to-all mesh topology using high bandwidth, low latency and low power D2D links. In a specific example, these D2D links are based on an Open Compute Project (OCP) Open Domain-Specific Architecture (ODSA) Bunch of Wires (BoW) 1.0 specification, or a similar specification. This link configuration can achieve a peak bandwidth of 1 Tbps (128 GB/s) in each direction between any two pair of dies at 0.35 pJ/bit energy efficiency.

In a specific example, the D2D links between the chiplets 2040 are implemented using conventional organic Ajinomoto Build-up Film (ABF) substrate technology with extended reach up to 25 mm interconnect length. The extended reach enables diagonal connections in the mesh configuration, which is reduces communication latency between chiplets and thus enhances the computational workload acceleration. The D2D links can also use low loss ABF dielectric material and stacked multi-layer vias to maintain signal integrity.

The switch configuration 2000 also includes details of various interconnections between chiplet devices 2040 within the same PU device 2020 and across different PU devices 2020. As shown in the expanded depiction of the first and second PU devices “C₀” and “C₁”, the switch device 2010 is coupled to the connection interface 2042 of one of the chiplet devices 2040 of the first chiplet group in each PU device 2020 (shown by lined arrows). In a specific example, these connections pathways can include printed circuit board (PCB) pathways, cables, or the like. For both PU devices “C₀” and “C₁”, a different chiplet device 2040 of the first chiplet group is also coupled to a different chiplet device 1240 in the second chiplet group via their connection interfaces 1242 (shown by lined arrows). In a specific example, these connection pathways can also include PCB pathways, cables, or the like.

Further, FIG. 20 shows that the remaining chiplet devices 2040 that were not coupled to the switch or coupled across chiplet groups are coupled instead across the PU devices 2020 via their connection interfaces 2042 using a bridge connection 2060. More specifically, each of the two remaining chiplet devices 2040 in each group are coupled to chiplet devices 2040 of different chiplet groups in the other PU device 2020. In an example, the switch connection interface 2042 (e.g., PCIe switch interface, and the like) allows connecting multiple card PU devices 2020 in an any-to-any connectivity matrix, which means that transfers can happen between any two devices but incur the latency of transiting through the switch. On the other hand, the bridge connection interface 2060 avoids the switch latency by allowing direct connection of two chiplets using a board trace, a DMX bridge connection (e.g., 512 GB/s bidirectional), and the like. In an example, the bridge connections are configured as a back-to-back PCIe links. Along with the D2D links within the MCMs, these links can provide the connectivity resulting in a multi-chiplet logical TP unit, as discussed previously.

Using such mesh configurations or physical connectivity enable multiple accelerators/chiplets to perform low-latency, high bandwidth communication via D2D connections over short distances within a package and switch links (e.g., PCIe) over longer distances. The switch configuration 2000 can include additional connections via switch-to-chiplet pathways, group-to-group pathways, and card-to-card pathways, which can be included to connect to other PU devices 2020 or to connect a different configuration of chiplet devices 2040 in the AI accelerator apparatus.

The switch-based connection provides the scalability to form more complex multi-card topologies particularly using multiple levels and hierarchical schemes. And while simple switch-based peer connections enable pipeline communication, it is also possible to achieve richer connectivity between cards using a large number of switches. Those of ordinary skill in the art will recognize other variations, modifications, and alternatives to this switch configuration 2000.

The present invention also provides methods and server system configurations using transparent bridging to enable communications across multiple central processing unit (CPU) sockets and server nodes. Merely by way of example, the transparent bridging methods and configurations are applied to push-based communication using Ethernet connectivity. Those of ordinary skill in the art will recognize other variations, modifications, and alternatives to the applications of these methods and configurations of transparent bridging.

Conventional network interface cards (NICs) enabling Ethernet connectivity have difficulty scaling with accelerators distributed across nodes within a multi-node accelerator system (e.g., multi-node GPU accelerator, and the like). And although network fabric configurations, such as remote direct memory access (RDMA) and RDMA over Converged Ethernet (ROCE), can be used with multi-node accelerator systems to transfer data more quickly and efficiently, these network fabrics can also require complex shared address space setups (e.g., for one-sided communication). Conventional software and hardware implementations of such network fabric configurations may also be constrained to operate at lower latency required for certain target applications (e.g., Generative AI inference applications). Further, the use of such network fabric configuration can run into various implementation challenges. For example, peripheral component interconnect express (PCIe) fabric topologies without custom firmware are typically limited to scale within PCIe switches and CPU socket provided PCIe lanes, which results in constrained multi-CPU socket peer-to-peer (P2P) connectivity.

By using transparent bridging, the present invention can enable fast and efficient communications across multi-node accelerator systems and server systems. Explicit software enablement for transparent bridging is not required, and delivery of data using transparent bridging can be guaranteed through the application of designated communication protocols (e.g., Ethernet-based protocols) for Scale-up and Scale-out. Further details of these transparent bridging applications are described in the following figures.

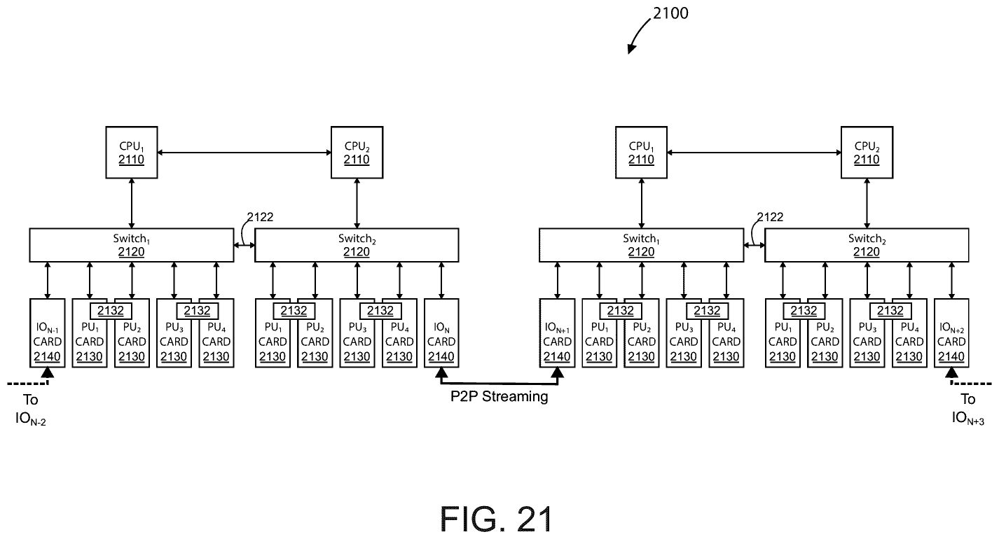

FIG. 21 is a simplified block diagram illustrating a server system using transparent bridging with synthetic fabric switch connectivity according to an example of the present invention. As shown, the server system 2100 can include a plurality of CPU devices 2110. In a specific example, the plurality of CPUs 2110 can be configured as one or more multiprocessors coupled together using point-to-point processor interconnects, such as Ultra Path Interconnect (UPI), and the like. Here, the CPUs 2110 are configured in pairs denoted as “CPU₁” and “CPU₂”.

Each of the CPU devices 2110 is also coupled to a switch device 2120. Here, the switches 2120 coupled to the CPUs 2110 of each dual-core multiprocessor are denoted as “Switch₁” and “Switch₂”. These switch devices 2120 can be configured for various form factors, such as peripheral component interconnect express (PCIe), and the like. In an example, the switches 2120 configured with each multiprocessor are also coupled to each other using a synthetic fabric configuration 2122 (e.g., PCIe fabrics, Ethernet fabrics, and the like). Although the system 2100 is shown using pairs of CPUs 2110 and switches 2120, the coupling configurations can be scaled to larger subsets of CPUs 2110 and switch devices 2120 as well.

Each switch device 2120 is also coupled to one or more processing unit (PU) devices 2130, which include can GPUs configurations, TPUs configurations, or the like. These PU devices 2130 can include the previously discussed AI accelerator apparatus configurations, which can include various form factors such as PCIe cards, and the like. In the PCIe card configuration, these PU devices 2130 can be configured similarly to the AI accelerator apparatuses 101 and 102 of FIGS. 1A and 1B. In FIG. 21, the system 2100 includes four PU devices (denoted as PU₁-PU₄) configured in pairs coupled by bridge connections 2132 (see FIG. 20). Here, the synthetic fabric configuration 2122 enables communication between PU devices 2130 on different switches.

Each switch device 2120 is also coupled to at least one input/output (IO) streaming device 2140, which can also be configured in the same form factor as the PU devices 2130. These IO streaming devices 2140 can be configured to implement transparent bridging to facilitate P2P communication between the PU devices 2130 coupled to different multiprocessors. Here, the IO streaming device 2140 coupled to “Switch₂” of the left-side multiprocessor is configured to communicate with the IO streaming device 2140 coupled to “Switch₁” of the right-side multiprocessor. Further, the IO streaming devices 2140 coupled to the other switch device 2120 of each multiprocessor can be configured to communicate with IO streaming devices 2140 of other multiprocessors.

In an example, these IO streaming devices 2140 can be configured to transparently transport data using transaction layer packets (TLPs) for memory functions (e.g. PCIe MemWr64) and completion packets (e.g., TLP prefixes). The IO streaming devices 2140 can also duplicate the next parallelism stage (e.g., pipelining parallelism, tensor parallelism, etc.) for memory base address register (BAR) spaces used by the CPUs 2110. In a specific example, the IO streaming devices 2140 are configured for PCIe P2P communications using an Ethernet fabric.

In an example, the system 2100 can also be configured such that one IO streaming device configured to one of the multi-processors and coupled to one of the switches in the synthetic fabrication configuration manages the communication with IO streaming devices configured to other multi-processors. Each multiprocessor with CPUs 2110 and its associated switches 2120, PU devices 2130, and IO streaming devices 2140 can also be configured as separate server nodes in a multi-node server system. In an example, system 2100 includes an additional layer of switches to provide a larger scale-up domain. In this case, a second plurality of switches (e.g., PCIe switches, network fabric switches, and the like) is coupled to the PU cards 2130 in a fully interconnected configuration in which each of these switches is coupled all of the PU cards 2130 in the system 2100 or in each subsystem that is configured under a CPU or group (e.g., CPU pair). A single switch hierarchy can be used for a backend scale-up network. Also, the system 2100 can include a configuration with a 1:1 ratio of PU devices to IO streaming devices for higher scale-out bandwidth. Those of ordinary skill in the art will recognize variations, modifications, and alternatives to this server configuration.

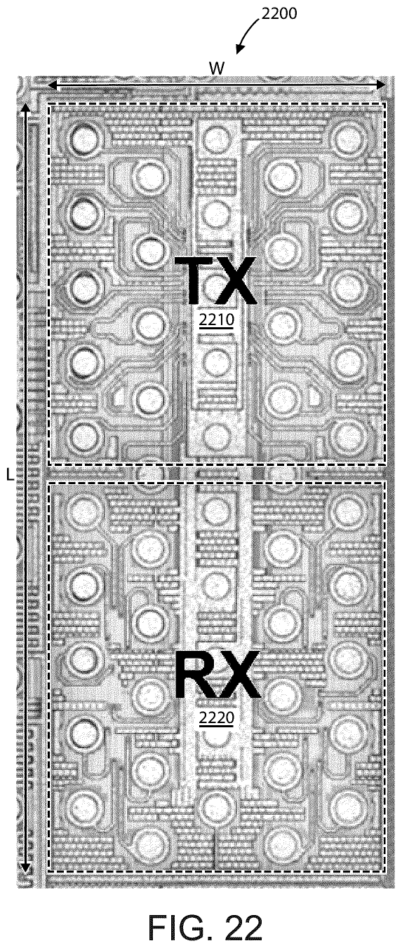

FIG. 22 is a die micrograph showing a die-to-die (D2D) physical layer (PHY) of a chiplet device according to an example of the present invention. As shown, micrograph 2200 shows a transmitter (TX) 2210 portion and a receiver (RX) 2220 portion of the D2D PHY. In a specific example, the D2D PHY incorporates 130 um pitch C4 bumps and each D2D PHY integrates 16 TX lanes and 16 RX lanes, with each lane operating at a data rate of 16 Gbps. This configuration delivers a total bandwidth of 256 Gbps per PHY, corresponding to a bandwidth density of 0.19 Tbps/mm per direction, which results in a 10× improvement in the achieved bandwidth density and energy efficiency compared to conventional printed circuit board (PCB)-level signaling technologies. By aggregating four such D2D PHYs per link, an inter-die bandwidth of 1 Tbps is achieved. In this example, a chiplet implements 16 D2D PHYS, their area utilization remains minimal, occupying only a small fraction of the overall die area. Key performance metrics of this example D2D link configuration shown in Table 1 below:

TABLE 1
D2D Performance Summary

| Technology | 6 | nm |
|---|---|---|
| Channel length | <25 | mm |
| Packaging | MCM | |
| Bump pitch | 130 | um |
| D2D Standard | BoW | |
| Data rate | 16 | Gb/s/wire |
| Single-PHY beachfront | 0.19 | Tbs/mm |
| BER | <1E-15 | |
| Eye-height margin of vertical link | 57.5% | |
| Eye-height margin of horizontal link | 45.3% | |
| Eye-height margin of diagonal link | 38.9% | |
| Eye-width margin of vertical link | 0.59 | UI |
| Eye-width margin of horizontal link | 0.62 | UI |
| Eye-width margin of diagonal link | 0.63 | UI |
| Energy Efficiency | 0.35 | pJ/bit |
| Active area | 0.8 | mm₂ |

By leveraging conventional packaging technology, the present D2D PHY configuration is simpler to implement at an affordable cost. The chiplet arrangement with the D2D PHY seamlessly aggregates memory bandwidth and capacity across every chiplet in the package, which empowers tensor parallel configurations for advanced distributed compute in the AI accelerator architecture. Also, the D2D PHY transceiver can further improves the signal integrity by using flexible CLK-data skew compensation and sampler voltage detection threshold tuning that maximizes eye opening on a per lane basis. Furthermore, the PHY can be configured to align the receiver's sampling point to the center of the aggregated eye across the lanes for reliable data capture. Those of ordinary skill in the art will recognize variations, modifications, and alternatives to this D2D PHY configuration.

As discussed previously, computational workloads for neural network models can be represented in an instruction set architecture (ISA) graph, which can include a plurality of ISA subgraphs that can be executed by the present AI accelerators and chiplets. The instructions can include categories such as (1) data movement, (2) computation, (3) reshaping), (4) control operations, and the like. Examples of such instructions are shown in Table 2 below:

TABLE 2
Example ISA operations

| | |
|---|---|
| Data movement | |
| MOVE_xxx2yyy | DMA based data transfer from - |
| | xxx: DDR, GM, ST, OB |
| | yyy: DDR, GM, ST, OB, WB, IB, DRE, SIMD |
| MOVE_xxx2PCIE | PCIe based peer-to-peer transfer |
| Compute | |
| MATMUL | Matrix multiplication using DIMC |
| CONV | Direct convolution using DIMC |
| EXEC_SIMD | Kernel function execution on SIMD cores |
| EXEC_CPU | Control function execution using tile CPU |
| Data reshape | |
| TRANSPOSE | Array transpose |
| EXTRACT | Rule-based sub-view extraction |
| INSERT | Rule-based sub-tensor insertion |
| Control | |
| LOOP | Nestable iterators |
| SEND/REC | CPU messaging via mailboxes |
| CONFIG_zzz | Pre-configure units (AC, SIMD, GM, ST) |
| BARRIER | Various barriers for stalling graph execution |
| RESET | Software triggered reset |
| NOP | Dummy, filler ops used for graph sync |

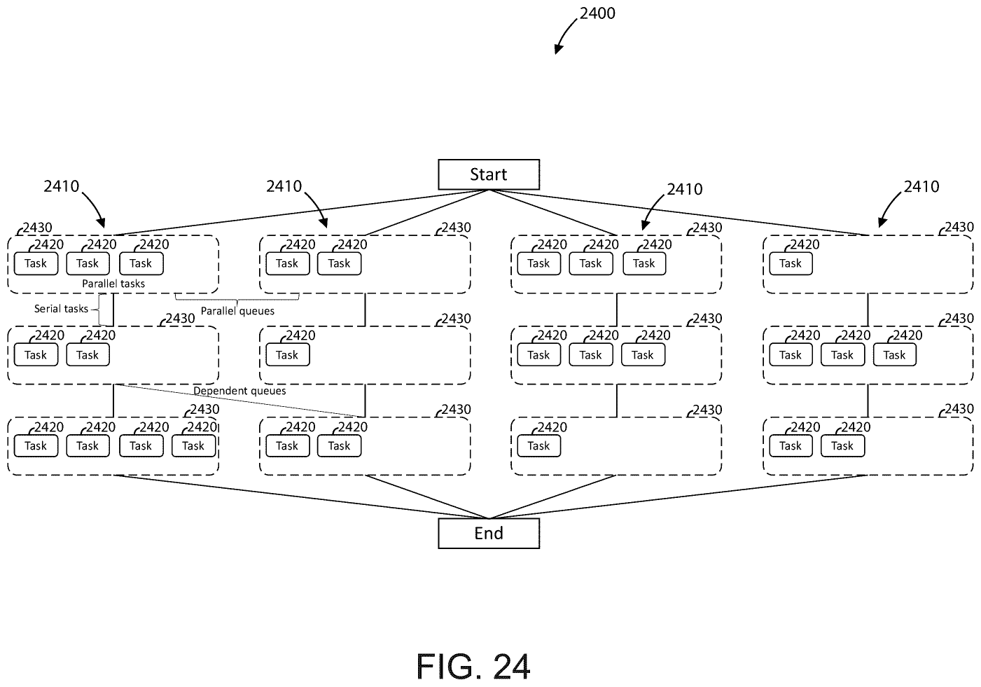

Depending on the workload, a compiler (see FIG. 15) determines an ISA graph representing the workload using a combination of such instructions or similar instructions. In a specific example, the ISA graph can be expressed as a conventional directed acyclic graph (DAG) which captures the node-level dependencies as graph edges. It can also be represented using a unique hierarchical data structure (shown in FIG. 24) which spatially spreads concurrent operations and registers dependencies using serial time steps and explicit node edges.

According to an example, the present invention includes a data flow architecture in which the producer-consumer relationships are readily captured in the execution graph (e.g., ISA graph). In certain cases, the data flow process can require storing intermediate results into memory. In this case, the majority of data movements are push-based where the producer writes its output directly into the consumer's buffers, and the readiness of the consumer and availability of allocated buffer space is ensured by software under an autonomous protocol. Such transfers do not involve any handshake between the sender and receiver irrespective of their distance.

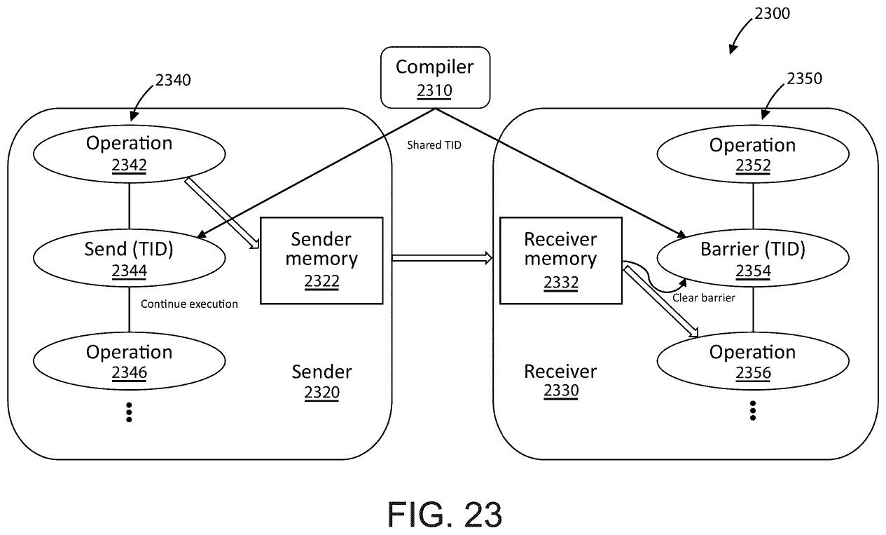

FIG. 23 is a simplified flow diagram representing a method of an autonomous data transfer protocol implemented in an accelerator system according to an example of the present invention. As shown, method 2300 includes a compiler 2310 configured to communicate with a sender 2320 and a receiver 2330 to facilitate data transfers, among other operations. The sender 2320 and the receiver 2320 can include device entities such as off-chiplet memory (e.g., DDR RAM), a general memory (GM) device, a stash memory (ST) device, an output buffer (OB) device, an input buffer (IB) device, a weight buffer (WB) device, a data reshape engine (DRE) device, a Single Input, Multiple Data (SIMD) device. Depending on the workload, other entities may be senders 2320 or receivers 2330 as well.

The sender 2320 includes a sender memory device 2322 and a sender thread 2340 with at least a first sender operation 2342 followed by a send instruction 2344 and then second sender operation 2346. Here, the result of the first sender operation 2342 is stored in the sender memory device 2322, and then the send instruction 2344 causes the stored result to be sent to the receiver 2330 based on a thread ID (TID). Afterwards, the sender 2320 continues the sender thread 2340 to the second sender operation 2346. Similarly, the receiver 2330 includes a receiver memory device 2332 and a receiver thread 2350 with at least a first receiver operation 2552 followed by a barrier operation 2354 and a second receiver operation 2556. In this case, the receiver memory 2332 receives the result transferred from the sender 2320, and the second receiver operation 2356 uses the result for its execution (data path shown by the hollow arrow lines).

In an example, the only entity requiring knowledge of the transfer completion is the downstream operation 2356 at the receiver 2330. Here, the barrier operation 2354 associated with the data transfer identity (using TID) is used. This local barrier can be removed as soon as the data is received, shown by the arrow from the receiver memory 2332 to the barrier operation 2354). Of course, these are example sender and receiver threads and there can be variations, modifications, and alternatives.

According to an example, the present invention includes a data communication method for an AI accelerator system using in-graph collectives. With in-graph collectives, collective operations are baked directly into the execution graph. Such operations leverage the autonomous transfer protocol and occur directly between peer devices in an AI accelerator system, which eliminates hose CPU interaction and expensive synchronizations leading to ultra-low latency collectives and greater opportunity for overlap of computation and communication phases of execution.

According to an example, the present invention includes an explicitly scheduled fine-grained control method using a dispatch engine (DE) device in an AI accelerator system. In this case, dependent operations are triggered only after upstream operations are completed. Instead of having completion signals travel back to the control processor (e.g., tile CPUs of a chiplet) to allow subsequent workload operation dispatches, a DE is configured to assist the control processor to reduce turn-around latency between consecutive tasks. This DE can be configured similarly to the hardware dispatch (HW DS) and DE devices in the chiplet devices of FIGS. 2A to 2D. The DE can also arrange the workload operations in a unique hardware data structure that maximizes concurrent execution without breaking graph causality, as shown in FIG. 24.

FIG. 24 is a simplified flow diagram illustrating a method of processing a neural network workload (e.g., transformer workload, convolution neural network workload, etc.) using an AI accelerator system according to an example of the present invention. As shown in the flow diagram 2400, the method includes processing a workload in a plurality of task queues 2410 such that each of the task queues 2410 performs one or more workload tasks 2420. Depending on the specific workload, certain tasks 2420 are performed sequentially (i.e., serial tasks) while others are performed simultaneously (i.e., parallel tasks). These tasks can also be configured in task groups 2430, which can also be performed sequentially (shown by the connected vertically-aligned queues) or simultaneously (shown by the horizontally-aligned queues in separate branches). Additionally, certain tasks 2420 or task groups 2430 may be configured as dependent upon the completion of another task 2420 or task group 2430.

This method of processing a neural network workload can be performed by a DE device, such as those described previously. In a specific example, up to 256 work items can be dispatched concurrently (along the horizontal axis of the flow diagram 2400). With the serial operations and dependencies captured vertically and diagonally, this workload processing method can allow a single control CPU to orchestrator over 50 TOPS of compute without incurring a large area cost of control logic. Those of ordinary skill in the art will recognize other variations, modifications, and alternatives to this task processing method.

Using the previously discussed components and methods, the present AI accelerator system can be configured for processing workloads for LLMs or similar model workloads involving autoregression and caching of key-value elements. The present system provides a novel solution for both KV caching and constantly changing context length without requiring a recompilation of the graph. This is achieved by organizing workload operations from an ISA graph in a unique hardware data structure and using a multi-stage compilation flow where the final resolution of variables occurs on-device prior to execution. Hence, a single compiled graph can automatically grow in instructions, memory usage, and compute units based on the parameters of the specific iteration.

For example, a compiled ISA graph with two runtime arguments can include a first operation followed by a loop operation using the first argument as a loop variable. The loop operation can include a second operation using the loop variable (e.g., count from zero up to the first argument) and the second argument, as a well as a third operation using the loop variable and the second argument. Following the loop operation, the compiled graph includes a fourth operation.

Once converted to an execution-ready graph, the operations of the compiled ISA graph can then be represented with a growing sequence of operations using a first constant and a second constant. The sequence includes the first operation followed by the loop sub-operations listed for each loop variable iteration. For example, the subsequence for the loop operation can include the second operation using zero as the loop variable and the second constant followed by the third operation using zero as the loop variable and the second constant. Then, the second and third operations are listed with one as the loop variable and the second constant, and this pattern can repeat until these operations are listed the be performed with the first constant value as the loop variable and the second constant. At the end, the sequence includes the fourth operation to be executed. Thus, the loop iterator is resolved by the accelerator itself for various values of context size. Those of ordinary skill in the art will recognize other variations, modifications, and alternatives to the use of such graphs.

In an example, the present invention includes a method of processing such in-graph collectives with a plurality of independently operating chiplet devices within multi-chip modules (MCMs), such as the AI accelerator configurations discussed previously, using reduce-scatter and all-gather techniques. In an initial state, each chiplet is assigned a tensor (e.g., partial product of a general matrix multiplication [GEMM]) of size “T” to be processed. In a first step, the chiplets perform a reduce-scatter operation between chiplets in an MCM using D2D interconnections. The operation include reduction operations (e.g., sum, max, etc.) on the tensor and the results are scattered in equal blocks (e.g., blocks of T/4 in an MCM with four chiplets).

In a second step, the method includes performing a reduce-scatter operation across the chiplets of a plurality of MCMs (e.g., a row of four MCMS in a 4×4 MCM system) using system interconnections, such as peripheral component interconnect express (PCIe) interconnections, and the like. Similarly, the results are scattered in equal blocks (e.g., blocks of T/16 in the row of four MCMs, each with four chiplets). Then, across the same, the method includes performing an all-gather operation, which includes aggregation operations (e.g., data moved in T/16 blocks between chiplets) on the scattered tensor blocks resulting in outputs having a dimension determined by the number of chiplets and the number of values.

In a third step, the method includes performing the all-gather operation between the chiplets in an MCM using D2D interconnections. Similarly, the results are aggregated (e.g., data moved in T/16 blocks between chiplets) resulting in outputs having the dimension determined by the number of chiplet and number values. Those of ordinary skill in the art will recognize other variations, modifications, and alternatives to this in-graph collectives processing method.

For AI workloads, key evaluation metrics for an accelerator apparatus include computing TOPS (Trillions or Tera Operation per Second), memory bandwidth, utilization, scalability, and energy efficiency, among others. The following tables and figures present results of a targeted benchmark and ML model execution measured on an AI accelerator apparatus according to an example of the present invention. These benchmarks are then extended to generative and reasoning AI models.

In these test cases, the measurements of the AI accelerator apparatus are measurements on an A0 silicon version of the apparatus by running workloads represented as ISA graphs and recording adequate metrics. The corresponding ISA graph were generated by compiling operations with dependencies and resource bindings. And the microbenchmarks were defined to exercise specific attributes of the apparatus including both the functional operations and their spatio-temporal mapping over the desired number of chiplets. Further, a monitoring device was configured within the apparatus to provide built-in counters to measure elapsed cycles for every ISA operation, including latencies of launch and completion signaling.

In these results, the workload time means the cycles elapsed from the launch of the first operation till the completion of the last operation. The effective TOPs means the number of math operations in the computation (M(2K−1)N) over time taken (at a clock rate of 1.167 GHz). And utilization means the ratio of the effective TOPs to the roofline TOPs of a compute unit (i.e., the DIMC device) with an ideal 512 cycles to complete a 64×512×64 matrix multiplication.

TABLE 3
Cycle counts and TOPS utilization computing
matmuls of various dimension in one Quad.

| M | K | N | Cycles | Utilization |
|---|---|---|---|---|
| 64 | 1024 | 1024 | 3444 | 0.60 |
| 64 | 2048 | 2048 | 10708 | 0.77 |
| 64 | 4096 | 4096 | 39344 | 0.83 |
| 128 | 1024 | 1024 | 5932 | 0.70 |
| 128 | 2048 | 2048 | 20252 | 0.81 |
| 128 | 4096 | 4096 | 77524 | 0.85 |
| 1024 | 1024 | 1024 | 39324 | 0.84 |

Table 3 shows the cycle counts for matrix multiplication operations of different dimensions executed on a single “Quad”, a tile group of four slices within a chiplet. The cycle counts include the time required to dispatch instructions from the control CPU (i.e., tile CPU), transfer time of the activations and weights from SRAM (i.e., global memory [GM]), matrix multiplication, and transfer time of the results back to SRAM. The matrix multiplications are distributed spatially and/or temporally to run on an appropriate number of cores within a Quad. Furthermore, the transfer and computation cycles are pipelined for high compute utilization, resulting in linear scaling of latency with computation size. A single matrix operation with (M=64, K=512, N=64) on one “Core”, takes about 1700 cycles including all the overheads described above. As the size of the matrix multiplication increases, the ramp-up and ramp-down of the initial and final data transfer and instruction dispatch/completion times are amortized over larger compute times, resulting in higher compute utilization. This is shown in the results by the utilization reaching nearly 80% utilization from the second row onwards.

TABLE 4
Cycle counts and TOPS utilization as number
of rows in an activation matrix is scaled.

| M | K | N | Cycles | Utilization |
|---|---|---|---|---|
| 1 | 4096 | 4096 | 9416 | 0.054 |
| 4 | 4096 | 4096 | 9400 | 0.22 |
| 8 | 4096 | 4096 | 10476 | 0.39 |
| 16 | 4096 | 4096 | 14340 | 0.57 |
| 32 | 4096 | 4096 | 22756 | 0.71 |
| 64 | 4096 | 4096 | 39344 | 0.83 |

Table 4 shows the compute utilization of cycle counts for matrix multiplications whose weights are fixed at (4096, 4096) and the rows of the activation matrix sweep from 1 to 64 representing typical matrix sizes in token-generation phase of LLMs where the rows correspond to batch size. Here, it is shown that a Quad of the apparatus can achieve a compute utilization of nearly 71% at batch size 32 due to high memory bandwidth.

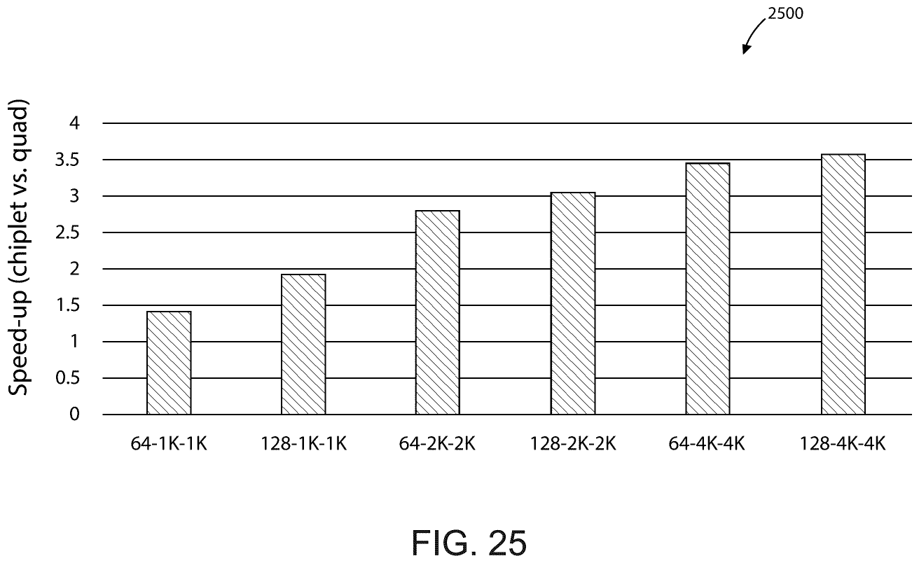

FIG. 25 is graph of performance differences between different configurations of a chiplet device according to an example of the present invention. More specifically, the graph 2500 shows the relative speed-up obtained when a matmul operation is spatially distributed over four Quads in a chiplet as opposed to a single Quad, as shown in the previous tables. In this case, a spatially distributed matmul is followed by an all-gather collective to feed the result as an input to the next matmul. However, during regular scheduling of the workload's dataflow, the collective is hidden behind the computing operations or avoided completely by taking advantage of activation multicast across Quads. The results of graph 2500 show that scaling efficiency improves as the tensor dimension increases, which is a trend that continues to hold when scaling to multiple chiplets and accelerators.

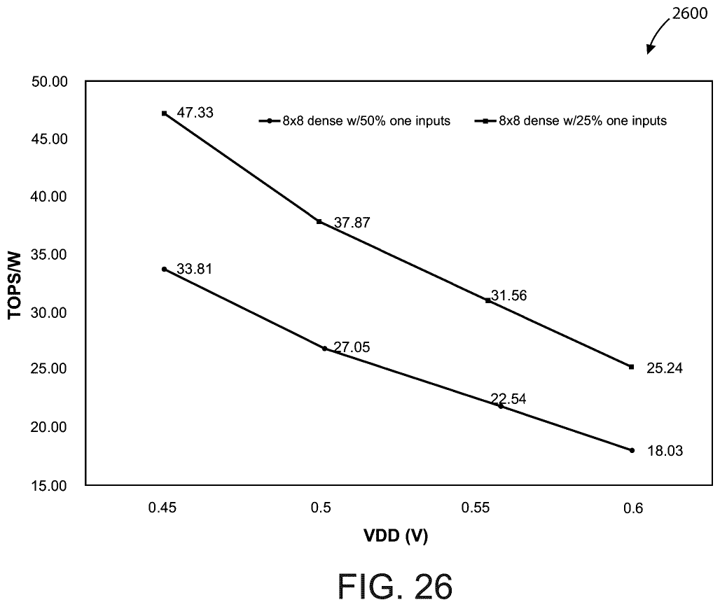

FIG. 26 is a graph of measured power efficiency for a DIMC device according to an example of the present invention. More specifically, graph 2600 shows the functional efficiency (measured in TOPS per watt) of a DIMC device as a function of different operating voltages using 8-bit weights and 8-bit activations. The top curve (with square data points) represents an 8×8 dense matmul with 25% one inputs, and the bottom curve (with circle data points) represents an 8×8 dense matmul with 50% one inputs. As shown, increasing the voltage allows the DIMC device to generate higher raw throughput while at lower voltages, it provides superior efficiency. DIMC TOPS/W exceeds SOTA efficiency for an 8-bit implementation while being part of an apparatus that can be a high volume product.

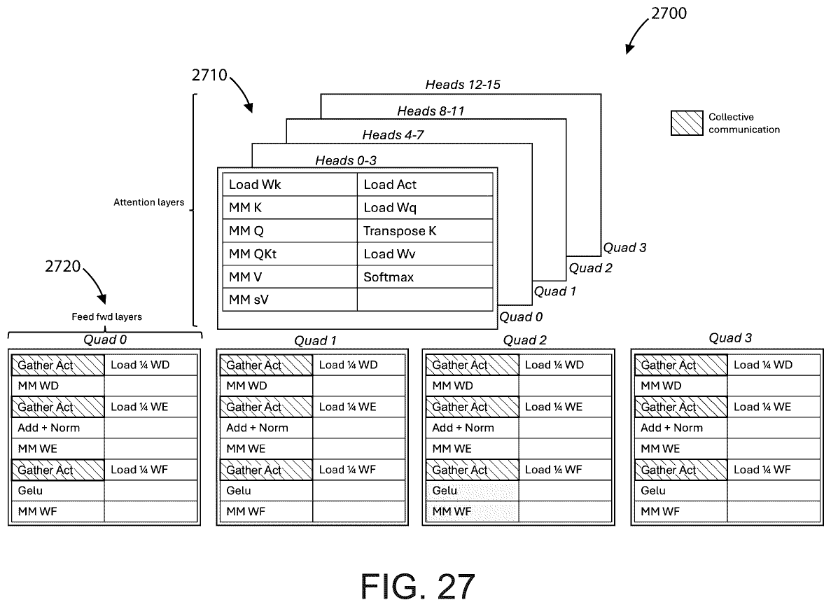

FIG. 27 is a simplified diagram illustrating a method of spatio-temporal mapping for an LLM decoder onto a chiplet device according to an example of the present invention. As shown, mapping configuration 2700 shows an example of how a small LLM decoder comprising of attention heads 2710 and feed-forward layers 2720 can be mapped onto a chiplet device (see previous chiplet examples) such that four Quads form a tensor-parallel configuration. The mapping exploits spatial resources for concurrent attention head processing and sharded linear layers processing. This configuration 2700 also shows the pipelining opportunities during different operations. In an example, overlapping can be performed in a fine-grained manner such that the downstream operations on a sub-tensor begin without waiting for the entire operation to finish.

In a specific example, a full BERT Large encoder running on a single Quad of a chiplet device with context of 384, finishes in about 296K cycles. This translates to an inference throughput of 5400 inferences/s on a single AI accelerator apparatus configured as a PCIe card at 1.167 GHz and a batch of 32. Of course, there can be variations, modifications, and alternatives.

According to an example, the tensor parallel execution of this kind of decoder extends to a tensor parallel unit, as discussed previously, and multiple such TPUs can be connected in a pipeline parallel manner to orchestrate a full model execution. The cumulative effect of efficient compute cores, very large bandwidth, fast interconnections, and software techniques is a step-function improvement in both throughput and latency.

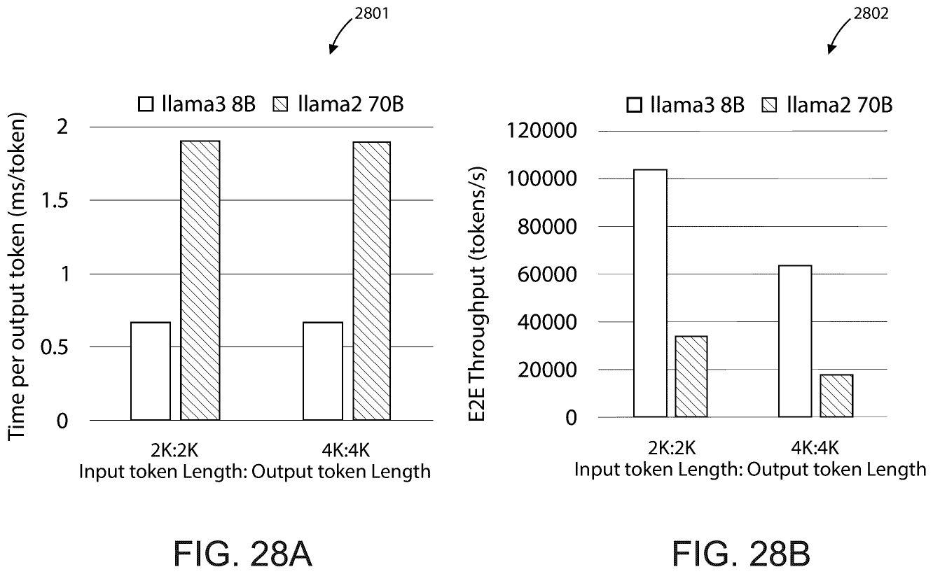

FIGS. 28A and 28B are simplified graphs measuring latency and throughput, respectively, for an AI accelerator apparatus according to an example of the present invention. More specifically, the metrics shown in graphs 2801 and 2802 are for large LLMs (8-billion and 70-billion parameter models) estimated using a performance model. As discussed previously, the latency and throughput of token generation are critical factors to the interactivity and cost effectiveness of reasoning-based LLMs for making such applications more practical. Depending on the embodiment, the present AI accelerator apparatus can exhibit 10× better latency then a conventional GPU while generating 1.5-2× better system throughput.

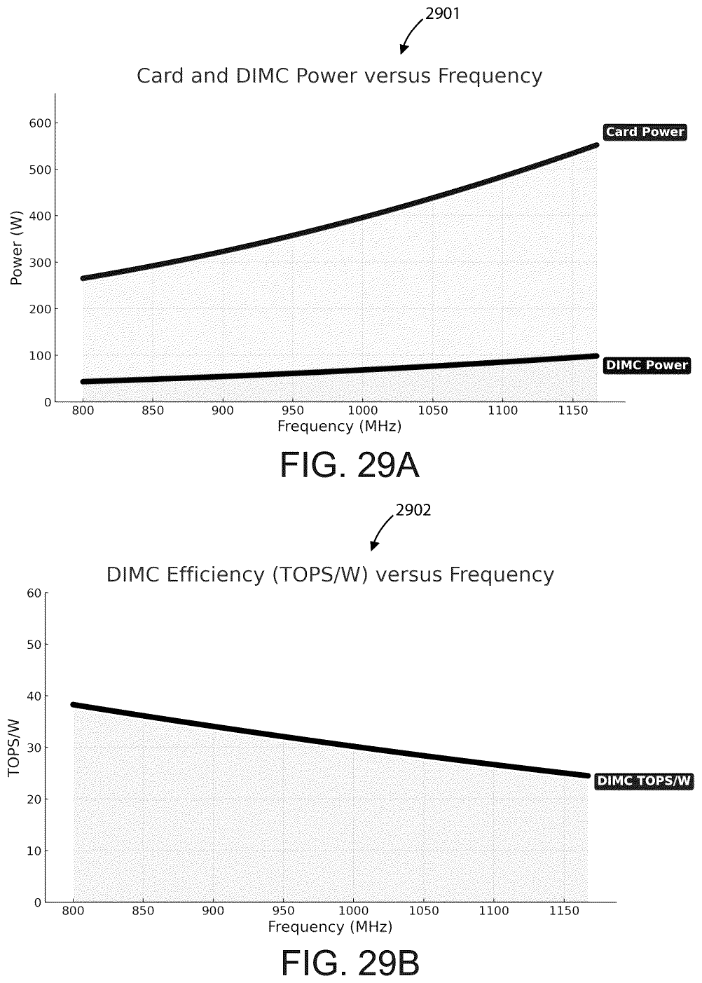

FIG. 29A is a simplified graph measuring power versus frequency for an AI accelerator apparatus and a digital in-memory compute (DIMC) device of the AI accelerator according to an example of the present invention. As shown, graph 2901 compares the power (measured in Watts) over frequency (measured in MHz) curves of an AI accelerator apparatus in a card form factor versus a DIMC device within the AI accelerator. These measurements represent a power stress scenario, and the power is shown to increase as the frequency increases. In this case, workload power is expected to be 60% to 80% of the reported power. In addition to the DIMC power measurements, the accelerator card power measurement includes the power measurements of the Single Input, Multiple Data (SIMD) devices, crossbar (XBAR) devices, input/output (IO) devices, memory devices, as well as regulator power loss and other sources affecting power.

FIG. 29B is a simplified graph measuring efficiency versus frequency in a DIMC device of an AI accelerator apparatus according to an example of the present invention. As shown in graph 2902, the efficiency of the DIMC device is measured in trillions of operations per second (TOPS) over the power consumption (measured in Watts). Here, efficiency decreases as the frequency increases.

The previously discussed server system can be configured as a multi-node AI server system and also include an inter-node network interface with can be configured similarly to the intra network interface but applied to communications across server nodes. Each system can also be configured such the plurality of AI accelerator devices are coupled to the socket of the host CPU, and the inter-node network interface can facilitate communication across CPU sockets. These examples and others are described in the following figures.

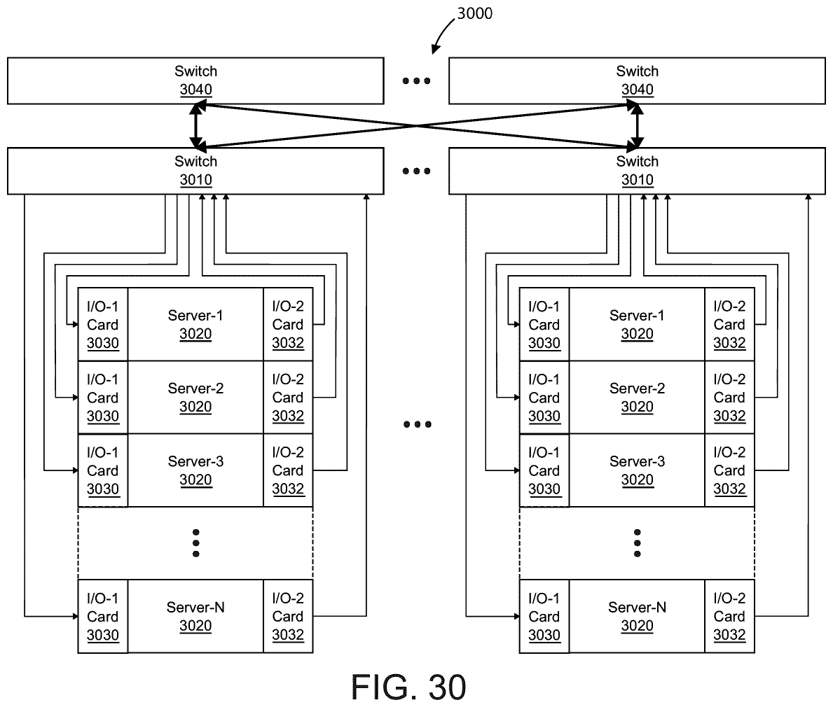

FIG. 30 is a simplified block diagram illustrating a multi-rack server system with multi-node server systems using transparent bridging for scaling up and out according to an example of the present invention. As shown, the system 3000 includes one or more switch devices 3010 (e.g., Ethernet switches, and the like), each of which is coupled a plurality of server node devices 3020 (numbered from 1 to N), and each of the server nodes 3020 is coupled to a first IO streaming device 3030 and a second IO streaming device 3032. In the multi-rack case, each switch 3010 is configured in a server rack system (e.g., top-of-rack [TOR] switch) that is coupled to another layer of switch devices 3040 (e.g., Ethernet switches, and the like) in an interconnected configuration. In an example, the switches 3010 for the rack systems are leaf switches, and the switches 3040 in the next layer above are spine switches.

In an example, the first IO streaming device 3030 can be configured to receive data from the switch 3010 and the second IO streaming device 3032 can be configured to transmit data to the switch 3010. Or, both IO streaming devices 3030, 3032 can be configured for receiving and transmitting data. Depending on bandwidth and latency requirements, each IO streaming device can be configured as a transmitter, a receiver, or a transceiver (e.g., network interface controller [NIC] device, smart NIC [SNIC] device, trusted NIC [TNIC] device, etc.).

In an example, these IO streaming devices 3030, 3032 are configured to implement transparent bridging to scale up and out the network of server nodes 3020 in the multi-node server system 3000. The system 3000 can be configured as a lossless network or a lossy network. Also, each of the nodes 3020 can be configured similarly to the previously discussed server node configurations, in which case the IO streaming devices 3030, 3032 can be configured to communicate across switches within the nodes 3020 using transparent bridging as well. Those of ordinary skill in the art will recognize other variations, modifications, and alternatives to scaling up and out in a multi-node server system and a multi-rack server system.

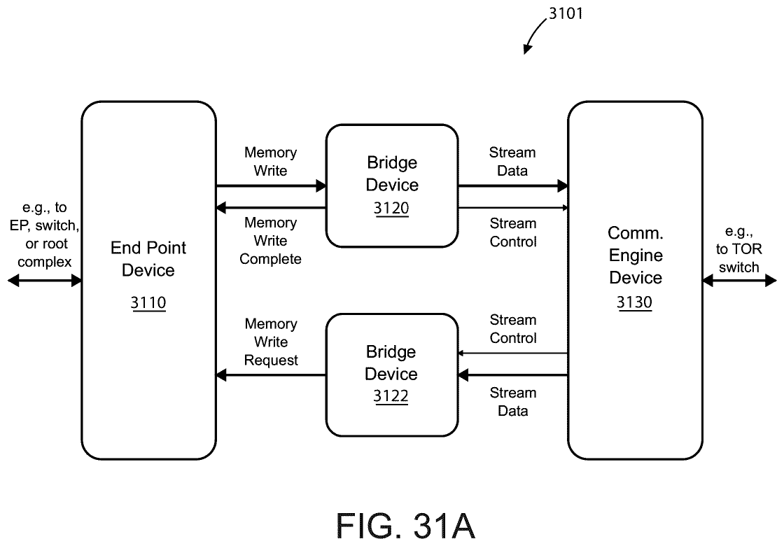

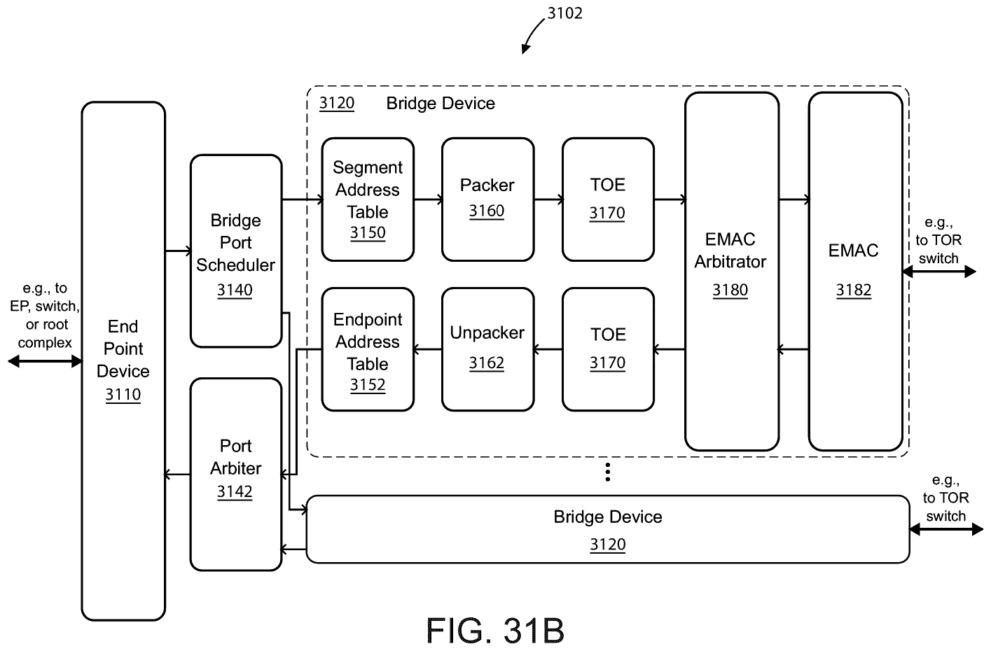

FIG. 31A is a simplified block diagram illustrating an IO streaming device according to an example of the present invention. As shown, the device 3101 includes an end point (EP) device 3110 coupled to a communication engine device 3130 via a first bridge device 3120 and a second bridge device 3122, which can be configured as transmitter bridge path and receiver bridge path, respectively. The first and the second bridge devices 3120, 3122 are configured for communication between the EP device 3110 and the communication engine device 3130 using transparent bridging. The EP device 3110 is configured for communication using a designated interface standard, such as PCIe, and the like. In an example, the EP device 3110 can be coupled to another EP device (e.g., of another IO streaming device, an AI accelerator PU, etc.), a switch, or a root complex. Depending on the application, the EP device 3110 and the communication engine 3130 can be configured for various interconnect technologies (e.g., PCIe, Ethernet, etc.).

The communication engine device 3130 is configured to communicate with other devices (e.g., within a server system) using one or more communication protocols, such as a transmission control protocol/internet protocol (TCP/IP), a die-to-die (D2D) interface communication protocol, an Ethernet communication protocol, a layer 2 (L2) communication protocol, and the like. In an example, the engine device 3130 can include a TCP/IP offload engine (TOE) configured for lossy networks. The communication protocol can include a guaranteed delivery scheme (i.e., no packet loss), which can include a retry buffer and a congestion control scheme with pause packet. And the D2D interface communication protocol can include D2D logic configured for lossless networks with porting support (e.g., from application specific integrated circuit [ASIC] to field programmable gate array [FPGA]).

The first bridge device 3120 is configured as a bridge from the EP device 3110 to the communication engine device 3130, while the second bridge device 3122 is configured as a bridge from the communication engine device 3130 to the EP device 3110. In an example, the first bridge device 3120 can also be configured to manage a network communication flow control system of the IO streaming device, such as in a PCIe credit-based flow control system, and the like. The first bridge device 3120 can facilitate memory write functionality by sending data/completion packets with the EP device 3110. These packets can include transaction layer packets (TLPs), data link layer packets (DLLPs), and the like. In an example, completion packets follow an in-order flow of data across the first bridge device 3120. The first bridge device 3120 can also stream data and control signals to the communication engine device 3130 using a streaming interface, such as an advanced extensible interface (AXI), and the like. Similarly, the second bridge device 3122 can receive control signals and data streamed from the communication engine device 3130 using the streaming interface. Further, the second bridge device 3122 can send memory write requests to the EP device 3110 using similar data packets. Using this configuration, the IO streaming device 3100 can connect an end point to another end point, an end point to a root complex, or a root complex to another root complex.

In a specific example, the IO streaming device 3100 includes an FPGA device configured for PCIe communication with support for TLP prefix and steering tag. The EP device 3110 can be a PCIe EP device and the communication engine 3130 is configured for Ethernet connectivity over a TOR switch. In this case, the first and the second bridge devices 3120, 3122 are configured as PCIe-Ethernet bridges. Those of ordinary skill in the art will recognize other variations, modifications, and alternatives to this IO streaming device configuration.

FIG. 31B is a simplified block diagram illustrating an IO streaming device scale-out configuration according to an example of the present invention. As shown, the device 3102 includes an endpoint device 3110 coupled to a plurality of bridge devices 3120 (e.g., configured in ports) through a bridge port scheduler 3140 and a port arbiter 3142. The bridge port scheduler 3140 can be configured to manage data from the end point device 3110 going to the bridge devices 3120, while the port arbiter 3142 manages data coming from the bridge devices 3120. This configuration can scale communication semantics from intra-chiplet to internode (e.g., PCIe semantics over Ethernet) and achieve lower latency than conventional network configurations (e.g., remote direct memory access [RDMA]).

In an example, the outgoing path in the bridge device 3120 includes a segment address table 3150 coupled to a packer module 3160 followed by a TCP offload engine (TOE) 3170. This outgoing path is coupled to an Ethernet Media Access Controller (EMAC) arbitrator 3180 that manages the data being sent through and coming in from the EMAC 3182. Similarly, on the incoming path coupled to the EMAC arbitrator 3180, a TOE 3170 is coupled to an unpacker module 3162 followed by an Endpoint Address Table 3152, which outputs to end point device 3110 via the port arbiter 3142. Those of ordinary skill in the art will recognize other variations, modifications, and alternatives to these communication network configurations.

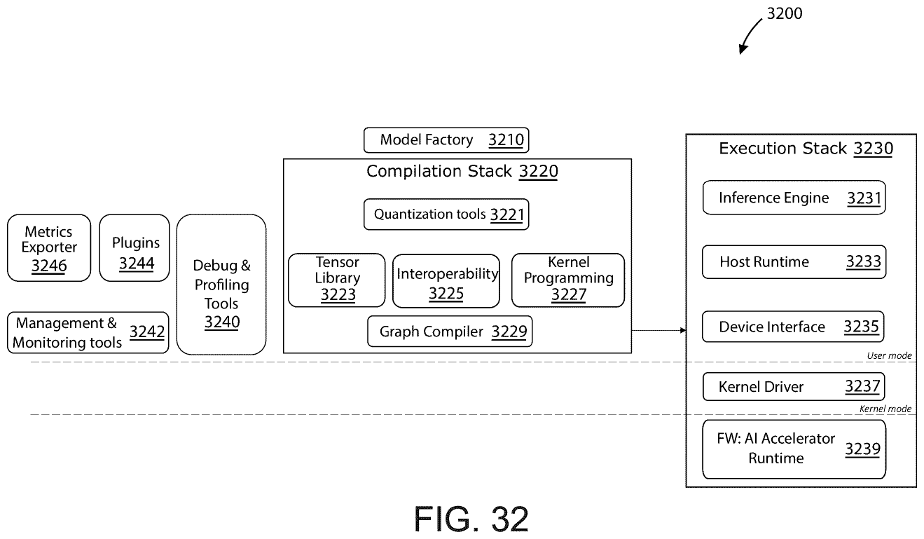

FIG. 32 is a simplified block diagram of an AI accelerator software stack according to an example of the present invention. As shown, the software stack 3200 includes a model factory layer 3210, a compilation stack 3220, and an execution stack 3230 that are configured determine parameters and instructions to be used by designated hardware to process a neural network model workload. The model factory layer 3210 can be used to provide model definitions, enable checkpoints, and determine model configurations such as model generation configurations (e.g., batch size, etc.) and distributed inference configurations (e.g., number of cards, parallelism type/degree, etc.).

In an example, the operation of the software stack is logically divided into a “Lowering” (or generalized compilation) stack 3220 and an “Execution” stack 3230 using a distributed runtime framework. The lowering stage of the compilation process includes translating complex language constructs into basic operations (i.e., simplifying the code), while the execution stage includes running the compiled code. The overall execution flow can also include invocation of the lowering stack as well. These stacks can be used to determine the workload description, accelerator cluster configuration, partitioning schemas, and other parameters.

The compilation stack 3220 includes at least a quantization layer 3221, a tensor library layer 3223, and a graph compiler layer 3229. The quantization layer 3221 provides quantization tools to reduce the computational and memory costs of processing a target model workload (e.g., running inference) by representing the weights and activations of the workload with low-precision data types. The stack 3220 can also include other model optimization tools, such as ML tools for numeric and sparsity techniques, padding, op replacement, and the like. The tensor library layer 3223 enables the use of tensors (i.e., array-like or matrix-like building blocks), modules, and other features to help build and train neural networks. In an example, the tensor library layer 3223 can uses the tensors to encode model inputs, outputs, and parameters according to a PyTorch deep learning framework, or the like.

With these tensors, a target model workload can be represented by modules in a computational graph. The computational graph can also be partitioned into sub-graphs of different levels with collective variables to be later executed across different levels of the target hardware architecture. For example, a model graph can be partitioned into a plurality of node-level subgraphs, each of which can be partitioned into a plurality of card-level subgraphs that can be assigned to different AI accelerator apparatuses. Each card-level subgraph can be further partitioned into chip-level subgraphs, which can also be partitioned into tile-level or gang-level subgraphs. The chip-level subgraphs can be assigned to different chiplet devices of the AI accelerator apparatuses, and the tile/gang-level subgraphs can be assigned to different tiles/gangs of the chiplet devices. Then, the graph compiler layer 3229 takes the computational graph and sub-graphs as inputs, analyzes their structure, and generates optimized code for executing the computations represented by the graphs and sub-graphs.

The compilation stack 3220 can also include an interoperability layer 3225 and a kernel programming layer 3227. The interoperability layer 3225 can enable conversion of the target model into a format that is compatible with various platforms and programming languages. For example, the interoperability layer 3225 can use Open Neural Network Exchange (ONNX) tools, or the like, to convert the model from the PyTorch format to the ONNX format, which supports a wide range of hardware and is optimized for inference speed. The kernel programming layer 3227 can be used to determine kernel instructions for the target hardware to process the target workload. These kernel instructions can control processes include scheduling, memory management, networking, etc. Overall, the compilation stack 3220 can lowering models (e.g., regular ML models) into a hardware-aware representation (e.g., quantized, partitioned, compiled model) with efficient resource mapping and scheduling.

In an example, the compilation stack operates in “user mode”, which has limited access to system resources compared to “kernel mode”. In this mode, the software stack 3200 also includes debugging and profiling tools 3240 and management and monitoring tools 3242 to assist the compilation and execution stacks 3220, 3230. A plugins layer 3244 can also include various plugins configured to support specific devices and resources, such as those for GPUs and memory devices. Further, a metrics exporter layer 3246 can collect and export metrics data (e.g., processing time, storage space, etc.) used to evaluate the neural network model.

In “user” mode, the execution stack 3230 includes an inference engine layer 3231, a host runtime layer 3233, and a device interface layer 3235. Using these layers, the execution stack 3230 can allocate and manage large logical tensors (representing model workloads) and caches over a distributed memory hierarchy of a target hardware device. The inference engine layer 3231 can include inference servers configured to manage and execute inference tasks involved in processing the compiled models from the compilation stack 3220. These inference servers can handle batching across multiple user requests, continued execution of stateful models that track dependencies between consecutive inference requests, global prompt caching to strategically store and reuse precomputed attention states, as well as other inference-related functions.

The host runtime layer 3233 can initialize a launcher to spawn and manage multiple processes for the execution of the compiled graphs and sub-graphs described previously. For example, the host runtime layer 3233 can instantiate the card-level subgraphs with process groups and handle local prompt caching and host-to-device/device-to-hose data transfers. The device interface layer 3235 works with the host runtime layer 3233 to send the instructions from the compiler commands and the data needed to process the neural network model workload on the target hardware. For example, the device interface layer 3235 can boot the tiles/gangs of the target hardware (e.g., AI accelerator with chiplets configured in tiles/gangs of matrix compute apparatuses); initialize the memory of the target hardware (e.g., DDR memory) with the inputs, weights, and sub-graph data; manage the asynchronous execution of the tiles/gangs, and send completion information to the host runtime layer 3233.

In “kernel” mode, the execution stack 3230 includes a kernel driver 3237 that runs at a high privilege level with access to all system resources of the target hardware. The kernel driver 3237 is stored in the memory of the target hardware and communicates with the device interface layer 3235 to implement the firmware 3239 that provides the core instructions (e.g., kernel instructions provided from the kernel programming layer 3227) for the operation of the device components of the target hardware to process the model workloads. For the AI accelerator apparatus, this includes specific instructions to the global CPU of each chiplet, the local CPUs of the tiles/gangs within each chiplet, and different devices within the tiles/gangs, such as the SIMD devices.

In an example, the present software stack includes a various features codesigned for LLM acceleration. Minimal host-device sync is enabled by continuous and asynchronous graph execution and checks for new work. Low latency collectives are enabled by graph-native invocation with sync hints. Expert score and routing is are enabled by native support for conditions and dynamic addresses. Iterative token generation and dynamic shapes are enabled by on-device autoregression engines. And efficient LLM serving engines are enabled by minimized IPC, O(1) critical-path hosting-processing with card count.

Although the software stack 3200 is described in operation with an AI accelerator apparatus, the software stack 3200 can also be configured to operate with an independent chiplet device with matrix compute apparatuses or a server system having a plurality of AI accelerator apparatuses (e.g., AI accelerator PCIe card devices coupled by switches and server CPUs). Those of ordinary skill in the art will recognize other variations, modifications, and alternatives to this software stack configuration and its applications.

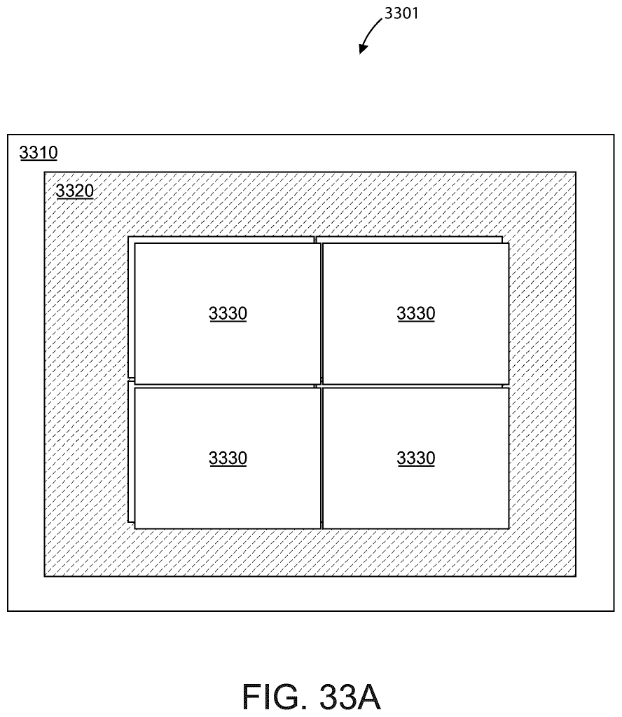

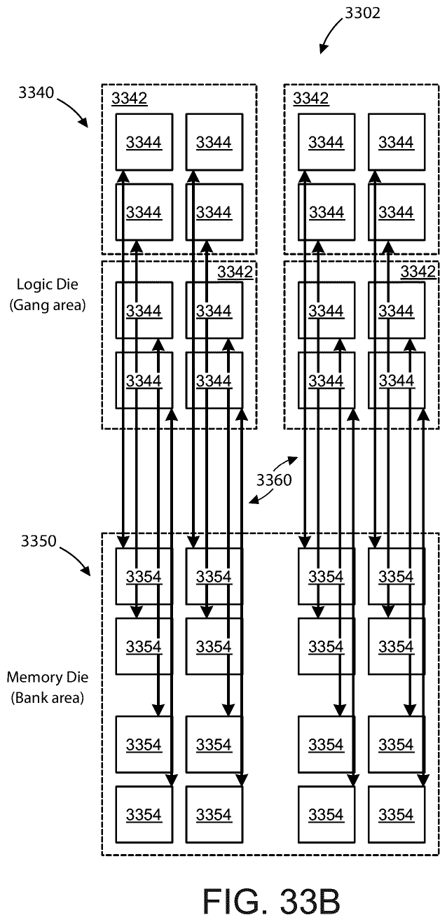

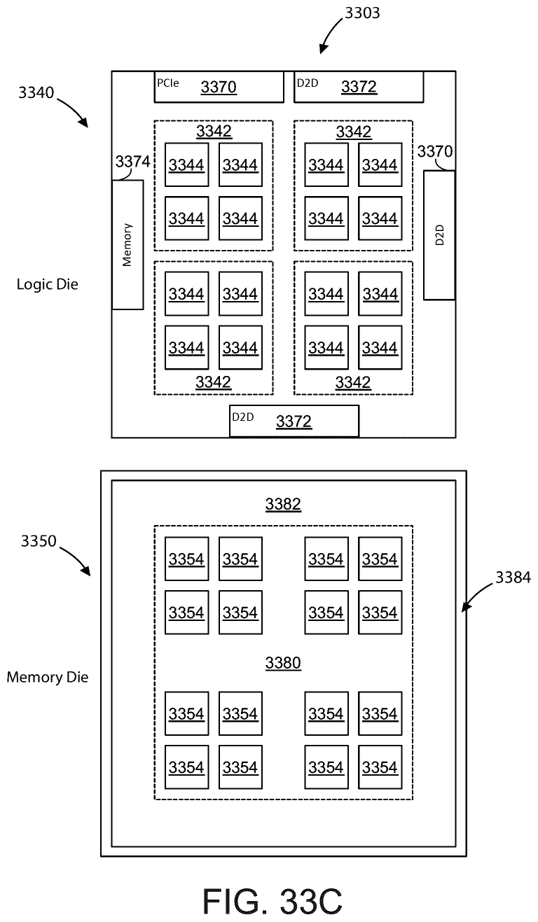

FIG. 33A is a simplified diagram illustrating a top view of a 3D stacked AI engine system according to an example of the present invention. As shown, the system 3301 includes a plurality of 3D stacked chiplet devices 3330 formed overlying a wafer substrate 3310 with a die region 3320. The stacked chiplet devices 3330 can be formed using a wafer-on-wafer hybrid bonding process, or the like. Here, there are four stacked chiplet devices 3330 arranged in a 2×2 configuration overlying the die region 3320, but there can be other configurations (e.g., 1×2, 3×3, 2×4, etc.). In an example, the die region 3320 includes a silicon capacitor interposer that can improve the power integrity of the system 3301 and serve as a foundation for stacking the chiplet devices and memory devices (e.g., DRAM devices) in the stacked chiplet devices 3330, which can increase the memory capacity by orders of magnitude. In a specific example, this configuration can have 100 times the vertical connections direct to compute (i.e., the chiplet devices) relative to conventional examples, such as those using high-bandwidth memory (HBM). This configuration can also exhibit 10 times the bandwidth (BW) and energy efficiency (EE) per stack (e.g., an example stacked chiplet system with BW: 20 TB/s and EE: 0.3 pJ/bit versus an HBM system with BW: 2 TB/s and EE: ˜3 pJ/bit+additional energy on XPU die).

FIG. 33B is a simplified diagram illustrating an exploded view of a 3D stacked AI engine system and its interconnections according to an example of the present invention. As shown, the system 3302 includes a logic die 3340 and a memory die 3350 coupled by interconnections 3360. This logic die 3340 includes one or more chiplets with each chiplet including a plurality of gangs 3342, and each gang including a plurality of slices 3344. The logic die can include configurations similar to other AI accelerator apparatuses, chiplet devices, and slices discussed herein. The memory die 3350 includes a plurality of memory devices 3354 (e.g., dynamic random access memory [DRAM], or the like), each of which can include a plurality of memory banks. In a specific example, the interconnections 3360 can include microbumps (ubumps), and the like, that couple each of the slice devices 3344 to one of the memory devices 3354. The memory die 3350 can also include addition interconnections (e.g., ubumps) to provide power to the logic die 3340, enable high-speed input/output (HSIO), as well other functions.

In an example, the logic die 3340 and the memory die 3350 can be co-designed such that each of the memory devices 3354 can be configured as stash memory devices in an array as follows. The slices 3344 of the gangs 3342 can be organized hierarchically to minimize routing distance between the dies 3340, 3350. Each chiplet can have an m₁×n₁ array of gangs 3342, and each gang can have an m₂×n₂ array of slices 3344. In this case, the number of slices 3344 across a width size of the logic die 3340 is determined by mix m₂ and the number of slices across a height side of the logic die 3340 is determined by nix n₂. Given this array configuration, the memory die 3350 can be configured such that the total number of memory banks across a width side of the memory die 3350 is a multiple of mix m₂, and such that the number of memory banks across a height side of the memory die 3350 is a multiple of nix n₂. In this manner, the memory devices 3354 can be configured in a hierarchy that corresponds to the slices 3344 in the stacked configuration.

FIG. 33C is a simplified diagram illustrating an exploded view of a 3D stacked AI engine system and its peripheral regions according to an example of the present invention. Similar to system 3302, the system 3303 includes the logic die 3340 with gangs 3342 of slices 3344 and the memory die 3350 with memory devices 3354. Additionally, the logic die 3340 includes a PCIe interface 3370, D2D interconnects 3372, and a memory interface 3374, which can have a similar configuration as discussed previously (see FIGS. 2A and 2C).

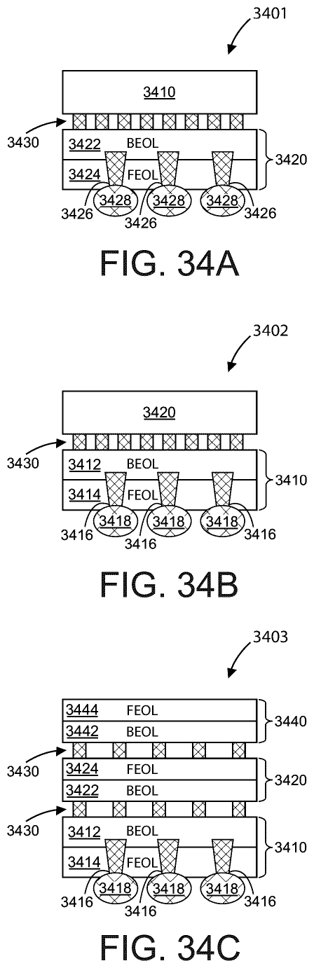

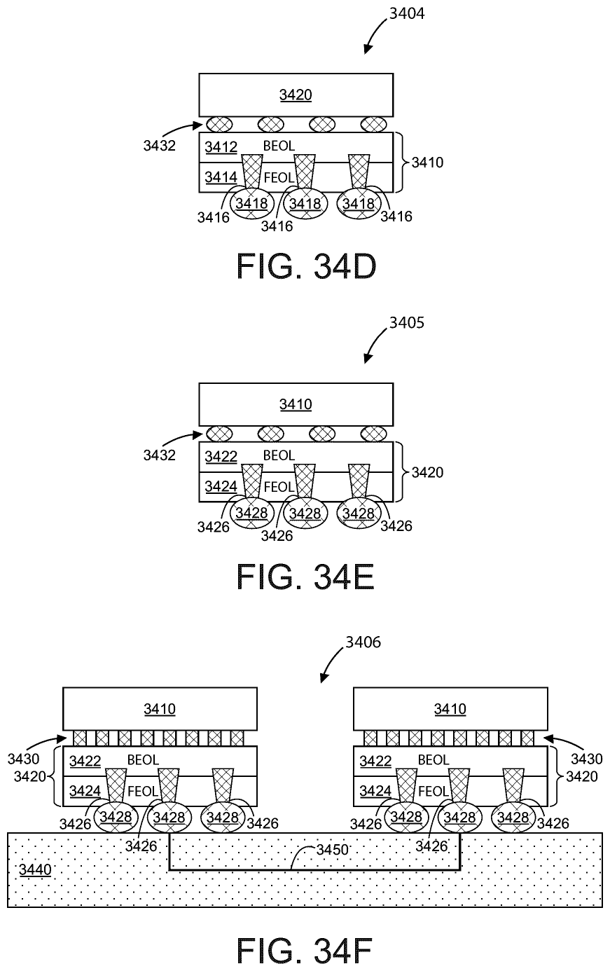

The memory die 3350 shows the memory devices 3354 (e.g., stash memory devices) spatially configured within a memory bank region 3380 and two outer periphery regions 3382, 3384. The first outer periphery region 3382 can include interconnections for HSIO from the logic die 3340 (e.g., LPDDR, PCIe, D2D, etc.) to other devices and systems outside of the packaged substrate, and the second outer periphery region 3384 can be configured for framing overhead. In an example, these memory devices 3354 can be configured using multiplexed channels, hybrid channels, or divided routing channels. Those of ordinary skill in the art will recognize other variations, modifications, and alternatives to these system configurations. Further examples of stacked chiplets or stacked 3D AI engine systems are shown in FIGS. 34A-34F.

FIG. 34A is a simplified diagram illustrating a cross-sectional view of an example 3D stacked chiplet device 3401 (or a 3D stacked AI engine system) with a logic die 3410 overlying a memory die 3420. These dies are bonded by a plurality of contacts 3430, which can include the materials and processes discussed previously. In a specific example, the memory die 3420 can be formed as a thin layer (e.g., 10 um memory die vs. 775 um logic die for 21 nm technology) that extends as if part of the logic die 3410. Also, the plurality of contacts 3430 can be characterized by 3u pitch and the bump contacts 3428 can be characterized by a 110 um-130 um pitch. Here, the memory die 3420 shows BEOL layers 3422 and FEOL layers 3424 with TSVs 3426 configured between these layers and coupled to bump contacts 3428.

FIG. 34B is a simplified diagram illustrating a cross-sectional view of an example 3D stacked chiplet device 3402 (or 3D stacked AI engine system) with the memory die 3420 overlying the logic die 3410. These dies are also bonded by the plurality of contacts 3430. Here, the logic die 3410 shows BEOL layers 3412 and FEOL layers 3414 with TSVs 3416 configured between these layers and coupled to bump contacts 3418.

FIG. 34C is a simplified diagram illustrating a cross-sectional view of an example 3D stacked chiplet device 3403 (or 3D stacked AI engine system) with stacked memory dies 3420, 3440 overlying the logic die 3410. Similar to device 3402, these dies are bonded by the plurality of contacts 3430. Here, the second memory die 3440 includes BEOL layers 3442 and FEOL layers 3444, and is bonded to the first memory die 3420 using a face-to-back hybrid bonding process. This face-to-back bond results in the FEOL layers 3424 of the first memory die 3420 being bonded to the BEOL layers 3442 of the second memory die 3440. Depending on the embodiment, additional memory dies can be stacked in the same manner for higher capacity. Or, a plurality of smaller memory dies can be stacked on an interface region of a larger memory die with each of the smaller memory dies being configured to an independent channel (e.g., multiplexed channel, hybrid channel, divided routing channel, etc.) provided in the interface region. Further, the logic die 3410 can be configured overlying the stacked memory dies (similar to device 3401) as well.

FIGS. 34D and 34E are simplified diagrams illustrating cross-sectional views of example 3D stacked chiplet devices 3404 and 3405 (or 3D stacked AI engine system) using micro bumps 3432. As shown, devices 3404 and 3405 are similar to devices 3402 (memory die on logic die) and 3401 (logic die on memory die), respectively, but the logic die 3410 and the memory die 3420 are bonded using micro bumps 3432. In a specific example, the micro bumps 3432 can be characterized by a 10u-36 um pitch. These micro bumps 3432 can also be used to form stacked memory dies, similar to device 3403.

FIG. 34F is a simplified diagram illustrating a cross-sectional view of an example 3D stacked die-to-die (D2D) link system. As shown, AI engine system 3406 includes two 3D stacked chiplet devices similar to device 3401 overlying a substrate member 3440 (e.g., organic substrate, or the like). These two stacked chiplet devices are coupled together by a D2D interconnect 3450 coupled between the bumps 3428 of each stacked chiplet device. In an example, the interconnect 3450 can include Universal Chiplet Interconnect Express (UCIe), or the like. Further, the logic and memory dies 3410/3420 can be arranged in a face-to-face (F2F) stacking configuration. These techniques provide a low-cost, high-volume, and high-yield process for forming 3D stacked chiplet devices and systems. Those of ordinary skill in the art will recognize variations, modifications, and alternatives to these stacked configurations.

While the above is a full description of the specific embodiments, various modifications, alternative constructions and equivalents may be used. As an example, the AI accelerator apparatus and chiplet devices can include any combination of elements described above, as well as outside of the present specification. Therefore, the above description and illustrations should not be taken as limiting the scope of the present invention which is defined by the appended claims.

What is claimed is:

1. A stacked in-memory compute (IMC) accelerator apparatus comprising:
an interposer substrate;
a plurality of chiplets spatially configured overlying the interposer substrate, each of the chiplets comprising a plurality of tiles, and each of the tiles comprising:
a plurality of slices, and
a central processing unit (CPU) coupled to the plurality of slices;
a plurality of die-to-die (D2D) interconnects coupled to the CPUs in each of the tiles through the interposer substrate; and
a memory interface coupled to the CPUs in each of the tiles; and
a plurality of memory devices coupled to the plurality of chiplets via the memory interface such that each chiplet and one or more memory devices form a stacked configuration;
wherein each of the slices includes a plurality of compute cores, each compute core include a digital IMC (DIMC) device and a Single Input Multiple Data (SIMD) device coupled to an output buffer (OB) device;
wherein each of the slices includes a stash memory device coupled to the DIMC device in each of the compute cores;
wherein each of the slices includes a global memory (GM) device coupled to the plurality of compute cores; and
wherein each of the slices includes a data reshape engine (DRE) device coupled to the plurality of compute cores.

2. The apparatus of claim 1 further comprises
a peripheral component interconnect express (PCIe) bus coupled to the CPUs in each of the tiles; and
a main bus device coupled to each PCIe bus in each chiplet using a master chiplet device, wherein the master chiplet device is coupled to each of the other chiplet devices using at least the plurality of D2D interconnects.

3. The apparatus of claim 1 wherein each chiplet comprises a network on chip (NoC) device configured for a multicast process and coupled to each of the plurality of slices;
wherein the compute device is configured to support one or more block floating point (BFP) data types using a shared exponent; and
wherein the compute device is configured to support a block structured sparsity.

4. The apparatus of claim 1 wherein the chiplet device is configured overlying the one or more memory devices in the stacked configuration.

5. The apparatus of claim 1 wherein the one or more memory devices are configured overlying the chiplet device in the stacked configuration.

6. The apparatus of claim 1 wherein the OB device is a shared scratchpad static random access memory (SRAM) serving as a primary data buffer between the DIMC device and the SIMD device;
wherein the stash memory device comprises a high-bandwidth, high-density multi-banked SRAM device configured to store workload inputs; and
wherein the GM device comprises a multi-banked SRAM device configured as a shared data buffer between the compute cores.

7. A stacked in-memory compute (IMC) accelerator apparatus comprising:
an interposer substrate;
a plurality of chiplets spatially configured overlying the interposer substrate, each of the chiplets comprising a plurality of tiles, and each of the tiles comprising:
a tile crossbar device;
a plurality of slices coupled to the tile crossbar device, and
a tile central processing unit (CPU) coupled to the plurality of slices;
a plurality of die-to-die (D2D) interconnects coupled to the each of the tile CPUs through the interposer substrate;
a memory interface coupled to each of the tile CPUs; and
a plurality of memory devices coupled to the plurality of chiplets via the memory interface such that each chiplet and one or more memory devices form a stacked configuration; and
wherein each of the slices comprises
a slice crossbar device coupled to tile crossbar device;
a plurality of compute cores coupled to the slice crossbar device, wherein each compute core includes a digital IMC (DIMC) device and a Single Input Multiple Data (SIMD) device coupled to an output buffer (OB) device;
a global memory (GM) device coupled to slice crossbar device;
a stash memory device coupled to the slice crossbar device and the DIMC devices of the compute cores; and
a data reshape engine (DRE) device coupled to the slice crossbar device.

8. The system of claim 7 further comprises
a peripheral component interconnect express (PCIe) bus coupled to the CPUs in each of the tiles; and
a main bus device coupled to each PCIe bus in each chiplet using a master chiplet device, wherein the master chiplet device is coupled to each of the other chiplet devices using at least the plurality of D2D interconnects.

9. The apparatus of claim 7 wherein each chiplet comprises a network on chip (NoC) device configured for a multicast process and coupled to each of the plurality of slices;
wherein the compute device is configured to support one or more block floating point (BFP) data types using a shared exponent; and
wherein the compute device is configured to support a block structured sparsity.

10. The apparatus of claim 7 wherein the chiplet device is configured overlying the one or more memory devices in the stacked configuration.

11. The apparatus of claim 7 wherein the one or more memory devices are configured overlying the chiplet device in the stacked configuration.

12. The apparatus of claim 7 wherein the OB device comprises a shared scratchpad static random access memory (SRAM) device configured as a primary data buffer between the DIMC device and the SIMD device;
wherein the stash memory device comprises a high-bandwidth, high-density multi-banked SRAM device configured to store workload inputs; and
wherein the GM device comprises a multi-banked SRAM device configured as a shared data buffer between the compute cores.

13. The apparatus of claim 7 wherein each tile comprises a plurality of input/output (I/O) ports, the I/O ports being configured to connect a plurality of I/O interfaces including a peripheral component interconnect express (PCIe) interface, a D2D interface, and a low-power double data rate (LPDDR) memory interface.

14. A stacked in-memory compute (IMC) apparatus comprising:
a switch device coupled to a first stacked IMC accelerator apparatus and a second stacked IMC accelerator apparatus;
wherein each of the first and second stacked IMC accelerator apparatuses comprises a plurality of chiplets configured overlying an interposer substrate, each of the chiplets comprising a plurality of tiles, and each of the tiles comprising:
a tile crossbar device;
a plurality of slices coupled to the tile crossbar device, and
a tile central processing unit (CPU) coupled to the plurality of slices;
a plurality of die-to-die (D2D) interconnects coupled to the each of the tile CPUs through the interposer substrate;
a memory interface coupled to each of the tile CPUs; and
a plurality of memory devices coupled to the plurality of chiplets via the memory interface such that each chiplet and one or more memory devices form a stacked configuration; and
wherein each of the slices comprises
a slice crossbar device coupled to tile crossbar device;
a plurality of compute cores coupled to the slice crossbar device, wherein each compute core includes a digital IMC (DIMC) device and a Single Input Multiple Data (SIMD) device coupled to an output buffer (OB) device;
a global memory (GM) device coupled to slice crossbar device;
a stash memory device coupled to the slice crossbar device and the DIMC devices of the compute cores; and
a data reshape engine (DRE) device coupled to the slice crossbar device; and
a bridge connection interface coupled to at least one of the chiplets of the first stacked IMC accelerator apparatus and at least one of the chiplets of the second stacked IMC accelerator apparatus, the bridge connection interface being configured to provide one or more back-to-back links between the first and second stacked IMC accelerator apparatuses.

15. The apparatus of claim 14 wherein each of the first and second stacked IMC accelerator apparatuses comprises:
a peripheral component interconnect express (PCIe) bus coupled to the CPUs in each of the tiles; and
a main bus device coupled to each PCIe bus in each chiplet using a master chiplet device, wherein the master chiplet device is coupled to each of the other chiplet devices using at least the plurality of D2D interconnects.

16. The apparatus of claim 14 wherein each chiplet comprises a network on chip (NoC) device configured for a multicast process and coupled to each of the plurality of slices;
wherein the compute device is configured to support one or more block floating point (BFP) data types using a shared exponent; and
wherein the compute device is configured to support a block structured sparsity.

17. The apparatus of claim 14 wherein the chiplet device is configured overlying the one or more memory devices in the stacked configuration.

18. The apparatus of claim 14 wherein the one or more memory devices are configured overlying the chiplet device in the stacked configuration.

19. The apparatus of claim 14 wherein the OB device comprises a shared scratchpad static random access memory (SRAM) device configured as a primary data buffer between the DIMC device and the SIMD device;
wherein the stash memory device comprises a high-bandwidth, high-density multi-banked SRAM device configured to store workload inputs; and
wherein the GM device comprises a multi-banked SRAM device configured as a shared data buffer between the compute cores.

20. The apparatus of claim 14 wherein each tile comprises a plurality of input/output (I/O) ports, the I/O ports being configured to connect a plurality of I/O interfaces including a peripheral component interconnect express (PCIe) interface, a D2D interface, and a low-power double data rate (LPDDR) memory interface.
